(19) United States
(12) Patent Application Publication
(10) Pub. No.: US 2023/0159860 A1
(43) Pub. Date: May 25, 2023

(54) COSMETIC AND PERSONAL CARE PRODUCTS AND METHODS

(71) Applicant: Jeffrey Dean Lindsay, Apleton, WI (US)

(72) Inventor: Jeffrey Dean Lindsay, Apleton, WI (US)

(21) Appl. No.: 18/092,914

(22) Filed: Jan. 3, 2023

Related U.S. Application Data
(63) Continuation-in-part of application No. 16/926,514, filed on Jul. 10, 2020.
Application No. 16/926,514 is a continuation-in-part of application No. 17/068,806, filed on Oct. 12, 2020.
Application No. 17/068,806 is a continuation-in-part of application No. PCT/US2020/055429, filed on Jul. 22, 2020.
(60) Provisional application No. 62/881,212, filed on Jul. 31, 2019.
(60) Provisional application No. 62/872,697, filed on Jul. 10, 2019.
(60) Provisional application No. 62/994,810, filed on Mar. 25, 2020.
(60) Provisional application No. 62/931,213, filed on Nov. 5, 2019.
(60) Provisional application No. 62/914,552, filed on Oct. 13, 2019.
(60) Provisional application No. 63/055,305, filed on Jul. 22, 2020.
(60) Provisional application No. 63/066,426, filed on Aug. 17, 2020.

(51) Int. Cl. C11D 3/386; C11D 3/38; C11D 11/00

(52) U.S. Cl. CPC C11D 3/38627; C11D 3/38645; C11D 3/38654; C11D 3/38636; C11D 3/381; C11D 11/0017

(57) ABSTRACT

Novel methods and compositions for treating textiles and other materials are disclosed in which persistent odor or other symptoms of biofilm presence can be reduced through the use of compositions comprising N-acetyl cysteine or other agents in combination with certain enzymes.

### CLAIM TO PRIORITY

This application claims priority to PCT/US2020/055429, filed Oct. 13, 2020, and to U.S. patent application Ser. No. 16/926,514, filed Jul. 10, 2020 and Ser. No. 17/068,806, filed Oct. 12, 2020, both of which claim priority to U.S. Patent Appl. Ser. No. 62/881,212, filed Jul. 31, 2019 and U.S. Patent Appl. Ser. No. 62/872,697, filed Jul. 10, 2019. U.S. patent application Ser. No. 17/068,806 both further claims priority to U.S. Patent Appl. Ser. No. 62/994810, filed Mar. 25, 2020; U.S. Patent Appl. Ser. No. 62/931,213, filed Nov. 5, 2019; U.S. Patent Appl. Ser. No 62/914552, filed Oct. 13, 2019; PCT/US2020/055429, filed Oct. 13, 2020; U.S. Ser. No. 63/014,100, filed Apr. 22, 2020; U.S. Ser. No. 63/055,305, filed Jul. 22, 2020; U.S. Ser. No. 63/066,426, filed Aug. 17, 2020; and U.S. Ser. No. 63/137,705, filed Jan. 14, 2021.

### BACKGROUND

### Field of the Invention

This invention pertains to products, formulations, and methods for personal care and cleaning, particularly cosmetics, oral care, and other health care products, as well as products and methods for treating clothing, textiles or other surfaces to reduce the presence of malodor or to reduce biofilm.

### Background/Description of Related Art

In the laundry, textile, and personal care industries, significant challenges remain in reducing odor, especially human body odor in fabrics including synthetic fabrics such as polyester. Persistent odor in polyester has been reported by many users, especially those who engage in strenuous exercise regularly. Many report that malodor, especially in the axillary regions, returns quickly after thorough laundering, and sometimes may not be thoroughly removed by laundering. Such malodor is sometimes called “perma-odor” or “perma-stink.” We have observed, for example, that some sports apparel may continue to have symptoms of perma-odor even after treatment with dilute bleach or other harsh agents that normally might be expected to eliminate microbial sources of odor. Repeated washing is often ineffective, even with advanced commercial laundry detergents. Many users simply feel they have to discard such infected clothing. There is a long-standing need for means to reduce such perma-odor or other forms of persistent odor in clothing.

Without wishing to be bound by theory, we propose that the recalcitrance of perma-odor is akin to the recalcitrance of bacterial infections when a microbial biofilm is present. Biofilms are remarkable adaptations of bacteria and other microbes such as protists and fungi, including yeasts, in which polysaccharides, proteins, DNA, and other materials may be used to create a protective matrix that can prevent antimicrobials or harsh chemical agents from penetrating effectively. In a biofilm, microbes, sometimes from more than one species, share chemical signals and cooperate to create protective materials that help secure them on a solid surface and protect them from external threats, allowing them to reproduce and thrive. However, there has not yet been a widespread recognition of the role of biofilms in athletic clothing and ordinary attire. Indeed, a common view is that conventional washing and drying is likely to prevent biofilms from forming. However, new evidence suggests that biofilms in clothing can provide a microbial stronghold for generation of perma-odor. Fortunately, experimental evidence now shows that certain agents such as N-acetyl cysteine can reduce biofilm and provide several valuable functions in cleaning products and cosmetics.

### SUMMARY

It has been discovered that perma-odor in a variety of textiles can be significantly mitigated through treatment with the combination of certain enzymes with one or more biofilm attack agents such as N-acetyl cysteine, mixtures of N-acetyl cysteine with other agents such as panthenol, or other agents described herein, applied for an effective period of time, followed by or performed substantially simultaneously with laundering with a laundry detergent, treatment with other soaps and detergents, or simply rinsing with water. Enzymes used in combination with biofilm attack agents in one aspect are provided as an enzymatic blend comprising surfactants and optional bacterial spores or live bacteria. The biofilm attack agents such as N-acetyl cysteine are provided in a solution, either with the enzymes or in a separate container, or provided at least partially in solid form such as a capsule, a powder, a tablet, a stick, etc., to be dissolved in an aqueous solution before, after or during application to the textile item being treated.

In describing the various versions and aspects of the methods and products disclosed herein, it should be understood that the elements, steps, features, etc. of any version or aspect are combinable with any other version or aspect or collection of versions and aspects unless stated otherwise or clearly unsuitable.

Thus, in one aspect, a method is provided for treating a solid material such as fibrous material including textiles, items of clothing, woven and nonwoven materials or combinations thereof, etc., wherein the material is suspected of having microbial biofilm matter in one or more regions that may be associated with persistent odor or other symptoms, or used in an environment or application at risk of developing biofilm and/or persistent odor, the method comprising applying an enzymatic composition to the one or more regions of the solid material, providing suitable time for the enzymatic mixture to attack biofilm, and then washing the textile item, wherein the enzymatic composition comprises: (a) water, (b) from 5% to 60% of a surfactant, (c) from 1% to 20% of an enzyme mixture comprising at least two of lysozyme, proteinase, amylase, mannanase, lipase, pectinase, DNAse and cellulase; and (d) from 0.1% to 10% of N-acetyl cysteine. The enzymatic composition in some aspects is packaged with indicia instructing a user to wait at least 5, 10, 15, or 30 minutes between applying the enzymatic composition and washing the textile, wherein washing generally comprises washing in water with a laundry detergent but may comprise rinsing without use of further detergents. In some aspects, the enzymatic composition further comprises from 0.01% to 8% by weight of bacterial spores adapted to become active in response to the presence of contaminants selected from at least one of proteins, carbohydrates, lipids, and carbohydrates, the spores then producing enzymes that attack a portion of said contaminants. The spore concentration in the enzymatic composition may be from 1×10⁵ to 5×10¹⁰ CFU/ml.

The enzymatic composition in some aspects comprises at least two portions, a first portion comprising an enzyme mixture and a second portion comprising N-acetyl cysteine (NAC), further associated with indicia instructing a user to apply both portions to the one or more regions of the textile item associated with persistent odor. The enzyme mixture in this or other aspects is in a liquid or comprises dry granulated enzymes that are combined with liquid prior to application to an item of clothing or other material.

In some aspects, the second portion comprising NAC is in liquid or powder form separate from the enzymes but adapted to be combined with the enzymes on the clothing, such as by adding the powder or a solution to the clothing before, after, or while adding the enzyme mixture and other components of the composition. The second portion of the enzymatic composition may comprise from 1% to 90% N-acetyl cysteine, optionally from 1% to 10% panthenol, and sufficient alkaline agents such that when the second portion of the enzymatic composition is combined with enough water at pH 7.0 to bring the concentration of the N-acetyl cysteine to 1%, that the pH of the resulting aqueous mixture is at least 6.0. Such a composition can be effective in reducing the amount of biofilm matter present or the surface area with biofilm matter present in the textile item, and is also effective in reducing malodor in the textile item, while also being substantially free of non-enzymatic bleaching agents.

Some aspects also comprise visualizing the presence of suspected biofilm matter using UV light. In such cases, the textile item with malodor may have been treated with a suitable dye that fluoresces in UV light to identify one or more regions that show relatively high fluorescence in UV light, wherein the enzymatic composition is applied to at least one of the one or more regions that show relatively high fluorescence. Such a dye may comprise any known optical brightener such as Calcofluour White and other compounds known to preferentially absorb onto cellulose fibers and onto biofilm material.

Through extensive experimental work, possible solutions to reduce or eliminate perma-odor have been found using materials that are generally safe and suitable for use in consumer products and in some cases may even be known as edible dietary supplements or components of natural edible products, rather than harsh compounds or restricted pharmaceutical compounds. Application of the pretreatment followed by laundering can be effective in reducing perma-odor in clothing, and the effect is believed to be achieved at least in part by undermining biofilm material that may exist in articles with perma-odor.

The pretreatment can be applied with a liquid medium that is sprayed, poured, wiped, daubed, rolled on, or otherwise transferred to articles of clothing, particularly to regions suspected of having malodor. The liquid medium may be provided to the user in ready-to-use form, or may be provided as a concentrate such as a liquid, slurry, paste, or solid such as a powder that can be prepared by the user through addition of water or through the mixing of two or more components to create the ready-to-use composition. The pretreatment may involve comprise two or more physically distinct compositions, such as first and second sprays or mixtures in any suitable form (powder, paste, etc.) applied before or after the first spray is applied.

In some aspect, evidence for the existence of a biofilm is considered by the user in applying the pretreatment. Thus, in one aspect, a method of detecting and mitigating a microbial infection in an article of clothing comprises: 1) exposing an item of clothing one or more times to a solution comprising at least 0.001% of one or more fluorescent optical brighteners such as Calcofluor White (an optical brightener believed to be present in many common laundry detergents), 2) shining UV light on the item of clothing to determine if there is preferential absorption of optical brighteners in a region of the clothing, 3) treating the region with preferential absorption of optical brighteners with an effective amount of an enzymatic mixture comprising an effective amount of bacterial spores, one or more surfactants, and a mix of at least three laundry enzymes, 4) allowing the enzymatic mixture to reside on the clothing for an effective time, and then 5) washing the clothing to remove the enzymatic mixture, wherein the treatment results in reduction of fluorescence and/or reduced perma-odor characteristics. In a related aspect, the item of clothing is also treated with a biofilm attack agent such as NAC and panthenol.

In one aspect, the enzymatic mixture is provided as a liquid concentrate comprising: (1) surfactant at a concentration of 10% to 55%, more specifically 15% to 45%, and more specifically still from 20% to 35%, such as naturally-derived non-ionic surfactants derived from plant carbohydrates (e.g., from corn or potatoes) and from plant oils such as coconut and palm oil; (2) a mixture of at least 3, 4, 5, or 6 more different classes of enzymes, such as a mix of protease, cellulase, amylase, lipase, mannanase and pectinase (pectin lyase), wherein the enzymes are provided in liquid concentrate form that comprise from 5% to 20% of the mass of the mixture (including water), such as from 8% to 20% or 8% to 15%, wherein the total protein mass can be from 3% to 15% of the concentrate, the protease mass from 1% to 5% of the concentrate, and wherein the lipase comprises between 1% and 25%, or between 1% and 10%, or between 1% and 7% of the total enzyme mass (or, in some versions, the concentrate has less than 0.6% total lipase or is substantially lipase free); (3) from 1% to 10% salts for pH control and enzyme stability, such as from 1% to 4% sodium citrate and 1 to 4% sodium bicarbonate; (4) optionally an effective amount of a mixture of bacterial spores, such as Bacillus subtilis marketed by Novozymes Biologicals, Inc., USA or the spores described in US 20190284647, “Spore Containing Granule,” published Sept. 19, 2019 by P. Bach.

In another aspect, the bioenzymatic mixture ready for application to clothing comprises (1) an effective amount of bacterial spores comprising between 1×10⁵ and 5×10¹⁰ CFU/ml (colony forming units per ml) of bacillus spores, more specifically from 1×10⁷ and 5×10⁹ CFU/ml, such as from 1×10⁷ to 8×10⁸, (2) a mix of at least three or at least four or at least five laundry enzymes from at least three different categories of enzymes collectively having a total enzyme concentration from 1% to 20% and optionally no more than 1.5% or 3% lipase, (3) at least one surfactant such as non-ionic surfactants having a concentration from 5% to 40% in the bioenzymatic mixture, (4) at least 15% water such as from 10% to 80% water or from 30% to 80% water; (5) optionally from 1% to 10% of a solvent other than water such as propanediol, 3-phenyl-1-propanol, isopropylidene glycerol, propane diol, propane glycol, propylene glycol, glycerin, isopentyldiol, pentylene glycol (in general, any alkyl diol having from 3 to 9 carbons and a viscosity at 20° C. of at least 5 mPa-s and more specifically any 1,n-alkanediols for n less than 9), 2-methoxy-2-phenylethanol, 2-phenylethanol, methyl chavicol, and myristicin aldehyde. Liquid alkyl triols may be considered such as butanetriol. Esters having up to 7 carbons with carboxylic acids having up to 8 carbons may be considered.

In one aspect, an item of clothing is treated with a biofilm attack agent in a target region suspected of harboring a biofilm, the method comprising:
1) applying an effective amount of a naturally-derived biofilm attack agent to the target region, the biofilm attack agent being selected from one or more of N-acetyl cysteine, panthenol or a derivative thereof, and a biofilm attack enzyme such as DNase, lysozyme, etc.,
2) simultaneously, subsequently, or previously applying a bioenzymatic mixture comprising bacterial spores suitable for attacking typical energy sources for bacteria, one or more surfactants, and an enzyme mixture of three of more categories of laundering enzymes selected from proteases, cellulases, amylases, mannanes, lipases, pectinases, and DNases;
3) providing suitable conditions for the spores to become active (i.e., providing sufficient time such as 1 hour or more or 2 hours or more at a suitable temperature such as 15° C. to 60° C., 18° C. to 45° C., or 20° C. to 40° C. with suitable moisture such as at least 10% moisture in the item of clothing, or from 10% to 80%, 15% to 50%, or 20% to 50% moisture relative to the dry fiber weight);
4) washing the item of clothing in a washing machine with a detergent and then drying the item of clothing, wherein the method is effective in reducing the amount of biofilm matter present relative to what is possible with washing alone.

Applicant has found that “biofilm attack agents” (so termed even though our understanding of the theory behind the success of these agents may be incomplete) useful for undermining perma-odor may comprise one or more of:
1. N-acetyl cysteine (NAC). The NAC in some aspects is combined with panthenol or derivatives thereof, optionally various salts or buffering agents, optional surfactants, and other optional agents such as allantoin, cyclodextrin, zeolites, phosphates, chelants, enzymes, antimicrobials, catechins, bacterial phages and the like, wherein, without wishing to be bound by theory, NAC is believed to open up the biofilm at least temporarily in order to allow a second agent to be more effective, often giving strongly synergistic results in the reduction of perma-odor symptoms.
2. Lysozyme, pectinase, and other enzymes capable of attacking portions of the biofilm matrix or reducing the ability of the biofilm or bacteria to adhere to a fabric. Such other enzymes may include certain endoglucans or cellulases, proteinases, amylases, mannanases, DNase, alginate lyase, etc.

In one aspect, a laundering composition comprising a biofilm attack agent is provided for users to apply to an item of clothing suffering from strong odor. The composition may be provided as a powder, a liquid concentrate, or ready-to-use material that may be in the form of a liquid, a foam, a paste or slurry, etc., and may be provided in two or more containers for application in two or more steps, such as rubbing a paste or applying a foam or spraying a solution or sprinkling a powder onto a malodorous region of an article of clothing, followed by further treatment with another material such as spraying a solution, applying a foam, rubbing a paste, sprinkling a powder, etc., followed by rinsing or washing and drying.

Thus, by way of example, in one aspect, a method for removing persistent odor in clothing is provided comprising applying an aqueous composition to clothing prior to washing, comprising from 0.1% to 10% NAC, one or more laundering enzymes at a concentration of from 0.1% to 7% or from 0.5% to 5% or from 0.6% to 3%, and from 0.1% to 25% or from 0.5% to 10% of one or more surfactants, buffered or otherwise at a suitable pH such as from 2 to 6.7, 7 to 10.5, 6 to 8.5, 4.5 to 8, 3 to 6.5, 2.5 to 5, 7 to 11, 8 to 10.5, 7.5 to 10, and so forth. In another aspect, a powder comprising NAC particles may be applied to an item of clothing that is wetted by an enzymatic blend optionally also comprising one or more surfactants, panthenol, etc.

In one aspect, a multi-step method to reduce perma-odor comprises:

a) identifying an article of clothing with persistent odor in one or more odorous regions such as the regions adjacent armpits or other high-odor or high-sweating zone of the human body, or alternatively, displaying evidence of biofilm material when viewed under UV light,

b) treating the article of clothing by applying a first solution comprising N-acetyl cysteine (NAC) such that at least 0.1 g, 0.2 g, or 0.3 g of NAC per 50 cm² area is delivered to the one or more odorous regions; and

c) applying a solution comprising one or more laundry-suitable enzymes, and optionally one or more species of bacterial spores selected for the ability to assist in cleaning of textiles by producing one or more laundry-suitable enzymes in response to the presence of suitable contaminants; such that both NAC and the enzymes and/or spores are present simultaneously. (The first and/or second solution may further include surfactants such as polyalkoxy glycosides, sodium laureth/lauryl sulfate, etc., which may be applied before or after the steps mentioned above.)

A related product comprises a container comprising NAC particles or solution and one or more compounds selected from panthenol and derivatives thereof; zinc, ammonium, or alkali metal (sodium, potassium, magnesium, calcium, etc.) salts such as chloride salts, carbonate salts, bicarbonate salts, citrate salts, formate salts, sulfate salts, phosphate salts, etc.; buffering agents; fragrance and/or odor reduction compounds that mitigate the odor of NAC. The container may comprise pouches that can be torn or cut open to mix with a laundry preparation or with water or sprinkled directly on clothing that is moist or will be moistened with water and/or laundry preparations such as an enzymatic blend delivered from a spray bottle or other applicator, etc. The product may be associated with indicia that directs users to apply the product to textiles in combination with enzymatic materials. Enzymatic material may be applied first, after NAC application, or simultaneously with NAC.

In one aspect, a laundry pretreatment with a biofilm attack agent is followed by or simultaneous with treatment by a cleaning composition comprising one or more of (1) enzymes effective in stain removal or laundering (e.g., proteinases, lipases, amylases, mannanases, cellulases, etc.), (2) a detergent, (3) optionally an antimicrobial agent such as a chemical antimicrobial agent.

In another aspect, the biofilm attack treatment is followed directly by washing such as in a top-loading or front-loading machine in cold, warm, or hot water using known laundry detergents such as Tide®, Gain®, Persil®, Arm and Hammer®, and the like. The laundry detergent may comprise a variety of laundering enzymes and surfactants, chelants, builders, bleaching agents, etc.

In one aspect, the method for odor control further comprises providing suitable time for the biofilm attack agent and/or cleaning composition to be effective, such as a dwell time before adding the cleaning composition or a dwell time before washing of at least about 2, 5, 10, 15, 20, 30, or 60, minutes, or 2, 4, 6, or 8 hours, such as from 3 minutes to 1 hour, 5 minutes to 30 minutes, 3 minutes to 3 hours, 30 minutes to 8 hours, 1 minute to 30 minutes, etc. In one aspect, the user is provided with the biofilm attack agent and the cleaning agent, with suitable instructions. In another aspect, the user is provided with the biofilm attack agent, the cleaning agent, and a detergent, with instructions.

### NAC in Cosmetics and Personal Care Products

For NAC-containing products in fields such a personal care, cleaning, etc., we have also discovered that aqueous solutions of NAC, as well as various cosmetic formulations comprising NAC such as emulsions, serums, creams, and solid sticks that normally might have sulfurous odor from NAC can have the odor substantially reduced by adding certain additives such as phosphate or polyphosphate compounds (e.g., phosphate salts, salts of metaphosphate, trimetaphosphate, and/or hexametaphosphate, particularly sodium hexametaphosphate or SHMP), betaine compounds such as coco betaine, sultaine compounds such as hydroxysultaines (e.g., cocoamidopropyl hydroxysultaine), and EDTA. In emulsions, sticks, etc., NAC can be combined with NAC-odor control agents in an aqueous phase that can then be combined with an oil phase or silicone phase (including silicone and oil phases). While the effectiveness of any NAC-odor control agent may depend on pH, etc., we have found sodium hexametaphosphate, for example, to be versatile in its performance under various conditions, often leading other candidates in its odor suppression ability relative to NAC odor.

Thus, in one aspect, a personal care or cleaning preparation is provided comprising at least 0.5% N-acetyl cysteine and an agent effective at reducing the odor of N-acetyl cysteine selected from phosphate salts, polyphosphate compounds, betaine compounds, sultaine compounds, and EDTA. In one aspect. the mass of phosphate salts and polyphosphate compounds is at least 20%, 25%, 30%, 35%, 40%, or 50% of the mass of N-acetyl cysteine. Generally, “personal care compounds” as used here refer to compounds for topical use on the body or for application to solid surfaces such as in household cleaning of items such as bathroom and kitchen surfaces, fabrics and textiles, or regions where biofilm may be present, including care of facial skin, underarms, the scalp, nails, etc. In a related aspect, a personal care product may comprise 0.5% to 5% N-acetyl cysteine, at least 10% water, an odor control agent effective at reducing the odor of N-acetyl cysteine selected from phosphate salts, polyphosphate compounds, betaine compounds, sultaine compounds, and EDTA, wherein the mass ratio of the odor control agent relative to N-acetyl cysteine is at least 20%.

In a related aspect, a cosmetic or cleaning preparation may comprise at least 0.5% N-acetyl cysteine, at least 1% of a diol or polyol, and at least 0.3% to 6% of an agent effective at reducing the odor of N-acetyl cysteine. The preparation may be in the form of a solid such as a solid stick for application to the body or other surfaces, held in a suitable container, further comprising 10% to 80% of a hydrophobic base comprising lipids, optionally from 5% to 40% silicone materials or a total of at least 40% lipids and silicone materials, and may have less than 20% water such as from 1% to 8% water, with an effective pH of 2.5 to 4, 2 to 4.5, or 2.5 to 3.8, and may contain 1% to 25% starch such as from 4% to 20% starch or at least 4% starch. Alternatively, the solid may comprise than 8% water and from 5% to 40% silicone material and from 15% to 70% lipids. In one aspect, the solid material may comprise an acidic material selected from Vitamin C and derivatives thereof and alpha hydroxy acids, wherein the acidic material plus the N-acetyl cysteine comprises from 3% to 16%, 4% to 23% or 2% to 10% of the preparation, and wherein the preparation comprises at least 40% of a hydrophobic material selected from lipids and silicone materials, and comprises from 0.5% to 10% emulsifiers and from 1% to 25% of a solvent that is liquid at 25° C. selected from water, alcohols, diols, and polyols, wherein the acidic material is soluble in the solvent, such that upon cooling, the solid is substantially free from tangible grit formed from precipitated acidic material, and the preparation is a solid at 25° C. having an effective pH from 2 to 4.5.

In one aspect, a skin-care serum is provided comprising from 0.2% to 6% 0.5% to 5%, or 0.6% to 7% N-acetyl cysteine, from 5% to 20% Vitamin C or derivative thereof, and from 0.2% to 3% panthenol or derivatives thereof, having a pH from 2.4 to 4.3, 2 to 4.5, 2.5 to 4.5, 2.5 to 4.2, or 2.5 to 3.8, optionally being substantially free of acrylamide compounds and having less than 15% lipids.

In one aspect, the preparation may comprise antimicrobial agents such as the cationic steroidal antimicrobial (CSA) compounds described in U.S. Pat. Nos. 7,754,705, 9,603,859, and US Patent Application 20150374719. For example, CSA compounds may be present in an aqueous solution at a concentration of from 0.01% to 1%, such as from 0.01% to 0.5%, or from 0.02% to 0.4% by weight.

Cleaning Products with NAC. A related discovery is that NAC can be combined with enzymes and/or surfactants to weaken biofilm in a variety of settings. Cleaning benefits have been seen in solutions of NAC and enzymes applied to sinks, showers, toilets, etc. A useful aqueous NAC solution may comprise from 0.3% to 25% NAC, such as from 0.5% to 10%, from 0.5% to 6%, or from 0.5% to 4% such as from 0.5% to 2.5%, with 0.5% to 15% or 1% to 8% enzymes such as protease, lipase, cellulase, pectinase, etc., optionally combined with 1% to 20% surfactants (e.g., anionic, cationic, nonionic), optionally 0.5% to 10% salts such as sodium citrate or lactate, optionally 0.5% to 3% panthenol or derivatives thereof, at a pH from 2 to 11, such as from 3 to 9, 4 to 9, 4 to 7, etc. Such cleaning products may be applied to a surface with biofilm by spray, wipe, sponge application, pouring, etc., and once the surface is wetted, may be allowed to sit for at least 1 minute such as from 3 to 30 minutes or longer if desired, followed by wiping or scrubbing to clear away biofilm.

In some aspects, NAC is combined with “biofilm softening” agents and/or skin softening or skin permeability enhancing agents, including panthenol, for increased efficacy such as weakening of biofilm in pores of the skin or other surfaces.

The NAC solution may be applied to surfaces suspected to have biofilm material or odor problems or bacterial infection, and may be allowed to sit where applied for an effective time such as from 1 minute to 24 hours, or from 2 minutes to 8 hours, at least two minutes, at least 10 minutes, at least 20 minutes, or from 10 minutes to 8 hours (unless otherwise specified, these times may overlap with the time other agents are also present that may be added before or after application of the NAC solution, such that a 30 minute dwell time may be achieved by adding NAC solution to an article, and then 5 minutes later applying an enzymatic mixture, and then allowing the article to sit for another 25 minutes before laundering or washing).

An enzyme and/or surfactant solution (a cleaning solution) may further be applied to the region treated with NAC solution, either in a pretreatment prior to laundering or washing by adding a mix that may reside on the treated region for an effective period of time similar to the effective times mentioned for NAC solution or by directly cleaning or laundering with cleaning agents such as laundry detergents comprising enzymes and/or surfactants. The pH of the NAC solution may be adjusted such that it does not hinder the efficacy of enzymes or bacterial spores. For many laundry detergents, a NAC solution pH may be from 4 to 10, such as from 5 to 9, 5.5 to 10, and 6 to 9. The cleaning solution may optionally comprise bacterial spores such as Subtilis bacillus spores and other spores.

While NAC can interfere with enzyme activity in several ways, we have found that by properly adjusting concentration and pH, NAC can be combined with laundering enzymes with excellent results, including enhanced stability of enzymes over time. For example, a NAC solution can be prepared with from 0.2% to 6% NAC in a solution having from 0.5% to 10% or from 1% to 5% enzymes (solids basis) such as a mixture of lipase, protease, cellulase, mannanase, and amylase such as mixtures marketed for laundry detergents by Novozymes, 5 to 20% surfactant, 1 to 10% salts, 40% or more water, etc., and optional bacterial spores.

We have also found that cosmetic formulations high in NAC can be made in the form of solid or semi-solid sticks for use in odor control or other objectives, even at low pH, a condition which defeats many prior approaches to making deodorant sticks. We have also found that useful creams, lotions, pastes, solutions, oral care products, etc. can be manufactured with NAC that may be of use in various topical and personal care applications. These advances are detailed more fully in US Patent Application Ser. Nos. 63/014,100, filed Apr. 22, 2020; 63/055,305, filed Jul. 22, 2020; and 63/066,426, filed Aug. 17, 2020.

Applicant has found that successful acidic antiperspirant sticks can be made in compositions comprising lipids or lipids and silicone compounds by combining an oil, silicone, or oil-silicone phase with a relatively viscous acidic phase comprising one or more acidic components such as mandelic acid or other alpha-hydroxy acids and N-acetyl cysteine, wherein a the viscous acidic phase has a viscosity substantially greater than that of water, such as at least 5 times higher (e.g., at least 5 centiStokes). The acidic thickener such as an aqueous starch mixture, a polyol such as propane diol, gums or water-swellable polymers or minerals dispersed in water, etc., is present in the aqueous phase, making it substantially more viscous than water. Such a thickened acidic aqueous phase can be combined with a heated oil phase or oil-silicone phase in the presence of an emulsifying-effective amount of a dermatologically-acceptable emulsifier and/or a gelling-effective amount of a dermatologically-acceptable gelling agent, after which optional agents such as dry powders (e.g., starch, silica materials, silicone powders such as polymethyl-silsequioxane, etc.) can be combined with the emulsion or blend of an aqueous phase and an oil or oil-silicone phase, along with other finishing agents such as presservatives, fragrances, other silicone liquids, volatile materials such as volatile silicones, etc. In general, all ingredients should be safe for the quantities used for products intended for use on human skin.

In some aspects, the acidic stick has from 10% to 50% lipids, from 10% to 40% silicones, from 5% to 25% starches or starch derivatives, from 0.5% to 10% acidic agents such as mandelic acid and N-acetyl cysteine (NAC), and may have less than 20%,15%, or 10% water. The stick may be formed by providing the acidic components in a thickened aqueous phase having a viscosity of at least 5 cps at 25° C. which is heated and blended into an oil phase or oil-silicone phase or silicone phase, followed by blending other components, such as powders or finishing agents.

Thus, in one aspect, a novel acidic stick comprises a solid or semi-solid waxy phase comprising one or more waxes and/or other lipids, a starch or starch derivative, a thickener, and at least 1% of an alpha-hydroxy acid (e.g., mandelic acid, citric acid, glycolic acid, lactic acid, malic acid, tartaric acid, etc.) associated with the thickener, wherein the alpha-hydroxy acid is substantially uniformly dispersed in the stick. The acidic stick may have from 0.2% to 20% water (e.g., from 3% to 15%), 1% to 9% alpha hydroxy acid, 5% to 35% silicone compounds, 10% to 40% lipids, 0.5% to 10% emulsifiers or gelling agents, and 2% to 20% starch or starch derivatives. It may also comprise from 0.5% to 10% of a polyol and optional antiperspirants.

We have found that successful acidic deodorant sticks can be made in relatively low-moisture formulas with silicones and lipids or substantially anhydrous formulations, achieving high levels of acidic ingredients such as mandelic acid and/or N-acetyl cysteine, without creating compositions that can are perceived as gritty. In particular, we have found that certain techniques such as significantly elevating the viscosity of the aqueous phase, in combination with carefully selected ingredients and other innovative formulation methods, can overcome multiple problems that hindered the development of a successful deodorant stick with high mandelic acid content. Through the approaches and formulations described herein, we have found that high levels of mandelic acid and other solids can be present in a minor aqueous/polar phase that, when combined with an oil/non-polar phase (including silicone or oil-silicone phases), can subsequently be cooled to room temperature without leading to the formation of perceptible grit and without evidence of skin irritation from nonuniformity in the distribution of acidic components. The resulting solid can have a smooth feel that can be applied comfortably without undue risk of skin irritation.

Surprisingly the approaches described herein seem to be able to solve multiple problems at once, including one or more of: a) difficulties in forming a stable dispersion involving oil and water phases at low pH, b) the problem of skin irritation from large pockets of alpha hydroxy acid in the cooled stick, c) the problem of poor texture due to a gritty feed from precipitated solids that were once in or largely in the aqueous phase, and d) the difficulty of having the acidic components sufficiently accessible to the skin to be able to modify the skin microbiome and/or effectively reduce malodor from certain bacteria.

Further, we have discovered that acidic sticks, creams, masks, and serums can be made acidic not only with alpha-carboxylic acids such as mandelic acid or lactic acid or other acids such as Vitamin C, but may have other positive effects on the skin and skin microbiome using N-acetyl cysteine, which may help hinder growth of biofilms and undesirable bacteria while also having other skin health benefits.

We have therefore found that personal care deodorant and antiperspirant compositions comprising effective levels of alpha hydroxy acids such as mandelic acid and/or other acidic materials can be formulated in a solid stick for convenient application to the underarms or other regions of the body. Such sticks can also comprise caffeine and may be substantially aluminum free and zirconium free or may comprise significant amount of aluminum and/or zirconium compounds, such as at least 3% by weight, at least 5%, 8%, 10%, 12%, or 13%, such as from 3% to 30%, 3% to 25%, 3% to 20%, 5% to 24%, etc.. In some aspects, the composition is prepared by combining one or more acidic materials such as mandelic acid in a solvent to create an “acid paste” having a viscosity substantially greater than water such as at least 5, 50, 100, or 200 times greater than water. The acid paste may comprise water, water and one or more polar solvents, or a polar organic solvent other than water, with an thickener such as a starch, a gum, minerals such as laponite, polymers such as polyacrylate and other acrylate polymers or copolymers (e.g., acrylates/C10-30 alkyl acrylate crosspolymer, crosslinked copolymers, such as Carbopol® Aqua SF-1 or Polyacrylate-14 marketed by Lubrizol Corp.) or carbomer (crosslinked homopolymers of acrylic acid, e.g., Carbomer 980) or polyquaternium compounds (e.g., Polyquaternium 4, 7, 11, 47), high-viscosity polar solvents, gelatin, or other agents that swell in water or other solvents. (In some aspects, though, it or other products herein may be substantially free or have less than 0.2% of polyquater-nium compounds, or acrylates, acrylamides, or crosslinked polymers.) The resulting viscous acidic mixture is, as defined herein, an “acid paste” that can be combined with a non-aqueous phase (an oil and/or a silicone phase) to form an emulsion or other mixture that can be cooled to form a solid stick, optionally after adding ingredients such as fragrances, powders (e.g., starch, silica, silicone materials, other solids), liquids (e.g., esters, alcohols, or silicone liquids such as an alkyl silicone liquid), etc. The acid paste when added to the other ingredients, prior to evaporation of water, may comprise 1% to 35% of the mixture, such as from 3% to 25%, 3% to 20%, 3% to 15%, and 5% to 17%.

For example, we have found that an aqueous solution of mandelic acid or other soluble acidic materials can be used, such as a solution comprising from 2% to 40% total of mandelic acid and/or NAC in water at a suitable temperature, or water combined with other polar solvents such as propanediol, glycerin, ethanol, propylene carbonate, or other alcohols, glycols, or esters, or in some aspects, in a solution of such polar organic solvents that may be substantially free of water.

The viscosity of the acid solution can be elevated to be substantially greater than that of water using a thickener such as a gum, a starch (corn starch, tapioca starch, potato starch, cassava, arrowroot starch, chemically modified starches such as modified food starch, cold-water soluble starches, and the like), a polymer such as a polyacrylate or copolymers thereof or known superabsorbent polymers, hydroxymethyl cellulose or other water soluble cellulosic derivatives, water-swellable polyurethanes such as those described in WO2004029125A1, polyethylene glycol (either liquids such as PEG 400 or aqueous solutions of solids such as polyethylene glycol 3350) and other polymeric polyols, etc. Thickener levels relative to the solvent mass may range from, for example, 0.1 to 15 weight percent, such as at least 0.3, 0.5, 1, 2, 3, 4, 5, or 6 weight percent, up to one of any suitable integer from 2 to 15 weight percent, from 2 to 10 wt%, from 2 to 6 wt%, etc. When starch is used, the starch and solvent is then heated until the starch grains swell (gelatinize) and cause the slurry to become thickened. In water-starch slurries, this may occur between about 50° C. and 80° C., for example, with many native starches tending to gel around 60° C. to 71° C. Rather than gelling with the addition of heat, a soluble starch may be used that is soluble in cold water. The resulting acidic starch paste has elevated viscosity and reduced opacity relative to the initial slurry. An appropriate amount of this slurry, which may be heated to temperature from 40° C. or 50° C. to 70° C. or 80° C., for example, and can then be combined with a molten waxy phase or oil-silicone phase to create a dispersion or emulsion that does not readily separate. Emulsifying waxes, other emulsifiers, or gel-producing agents such as hectorite particles or other minerals may be present but need not be used.

The dispersion may be blended with additional agents such as powdered starch or other powders including laponite, talc, hydroxyapatite and derivatives thereof, magnesium hydroxide, magnesium stearate, zinc stearate, zinc oxide, other zinc compounds, antiperspirant salts such as aluminum and zirconium salts, silica, sillylated silica or other solids, microspheres, and the like. In some aspects, however, the deodorant stick is substantially free of aluminum salts and/or zirconium salts.

In another aspect, a water/oil emulsion or dispersion comprising mandelic acid associated with an aqueous solvent in an aqueous phase is heated to drive off a portion of the water such as at least 20%, at least 40%, or at least 60% of the water, with exemplary ranges of 20% to 90% or 30% to 80%, resulting in a highly uniform distribution of mandelic acid throughout a waxy phase. For example, mandelic acid may be dissolved in a mixture of water and an alcohol such as ethanol that may also comprise other solvents such as glycerin or propanediol, and this ethanol-water-acid mixture is combined with a mix of waxes, fatty acids, esters, butter, oils, and related lipids. Emulsifying waxes can be helpful in promoting good mixing. During heating, the solids melt and can form a dispersion or emulsion with the ethanol-water-acid mix dispersed in the oil phase. As heating continues, water and ethanol may be driven off, resulting in a waxy material with mandelic acid finely dispersed throughout. Prior to cooling, the melt may be combined with a starch such as arrowroot starch to provide additional tactile properties, and may then be poured into a container.

Thus, in one aspect, a cosmetic stick comprises from 0.2% to 12% weight acidic materials distributed substantially uniformly throughout a solid or semi-solid waxy phase, such that the composition at room temperature is free of tangible or visible acid grains or crystals. In some aspects, the acid such as mandelic acid or NAC is associated with starch granules dispersed throughout the stick.

In some aspects, silicone materials such as cyclopentasiloxane, dimethicone, silica silylate, silica dimethyl silylate, trimethylsiloxysilicate and trifluoropropyldimethyl/Trimethylsiloxysilicate and other siloxanes can be present and may be combined with waxes and oils to impart slip or other tactile or rheological properties or to improve delivery when rubbed against the skin. The silicone content may be from 1 to 50%, such as from 1% to 40%, 5% to 40%, 3% to 36%, 1% to 25%, 8% to 39%, or from 11% to 40%. Silicone-treated silica, silicone-coated particles, silicone microspheres, and other particles comprising silicone may be considered.

In some aspects, the composition may be substantially free of volatile silicone compounds such as volatile cyclic silicone oils, in particular cyclotrisiloxane, cyclotetrasiloxane, cyclopentasiloxane, and cyclohexasiloxane. The composition may also be substantially free of volatile nonsilicone oils, such as any one or more of isodecane, isopentadecane, and isohexadecane, or may be substantially free of C8-C20 isoparaffins or C8-C16 isoparaffins. The effective pH may be from 2 to 6, such as from 2.8 to 5.7, from 3 to 5.5, from 3.2 to 5.5, and from 3.5 to 5.4.

Without wishing to be bound by theory, one role of a low pH of the skin is to limit the growth of the bacteria that produce undesirable odors. A reduced pH may also create an environment that protects or maintains healthy microbial flora on the skin, thereby controlling the less desirable bacteria that may produce unwanted odor.

We have also found that a variety of creams, pastes, lotions, and other cosmetic or personal care products can be made using NAC and other related compounds such as N-acetyl glucosamine, N-acetyl methionine, L-cysteine, and nacystelyn (NAL), a lysine salt of N-acetylcysteine (NAC) and salts of any of the above such as, for example, L-cysteine HCL monohydrate. For example, NAC or related compounds dissolved in a solvent such as propane diol, water, water and a thickener, propylene glycol, or other solvents and combinations thereof can be blended with a variety of known lotion products or formulations, optionally with additional agents such a sodium methyl cocoyl taurate, GLDA, EDTA, hydroxysultaine or betaine compounds, or various compounds that are effective in reducing the odor of NAC and/or the flavor of NAC, which can hinder consumer acceptance of many cosmetic and oral care products if NAC is added at a significant level (e.g., above 0.1%, 0.3%, 0.5%, 1%, etc., such as from 0.1% to 10%, or any numerically feasible combination of lower and upper limits each selected from the series of numbers between 0.2% and 15% in increments of 0.2%, i.e, 0.2, 0.4, 0.6, . . . 14.8, 15.0, such as from 0.4% to 14.2% or 0.2% to 12%). In preparing a lotion, cream, paste, or other cosmetic or personal care product, the NAC or related compound is generally dissolved in an aqueous phase or hydrophilic phase that may comprise anhydrous solvents, which may comprise gelatinized starch, thickening polymers, gelatin, gums, high-viscosity polyols and other thickeners, and may then be blended in with an oil phase or a cream, lotion, paste, ointment, or other cosmetic or personal care agent. Odor control agents may be provided that interact with NAC to reduce its characteristic odor, or flavor control agents such as combinations of essential oils in sorbitol or other sugar alcohols, etc., may be added.

### BRIEF DESCRIPTION OF THE DRAWINGS

FIG. 1 depicts a shirt with UV-fluorescent biofilm-laden zones in the armpits of a shirt being illuminated with UV light.

FIG. 2 depicts spraying a cleaning composition on a biofilm region.

FIG. 3 depicts a flowchart showing a process in which biofilm visualization is used to guide treatment of clothing with persistent odor.

FIG. 4 depicts a flowchart showing steps in a process for treating clothing with persistent odor while also treating odor on the skin of the wearer.

FIGS. 5A and 5B depict dispensing options, such as a roll-on applicator (5A) for applying a composition to portions of clothing or a pod (5B) for a wash cycle.

FIG. 6 depicts a packaged product with an assembly of a pre-treatment cleaning composition, a biofilm attack agent, and tablets or capsules to be used in a washing machine to reduce biofilm and odor sources.

FIG. 7 depicts another assembly comprising a pre-treatment spray and a biofilm attack agent that can be added to water to form a biofilm attack solution, both of which can be used to spray malodorous regions of clothing or suspected biofilms.

FIG. 8 depicts a flowchart showing steps in a process for treating clothing with persistent odor.

FIG. 9 depicts a spray bottle containing a biofilm attack agent inside.

FIGS. 10A to 10F present photos of a blue polyester sports shirt showing evidence of fluorescence from biofilm matter in the shirt that can absorb optical brighteners.

FIGS. 11A to 11O show photos of a gray polyester sports shirt previously afflicted with perma-odor, showing remnants of a possible biofilm visible via Calcofluor White fluorescence in UV light.

FIGS. 12A and 12B show photos of the right and left pits of a triathlon shirt under UV light.

FIGS. 13A and 13B show views in UV light of the left and right pits of a lace dress with a perma-odor problem, displaying strong fluorescence in the pit.

FIGS. 14A and 14B show views of the pits of the lace dress in UV light after treatment with bioenzymatic liquid and a biofilm attack agent.

FIGS. 15A and 15B are before-and-after images of a biofilm region in the lace dress taken with confocal microscopy with a UV laser and no added dye.

FIG. 16 is a flow chart showing one aspect of a method for making a stick composition for various products described herein.

FIG. 17 depicts a roll-on dispenser for applying materials described herein to various surfaces.

FIG. 18 depicts a container comprising first and second wells holding ingredients useful in cosmetic or cleaning applications, including NAC.

FIG. 19 depicts an assembly with containers holding various components of a cleaning system for pretreating and treating a surface.

### DETAILED DESCRIPTION

As used herein, “detergent composition” refers to compositions for removal of undesired compounds from surfaces such as textile surfaces. Such compositions may be in any suitable product form such as liquid, gel, slurry, dispersion, powder, solid stick, granulate, paste, or spray compositions. It may include liquid and/or solid laundry detergents and fabric detergents and may comprise one or more enzymes such as hemicellulases, peroxidases, proteases, cellulases, xylanases, lipases, phospholipases, esterases, cutinases, pectinases, mannanases, pectate lyases, keratinases, reductases, oxidases, phenoloxidases, lipoxygenases, ligninases, pullulanases, tannases, pentosanases, malanases, beta-glucanases, arabinosidases, hyaluronidase, chondroitinase, laccase, DNase, chlorophyllases, amylases, perhydrolases, peroxidases, xanthanase and mixtures thereof. The detergent composition may further comprise ingredients such as surfactants, builders, chelating agents, bleach system or bleach components, polymers, fabric conditioners, foam boosters, suds suppressors, dyes, perfume, tarnish inhibitors, bactericides, fungicides, soil suspending agents, anti-corrosion agents, enzyme inhibitors or stabilizers, enzyme activators, transferase(s), hydrolytic enzymes, oxido reductases, bluing agents and fluorescent dyes, antioxidants, and solubilizers, etc.

As used herein, “derivatives of panthenol” may include pantothenic acid and salts thereof (e.g., the calcium, sodium, potassium salts, etc.), pantethine, pantetheine, and so forth. Panthenol is closely related to its derivative, pantothenic acid, and pantethine (bis-pantethine or co-enzyme pantethine), a dimeric form of pantetheine produced from pantothenic acid (vitamin B5) by addition of cysteamine. However, in one aspect, a composition may be substantially free of pantothenic acid while containing panthenol or derivatives thereof.

As used herein, ranges such as concentration ranges for a compound may have a lower limit and an upper limit selected from any suitable concentration value mentioned for that compound. In aspects where a compound is to be excluded or kept at a low level, the concentration range may be from zero or substantially zero (e.g., 0.1%, 0.05%, 0.01%, 0.001%, 100 ppm, 10 ppm, or 1 ppm) to an upper limit of any concentration mentioned herein for that compound or salts thereof.

As used herein, “effective pH” refers to a measure of the pH of a solid or semi-solid deodorant material or related material when it is combined with distilled water. About 0.100 g (e.g., from 0.085 to 0.13 g) of the material is placed in a weighing dish and combined with a mass of distilled water equal to twice the mass of the matter being tested. The weighing dish should be the 7-ml volume plastic intermediate dish provided with the Smart Weight Gem50 jewelers balance (0-50 g, milligram precision digital scale). The material being measured is combined with water and then smeared in the dish by hand to contact the water thoroughly with the material, blending for about 10 seconds. After 15 more seconds, a pH paper strip is contact with the water phase to read the pH. The pH paper may be the Hydrion® 3.0 to 5.5 strip, the Hydrion® 0 to 6.0 strip, or the Lab Essentials™ Universal 1-14 pH Paper, relying on the paper with the smallest range that encompasses the pH of the material being measured. Note that with pH paper, as water wicks up the paper, its pH may change as acidic components are absorbed by or reacted with components in the paper, so the leading front of water wicking into the paper may display a more neutral pH than what is indicate in the main body of the wetted paper, so the pH near the leading edge of the wicking front should be disregarded. In some aspects, the deodorant stick materials disclosed herein may have effective pH values less than 7, such as from 2 to 6.5 or any other pH range discussed herein or with upper or lower limits selected from any pH value discussed herein or in other citations.

### N-Acetyl Cysteine

NAC solutions in the range of 0.01% to 15% or more appear to be useful in reducing biofilm on fabrics with persistent odor, especially when combined with or followed by treatment with additional agents such as panthenol or derivatives thereof, laundry enzymes or other enzymes, detergents, and various solvents. Suitable formulations may have 0.1% to 13%, 0.5% to 13%, 1% to 10%, 0.3% to 8%, and 0.5% to 6% NAC, such as from 0.7% to 3.5% NAC.

Other agents can also be considered such as “biofilm modification” agents to soften a biofilm or enhance its permeability, such as 2′-hydroxycinnamic acid, 3-methyl-2(5H)-furanone, phenyl propanol such as 3-phenyl-1-propanol, propane diol, propane glycol, pentylene glycol, DMSO, panthenol, pantothenic acid, glycerin, 3-methoxyphenylacetic acid, 4′-hydroxyphenylacetic acid, 2-methoxy-2-phenylethanol, 2-phenylethanol, methyl chavicol (Basil oil) and other essential oils, myristicin aldehyde, 3,4-dihydroxybenzoic acid, and isopropylidene glycerol. They may be present at levels of at least 1%, 3%, or 5%, or from 0.5% to 15%, 1% to 8%, etc.

In some aspects, the composition may be substantially free of any or all of the following or any subset: ethanol, methanol, propanol, alcohols, alcohols having 3 or fewer carbons, alcohols having 2 or fewer carbons, glycolic acid, acetic acid, critic acid, latex, spermicides, triethylamine, trimethylamine, ammonia or complexes thereof, amines, polyhydroxy fatty acids, polyhydroxy acids, alpha-hydroxy acids having 14 or greater carbons, fatty acids, polyhydroxy fatty acid esters (or polyhydroxy fatty acid derivatives such as esters, amides, and alcohols), benzoic acid, parabens, preservatives, perfumes, artificial colors, sodium bicarbonate, bicarbonates in solid or ionic form, retinol, or Retin-A. “Substantially free” in this context may mean lacking an effective quantity. For alcohols and acids this may be taken as less than 0.1%. In some cases, the concentration may be less than 0.05%.

### Bacterial Spores and Other Microbial Agents

Bacterial spores used herein may be any of those described in U.S. Pat. No. 9,228,284, “Mitigation of odor in cleaning machines and cleaning processes,” issued Jan. 5, 2016 to S.C. Mchatton, et al., particularly the strains of B. subtilis. See also U.S. Pat. No. 9,756,862, “Proportioner-ready bioenzymatic concentrated cleaning product,” issued Sep. 12, 2017 to D. A. Cooper et al.

The spores are obtained from non-pathogenic spore-forming microorganisms that are capable of reacting with and removing various organic substances. Such spores can produce extracellular enzymes that may include protease enzymes, urease enzymes, amylase enzymes, lipase enzymes, cellulase enzymes, and combinations thereof. Commercially available concentrated of spores suspended in liquid may be used. Such spore concentrates may comprise from 1% to 50% of the compositions described herein, or from 5% to 30% or from 10% to 25%. The bacillus spores may constitute 0.05% to 60% by weight of the spore concentrate, and after blending with enzymes, surfactants, and other agents to form a concentrate or ready-to-use mixture for treating laundry, the bacterial spore concentration may be from about 0.01% to about 10% or 0.05% to 5%, or from 0.1% to 4%. Alternatively, the number of colony forming units (CFU) per ml in the concentrate or diluted mixture may be 1×10⁵to 1×10¹⁰, 1×10⁵to 1×10⁹, or 1×10⁶to 1×10⁸.

### Enzymes

Enzymes, particularly hydrolases, have been used as a tool for laundering fabrics for decades. Among hydrolases, proteinases, amylases, cellulases and mannanase are also commonly employed in some products. Lysozymes, pectinases, and DNases may also be considered.

Enzymes may be of any suitable origin, such as vegetable, animal, bacterial, fungal and yeast origin, and may be modified in various ways and expressed via host organisms in which the genetic material responsible for the production of the enzyme has been cloned. The enzymes can be added as separate single ingredients (prills, granulates, stabilized liquids, etc. containing one enzyme) or as mixtures of two or more enzymes (e.g. cogranulates or blends in solution).

There are a wide variety of specific enzymes. Numerous powder and liquid detergents for washing machines, including machines for clothes washing as well as dish washing, comprise blends of enzymes to provide detergency effects. Enzymes useful with the formulations described herein may include any combination of lipases, proteases, amylases, cellulases and mannanases, pectinases, hemicellulases, peroxidases, lysozymes, xylanases, phospholipases, esterases, cutinases, pectinases, laccases, keratanases, reductases, oxidases, lipoxygenases, ligninases, pullulanases, pentosanases, malanases, β-glucanases, DNAse, etc. However, in some aspects the composition may be substantially free of particular enzymes, such as substantially free of any particular class of enzymes such as lipase or laccase (e.g., having less than 0.2%, less than 0.1% or less than 0.05% by weight of the excluded enzyme or enzyme category) or substantially free of bacteria or bacterial spores. One may limit lipase, for example, to less than 25%, 15%, 10%, or 5% of the enzymes present, with lower limits of, say, 1%, 3%, 5%, or 10%, when feasible.

As used herein, “laundering enzymes” refers to enzymes commonly incorporated into laundry detergents, both liquid and granulated detergents, such as lipase, cellulase, mannanase, protease, pectinase, and amylase. These are often engineered to be active at an alkaline pH such as from 7 to 9.5 or 7.5 to 8.5 but may individually or collectively be adapted for optimum performance in other pH ranges such as from 3 to 12, 3 to 6, 4 to 7, 5 to 8, 6 to 8, 4.5 to 8.5, 5 to 7.6, 3.5 to 6.5, etc. Enzymes may be incorporated in a product at levels from 0.01% to 20% of active enzyme by weight, or from 1% to 15%, 2% to 12%, and the like.

Proteases (sometimes known as peptidases) may include serine proteases, which include a serine group in the catalytic center, or metallo proteases, cysteine proteases (including papain and bromelain), aspartic proteases, threonine proteases, and the like. Examples of alkaline proteases are subtilisins such subtilisin Novo, subtilisin Carlsberg, subtilisin 309, subtilisin 147 and 168, and Subtilisin A. Other serine proteases from Novozymes include: Alcalase®, Savinase®, Esperase®, Neutrase® (E.C.3.4.24), rTrypsin® (EC 3.4.21.4); nattokinase, and SAPV peptidase.

Pectinases can include Pectinex® and XPect® products of Novozymes Lipases (e.g, EC 3.1.1.3) may include any available bacterial lipase, a M1 Lipase® and Lipomax® (Gist-Brocades) and Lipolase® and Lipolase Ultra® (Novozymes). Cellulases may include any known cellulases such as those for laundry detergents including the the Celluclast® and Cellic® cellulases of Novozymes. Mannanases may include Mannaway® from Novozymes, Cp-mannanase marketed by PhylloZyme (Philadelphia, Pa.), or others from plant or bacterial sources. DNase can include deoxyribonuclease and related peptides or enzymes. Amylases (a and/or 13) can be included such as Termamyl®, Ban®, Fungamyl® and Duramyl®, from Novo Nordisk.

### Surfactants

A surfactant system can comprise nonionic and/or anionic and/or cationic and/or ampholytic and/or zwitterionic and/or semi-polar nonionic surfactants. They may be present at 0.01% to 25% by weight, such as from 0.1% to 5%, 0.5% to 20%, etc., or otherwise at an effective concentration. Surfactants may be bio-based such as GlucoPure® Sugar Surfactants of Clariant, Spectrapon of Spectrum Chemical (Boca Raton, Fla.), Glucopon alkyl polyglycoside surfactants from BASF (Ludwigshafen, Germany), Sucranov SF from Jarchem (Newark, N.J.), or other systems comprising such components as glycosides of fatty acids and alcohols, polyether glycosidic ionophores and macrocyclic glycosides, carotenoid glycosides and isoprenoid glycolipids, biologically active glycosides of aromatic metabolites, lipopeptides, glycosides, fatty acid amide glycosides, etc.

Polysorbate surfactants may be used. Nonionic, anionic, cationic, ampholytic, zwitterionic and semi-polar nonionic surfactants may be used, as well as alpha olefin sulfonates (AOS), cocamide MEA (CMEA), cocamidopropyl betatine (CAPB), lauryl alcohol ethoxylates, lauryl amine oxide, sodium coco sulfate, sodium lauryl ether sulfate, sodium lauryl sulfate, etc.

### Regimens for Odor Control, Including Washing Machine Cleaners

The treatments and compositions described herein can be used as part of a regimen for odor control that includes not only applying pre- and post-treatments to laundered clothing. Such a regimen can also include periodic sanitizing of a washing machine to reduce the risk of microbes being transferred to clothing. In one embodiment, the laundry treatments are packaged with a washing machine treatment such as a powder, liquid, or tablet that can be placed in a washing machine and run in a washing cycle not to launder clothing but to attack biofilm and/or microbes in the washing machine. Such a washing machine cleaner may comprise from 1% to 80% NAC with suitable excipients (if in solid tablet form), panthenol, detergents, buffering agents, etc., such as a tablet comprising NAC, a binder such as magnesium stearate or a starch compound, sodium carbonate or other salts, and a detergent. In a related aspect, a solid cleaning table comprises 5-50% NAC, optionally 1-10% panthenol, optionally 3-20% boric acid or borax, 1-10% sodium carbonate peroxyhydrate or other peroxides, 1-10% sodium carbonate or other alkaline salts (sodium bicarbonate, potassium carbonate, sodium hydroxide, and so forth), and suitable excipients. An effective concentration of quaternary amines and other antimicrobials can also be employed to attack microbes. Surfactants and other agents may also assist. In another aspect, a composition for the cleaning of biofilm material in washing machines for clothing and/or dish washers or other washers comprises: from 1% to 50% or 3% to 30% NAC and 1% to 25% panthenol; from 1% to 30% of boric acid, a borate salt such as sodium borate, or a combination thereof; from 5% to 20% sodium carbonate; from 2% to 25% sodium carbonate peroxyhydrate; up to 20% of a laundry enzyme or other enzyme described herein such as an enzyme mix in powder form comprising protease, cellulase, mannanase and lipase; and up to 25% of an anionic, cationic, or nonionic surfactant. In one embodiment, all the ingredients are provided in a single integral product that may comprise solid and liquid portions embedded in a water soluble polymeric film similar to that used in TIDE® pods (Procter & Gamble) or CASCADE® dishwasher pods, with the liquid portion comprising an enzyme solution, for example. A two-step process may also be employed comprising first spraying the interior of a washing machine with an enzymatic composition comprising enzymes and surfactants, and optionally biofilm attack agents or antimicrobials, and after allowing the mixture to reside for a predetermined time such as 1, 2, 4, or 6 hours, a wash cycle is then started which uses the solid ingredients that may be in the form of a solid tablet, capsule, or powder that is added to the interior, or which may be in liquid form or both.

### Segregated Materials

In treating surfaces including textiles, segregated materials may be provided. For example, one material may be in the form of a powder or tablet in a first container such as a plastic pouch, blister pack with a foil seal, a foil sealed packet, plastic or glass bottle or tube, a shaker similar to a salt shaker for shaking powder onto a surface, and so forth. A tablet may be an effervescent table that can be added to a quantity of water or other liquid to rapidly dissolve to form a solution. Sealed packets or pouches may be opened by tearing, popping a blister, peeling a peelable layer, and so forth. Packets. pouches, or pods may also be made with a water soluble film such as the films used in detergent “pods” such as TIDE® Pods or other films such as polyvinyl alcohol films, films made from starch, cellulose, or derivatives thereof, etc.. Thus, a pouch or pod containing NAC and/or other biofilm attack agents and a segregated portion comprising enzymes and surfactants could be dropped into a container of water such as a spray bottle or other applicator, and upon dissolving, could be applied to a target region of a textile item with both NAC and enzymes.

One material may be in liquid form such as a concentrate in a bottle or pouch or flexible container to be mixed with water. The concentrate may be provided in a container large enough to accommodate the requisite amount of added water to turn the concentrate into a normal strength solution, or the concentrate may be poured or squeezed from a small container such as a tearable pouch or small rigid container into a larger container that can hold the additional water needed for dilution, which may be added before or after the concentrate is placed inside the larger container. The larger container may be a spray bottle or other liquid applicator for spraying, daubing, pouring, dipping, wiping, brushing, or otherwise applying the liquid to an item of clothing, a textile product, or other surface to be treated. In one embodiment, a powder is provided that can be mixed with water in a dispensing container such as a spray battle, sponge applicator, roll-on, a foam applicator, etc. Separation of two or more components of the treatment may be designed to overcome problems were the components mixed at the time of manufacture. In some aspects, a first component is at a relatively lower pH while a second components is at a higher pH. Each of these components may be applied to the target substrate in separate steps or together. For example, a first component may comprise a formulation that is most effective or most stable at low pH, such as a mixture comprising NAC and/or a and/or a fruit pectinase or other enzyme having best efficacy at a pH below 7. The pH of the first composition may be from 1.5 to 7, from 1.9 to 6.9, from 2 to 6.5, from 2 to 5, and so forth. A second composition may have a higher pH such as from 7 to 12, from 7.2 to 11, from 8 to 11, etc. The difference in pH between the first and second compositions may be at least 0.3, at least 0.5, at least 1.0, or at least 1.5, such as from 0.3 to 5, or from 0.7 to 3.5.

The first or second composition may be applied first, followed by application of the second application, or vice versa. They may be applied simultaneously (e.g., via dissolution of the water soluble film of a pod having two or more isolated chambers within), or the user may be directed to wait a period of time between application, such as from as at least 1, 3, 5, 10, 20, 30 or 60 minutes, etc. An intermediate action may be recommended between the two applications, such as rinsing the area being treated following the first treatment, changing the pH of the treated region by applying a powder or spray of an agent such as a base or acid such as sodium bicarbonate, vinegar, etc.

For removing biofilm in washing machines, biofilm attack agents such as solid NAC with other solid ingredients and a solution comprising enzymes and detergents may be combined in a unit-dose pouch or “pod” typically held in a water-soluble film. A pod with biofilm attack agents may used in a washing machine cycle.

### DETAILED DESCRIPTION OF THE DRAWINGS

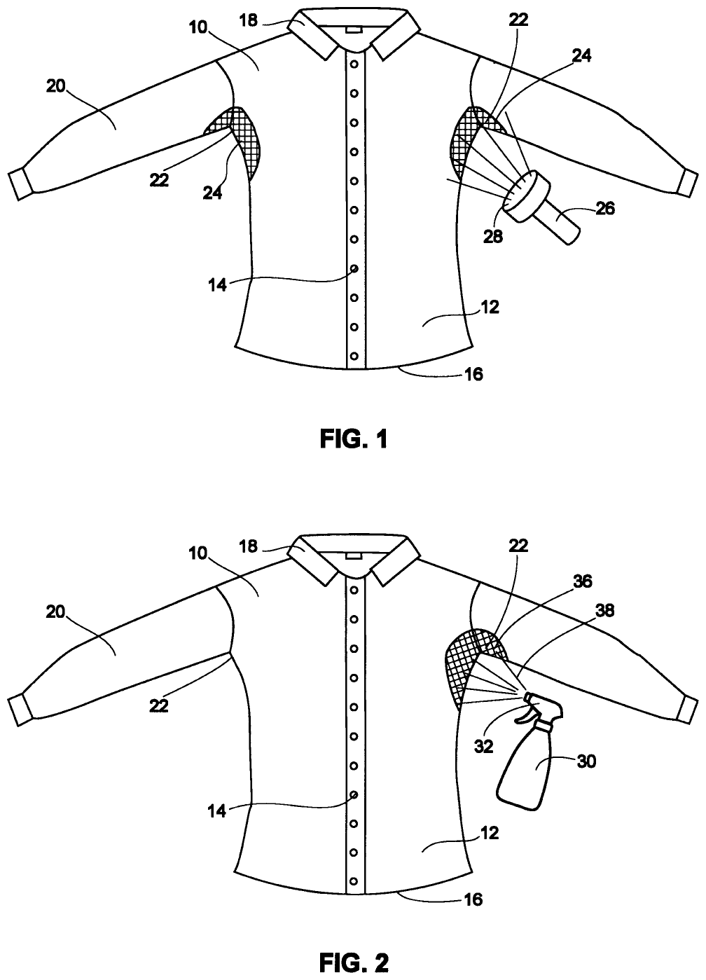

FIG. 1 depicts a shirt 10 having a main body 12, sleeves 20, a collar 18, a lower hem 16, buttons 14 for fastening, etc., with underarm regions 22. Depicted generally in the underarms region 22 is a malodorous biofilm region 24, present in both underarm regions 22. A handheld UV lamp 22 with multiple LED UV lights forming the illuminating face 28 of the lamp 26 is shown shining UV light toward an underarm region 22 to assist in visualizing the biofilm region 24. If the shirt has been repeatedly washed in a detergent comprising optical brighteners or has had an optical brightener solution applied to it followed by rinsing, the preferential absorption of the optical brightener(s) onto the biofilm may cause the biofilm region 24 to fluoresce (not shown), even under normal lighting conditions but most clearly visible in dim light or darkness as the UV light is applied. When repeated treatments of compositions described herein are needed, periodically inspecting fluorescence can assist in gauging progress as biofilm size and fluorescence intensity is gradually reduced. In some cases, a single treatment may show dramatic change.

FIG. 2 shows the shirt 10 of FIG. 1 but instead of biofilm regions (24 of FIG. 1), a wetted region 36 in an underarm region 22 indicates where the liquid in a spray bottle 30 is being applied as a spray 38 using a trigger spray mechanism 32. The liquid may comprise the enzymatic mix of detergents, enzymes, and optional bacteria or bacterial spores described herein, with or without additional biofilm attack agents such as NAC, panthenol, catechins, and/or biofilm modification agents. After spraying, the user may be instructed to wait about 15 or 30 minutes before washing.

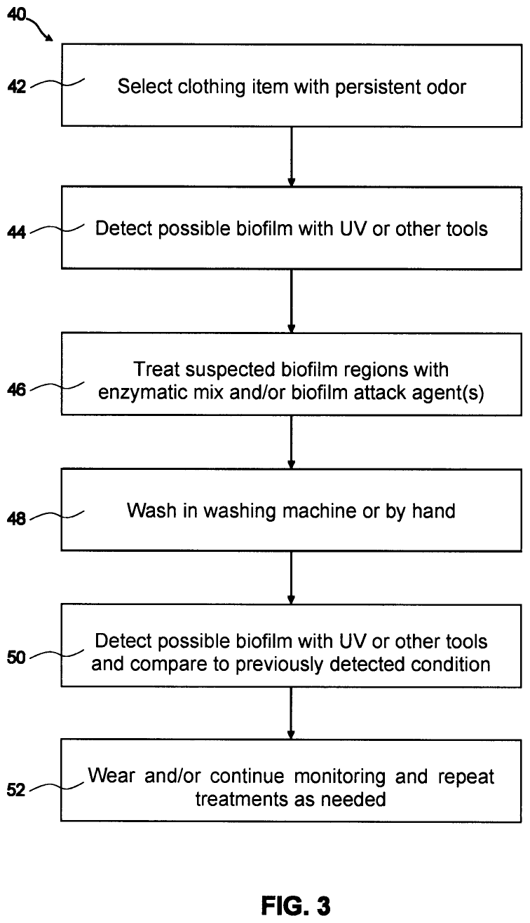

FIG. 3 is a flowchart 40 for one treatment method. In Step 42, a user selects a clothing item suspected of having persistent odor and/or a biofilm. In Step 44, the user may detect evidence of a biofilm using UV visualization or other tools (these may include confocal microscopy, fluorescence microscopy, dye staining with Crustal Violet, Congo Red, or other suitable dyes, inoculation of a sample from the item of clothing, etc.) to guide Step 46, the application of an enzymatic mix and/or biofilm attack agents to the locations likely to have biofilm. Then in Step 48, the item of clothing is washed and afterwards in Step 50, UV or other tools are applied to examine the remaining regions having apparent biofilm for comparison to the previous findings from Step 44, followed by Step 52, wearing or continuing monitoring and treating the item of clothing in additional cycles as needed. The result of the treatments should be not only reduced biofilm presence, but reduced malodor.

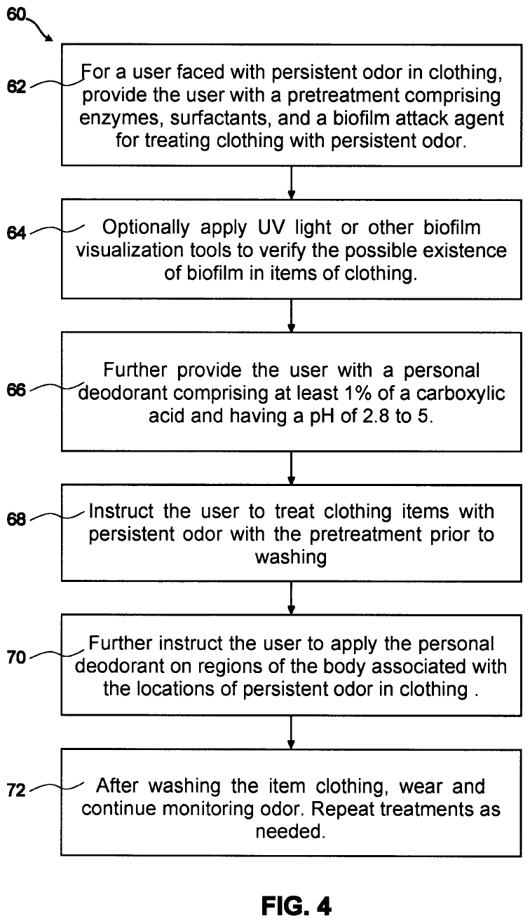

FIG. 4 depicts another flowchart 60 beginning with Step 62, wherein a user faced with persistent odor in clothing is provided with a pretreatment product comprising in one or more parts comprising enzymes, surfactants, and a biofilm attack agent for treating clothing with persistent odor. In Step 64, the user may apply UV light or other biofilm visualization tools to verify the possible existence and location of biofilm in items of clothing. In Step 66, the user may also be further with a personal deodorant comprising at least 1% of a carboxylic acid such as an alpha hydroxy carboxylic acid such as mandelic acid and/or lactic acid, having a pH of 2.8 to 5.5 or from 2.8 to 5. The user in Step 68 us instructed to treat clothing items with persistent odor with the pretreatment product prior to washing, and is further instructed in Step 70 to apply the personal deodorant on regions of the body associated with the locations of persistent odor in clothing. In Step 72, after it is washed, the item of clothing may be worn and further monitored for odor or signs of biofilm, repeating any or all of Steps 62 through 70 as needed.

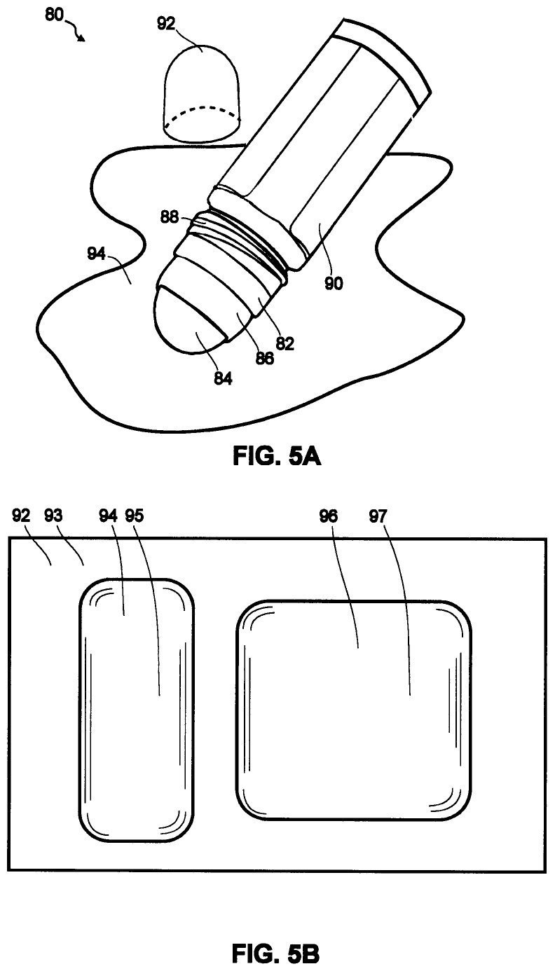

FIG. 5A depicts a roll-on dispenser 80 comprising a cap 92 and a dispenser body 90 containing either (1) the enzymatic mix described herein, (2) the enzymatic mix coupled with a biofilm attack agent such as at least one of NAC, a flavanol solution, and a lysozyme inside (not shown), (3) a biofilm attack agent without laundering enzymes in a suitable carrier such as a base of water and a glycol, diol, or suitable solvent and surfactants or other agents, or (4) a freshener comprising at leat one of an odor neutralizer such as cyclodextrin or cucurbituril compounds, a soya-based quat, an antibacterial agent, optionally with suitable fragrances, or a combination of any of the above, that can be dispensed using a roll-on ball 84, held in place with a roller body 86 which fits into the upper end of the dispenser body 82. The cap 92 attaches to the dispenser body 90 by engaging threads 88 thereon when it is twisted in the proper direction. The roll-on dispenser 80 can be used to apply a solution to clothing prior to laundering or directly onto clothing after laundering or between washes as a freshener. In some cases, it may be applied to clothing as the clothing is being worn. The contents may be refilled by opening a bottom cap (not shown) or unscrewing the roller body 86 or other portion of the dispenser 80.

FIG. 5B depicts a unit-dose pouch or “pod” 92 comprising a water soluble film 93 which contains first and second segregated portions, 94 and 96, each of which contain segregated materials, 95 and 97, respectively. First material 95 may be a solid such as a powder or solid capsule comprising NAC and optionally other biofilm attack agents, antimicrobials, buffering agents, cleaning agents such as borax, boric acid, borax, sodium carbonate peroxyhydrate, etc., and second material 97 may comprise enzymes, surfactants, bacterial spores, with suitable chelants, solvents, rheology modifiers, builders, and the like. The mass of each segregated material may range from 3 g to 200 g or greater, as needed. One or more pods may be placed in a washing machine such as a clothes washer, dish washer, or other device and run with or without the normal contents to help reduce sources of biofilm.

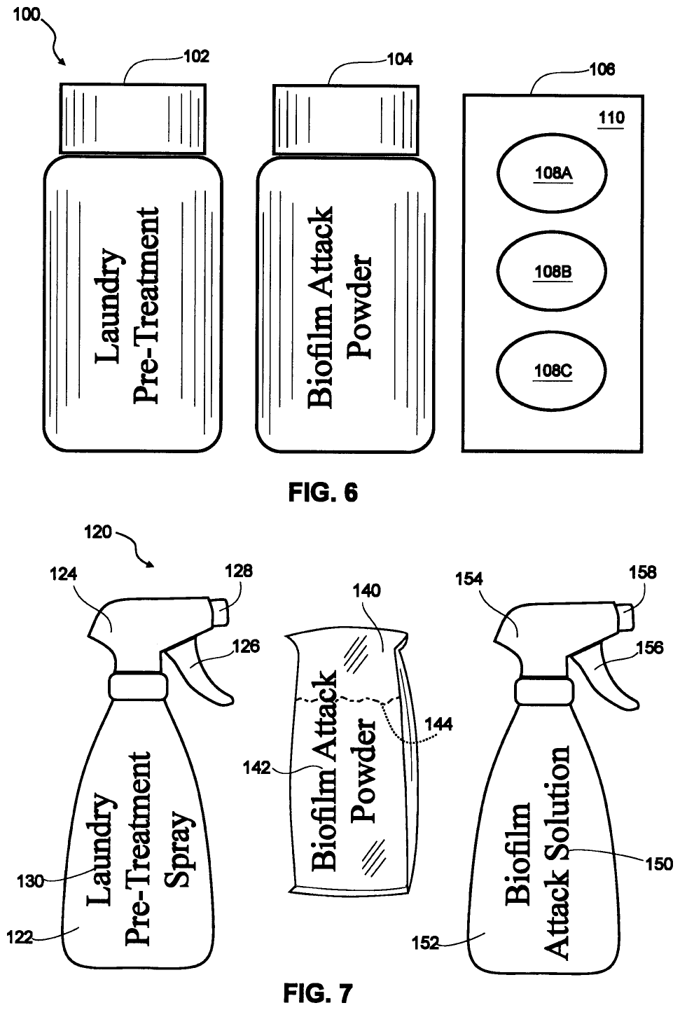

FIG. 6 depicts a combined assembly 100 for combination in a single package (not shown) of a first container 102 containing a cleaner composition labeled as a “laundry pretreatment” comprising at least one of NAC, a suspension of bacteria or bacterial spores such as Bacillus subtiliis spores, two or more laundering enzymes, panthenol, at least 5% surfactant such as from 10% to 70% surfactant, and a second container 104 comprising a biofilm attack agent and/or a biofilm modification agent. The contents of the second container 104 are labeled as a “biofilm attack powder,” but in related embodiments may be a liquid, a slurry, a paste, a powder, individual powder capsules, and the like, and may further comprise a desiccant. The assembly 100 also comprises a blister pack 106 or other packaging system (film or paper packets, pouches, or sachets, sprinkle capsules, ordinary capsules, tablets such as effervescent tablets in a tube or foil pack, etc.) for providing solid material such as tablets or units of powder. Three tablets are shown here as 108A, 108B, and 108C with a blister pack backing 110 holding them together. The tablets or units 108A, 108B, 108C can be detached from the blister pack 106 and placed in or emptied into a washing machine to run a sanitizing cycle, in which the antimicrobial ingredients of the tablets 108A, 108B, 108C can be effective in reducing microbes dwelling in the washing machine (not shown). Alternatively, the tablets may be added to a liquid or other mixture such as a spray made from the cleaner composition of the first container 102 or a biofilm attack preparation made from the biofilm attack powder of the second container 104 to enhance their function, or may be added to a washing machine (not shown) for use in a wash cycle in which one or more articles of clothing therein have been pre-treated with the cleaner composition of the first container 102 or the biofilm attack agent of the second container 104.

The assembly 100 may also include a deodorant or antiperspirant product (not shown) designed to enhance the skin microbiome to reduce body odor, particularly one with synergistic benefits with the other components, such as one comprising a mandelic acid composition having at least 0.5% mandelic acid in a cream, stick, roll-on, wipe, spray, or other format, such as LUME® Deodorant.

FIG. 7 depicts an assembly 120 for a two-part system. A first container 122 labeled as a “laundry pre-treatment spray” holds an enzymatic mix comprising one or more surfactants, optional bacteria or bacterial spores such as Bacillus subtilis, and a mixture of three or more classes of enzymes comprising protease and at least two of lipase, amylase, cellulase, mannanase, and pectinase having a total protein content of at least 1% such as from 1% to 15% or from 2% to 10% or from 1% to 8%. The first container 122 is in the form of a trigger spray bottle having a trigger spray mechanism 124 with a trigger 126 operable by one or more fingers and a spray nozzle 128 such as an adjustable nozzle with multiple settings (e.g., jet, spray, on, off) which may have a foaming screen over the nozzle to promote foam formation which in some cases may help reduce the risk of creating minute aerosol droplets of enzymes that might be inhaled. Also shown is a packet 140 labeled “biofilm attack powder” 142 containing a powder 144 that may comprise NAC and/or other biofilm attack agents. The packet 140 may be torn open and emptied into a second container 152 or, when made from a water soluble film or the like, may simply be placed in the second container 152 coupled with water, where it will dissolve and allow the biofilm attack powder to become dissolved and able to be applied via the trigger spray mechanism 154 with its trigger 156 and nozzle 158 in liquid communication with the contents of the second container 152. The biofilm attack powder on a dry basis may comprise at least 10% NAC such as from 10% to 80% NAC or substantially pure NAC only. It may further comprise from 0.1% to 50% panthenol such as from 1% to 35%, 1% to 25%, 1% to 10% or 1% to 5% panthenol or derivatives thereof. It may further comprise agents to adjust pH, ionic strength, viscosity, wetting angle, rheology, aroma, etc., such as metal salts including magnesium hydroxide, magnesium oxide, magnesium sulfate, magnesium citrate, magnesium acetate, magnesium chloride, and the like, sodium chloride, sodium citrate, sodium bicarbonate, sodium carbonate, etc., potassium chloride, potassium hydroxide, wherein the metal salts may comprise from 0.05% to 20% of the biofilm attack composition. In one embodiment, for example, the composition may comprise from 0.05 to 15% each or from 0.1% to 10% each or from 0.3% to 6% each of one or more magnesium salts and one or more sodium salts. The pH of the biofilm attack solution when diluted according to instructions may be from 2 to 10, such as an acidic formulation with a pH range of from 2.5 to 6.5, from 3 to 5.5, or from 3 to 4.8, or less than 4.5. Other pH ranges contemplated include from 3 to 9, 4 to 9, 5 to 9, 6 to 9 and 7 to 9, or from 3.5 to 8.5 or 4 to 9.

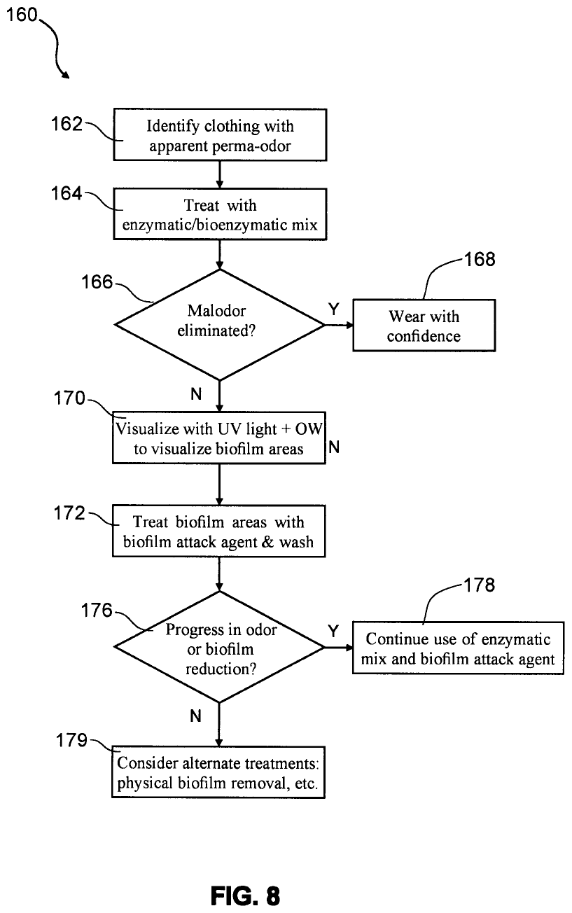

FIG. 8 depicts a flowchart 160 showing steps in a process for treating clothing with persistent odor. In Step 162, a user identifies clothing with apparent perma-odor and then in Step 164, treats the item of clothing with an enzymatic or bioenzymatic cleaning composition. If malodor is eliminated 166, the article can be worn with confidence 168, but if problems remain, in Step 170 the user may visualize potential biofilm areas using UV light or other tools to view fluorescence from absorbed optical whiteners/brighteners (“OW”), and then in Step 172 treat the biofilm candidate areas with a biofilm attack agent and optionally also with an enzymatic cleaning composition. If there is progress in odor or biofilm reduction 176 (biofilm reduction being known by again visualizing the biofilm area, not shown, for comparison to the previous visualization), then the use of the enzymatic cleaning composition and biofilm attack agent may be continued as needed 178, but if progress is lacking, there may be a need to consider alternate treatments 179 such as physical biofilm removal using a scrub brush, tooth brush, or other form of friction, or a water jet, ultrasonic cleaner, very low of high pH treatments, more intense chemical agents such as antimicrobial agents, high temperature, etc.

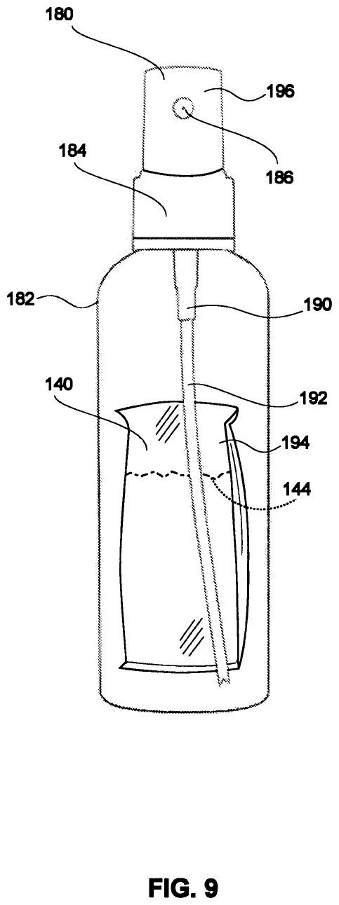

FIG. 9 depicts a spray bottle 180 containing a biofilm attack agent shown as a powder 144 inside a packet 140. The packet 140 is made from a water soluble film 194 such that when water is added to the spray bottle 180, the film 194 dissolves allowing the internal powder 144 to also dissolve and turn the water into a biofilm attack solution (not shown). The bottle 180 comprises a spray bottle body 182, a cap 184 having a nozzle 186 and a spray button 196, from which descends a dip tube connector 190 joined to a dip tube 192 descending into the interior of the spray bottle body 182, providing fluid communication between any fluid (not shown) inside the spray bottle body 182 with the spray nozzle 186, wherein depressing the spray button 196 causes pumping of the liquid through the dip tube 192 to the nozzle 186.

The remaining figures are described below in the Examples section.

### Odor and Biofilm Control Details and Examples Enzymatic Sprays

Several enzymatic solutions were made: First was an enzymatic blend labeled E1, comprised a buffered solution of Novozymes enzymes for laundry detergent in a buffered solution with surfactants and bacterial spores from J-Zyme™ AB-20X NFC distributed by J Tech Sales (Boca Raton, Fla.), said to employ spores from Nozozymes. The solution comprised about 20% J-Zyme which is said to have about 1.1×10⁹ CFU/ml of bacterial spores. This consisted substantially of water, a probiotic bacteria blend believed to comprise Bacillus subtilis spores; enzymes from Novozymes including protease, amylase, pectate lyase, mannanase, 2 types of cellulase, and lipase; alkypolyglucoside from sugar feedstock, sodium citrate, sodium bicarbonate, 1,3 propanediol from natural feedstock, probiotic bacteria blend, and preservative (0.1% of a blend of methylchloroisothiazolinone and methylisothiazolinone). Total enzyme concentration was about 2% by weight. The enzymes here were selected to have optimum activity at a pH of about 7-8.

E2: A blend similar to E2 but without lipase and with the addition of a gentle quat, soyaethyl morpholinium ethosulfate. Ingredients included naturally derived surfactants (from sugar), probiotic bacteria, an enzyme blend containing protease, amylase, pectate lyase, mannanase and cellulases (no lipase); a solvent system made from naturally derived glycerin that also served as an odor control agent, and naturally derived soyethyl morpholinium ethosulfate. The concentration of the quat was about 0.5% and the enzyme concentration was about 2%.

E3: a blend made from a mix of enzymes, with a total of 5% enzymes comprising pectinase, amylase, mannanase, protease, lipase and cellulase. The solution comprised 20% glucopon-like surfactant from 100% biobased alkyl polyglycosides, sodium citrate and sodium bicarbonate for buffering to a pH in the 7-8 range, propanediol, a mix of bacterial spores approved for bio-enzymatic cleaning from a 10× concentrate comprising Bacillus subtilis spores, a solvent system derived from naturally derived glycerin and as an odor control agent, and a suitable preservative known to be compatible with the bacterial spore mix.

E4C: This blend is a 4:1 concentrate intended upon dilution to give a solution similar to E3, but with slightly reduced surfactant levels. Upon 4:1 dilution, the concentrated E4C solution was diluted to normal strength and dubbed E4D.

E6C is another 4:1 concentrate intended upon dilution to give a solution similar to E3, but with slightly reduced surfactant levels to facilitate the concentrate form and less lipase. This concentrated enzyme blend has about 15% liquid enzyme mixtures comprising pectinase, amylase, mannanase, protease, lipase and cellulase (the liquid enzyme mixtures themselves are estimated to have roughly 40 to 60% protein), about 30% surfactants comprising biobased alkyl polyglycosides, salts such as sodium citrate and sodium bicarbonate, propanediol, a mix of bacterial spores approved for bio-enzymatic cleaning from a 10× concentrate, a solvent system derived from naturally derived glycerin, and a suitable preservative known to be compatible with the bacterial spore mix. Upon dilution (3 parts water to 1 part E6C) the result is E6D (the “D” indicates dilution has occurred).

EN2: 11.1 ml of KOH 0.1M solution was combined with 11.8 g of 1.8% NAC solution at pH 3.0, giving a pH of 4.85. Then 20.4 g of this solution was combined with 39 g of NIC solution, giving a pH of 7.00

Other enzymes used included: Pectinase from Phygene Biotechnology Co (Fuzhou,Chna), product PH1561, CAS 9032-7501; pectinase in Kitchen Alchemy Pectinex® Ultra SP-L solution from Modernist Pantry, LLC (Eliot, Maine); pectinase powder (“pectic enzyme”), L.D. Carlson Co. (Kent, Ohio); alpha-amylase powder from BOSF (1,4-alpha-D-glucan glucanohydrolase), 10 kU/g, CAS 9000-90-2, EC 232 6; amylase powder, BSG (Shakopee, Minnesota), product 10019; papain, Phygene Biotechnology Co (Fuzhou,Chna), product PH9028, CAS 9001-73-4; papain tablets, Beazyme brand, MCM (Malaysia Chemical Company, Kuala Lumpur), 150,000 USP, purchased in Kuala Lumpur, Malaysia; lipase (triacylglycerol acylhydrolase) from Candida rugosa, Ekear Co. (Shanghai, China), product P0114, CAS 9001-62-1; cellulase, Phygene Biotechnology Co (Fuzhou,Chna), product PH9018, CAS 9012-54-8; cellulase powder from Heshibi Biotech, China; cellulase powder, Henan Wan Bang Industrial Co. (Henan Province, China); cellulase powder, Zhejiang Yiruo Biotech (Zhejiang Province, China); cellulase powder, Shandong Longda Biotech (Shandon Province, China); cellulase powder, Yin brand (China); lysozyme from egg whites, Bomei Biotech, CAS 12650-88-3; lysozyme chloride, Homecare Noflux® brand, 90 mg per tablet, purchased in Kuala Lumpur, Malaysia; E-Zyme® Troche lysozyme chloride tablets, 200 mg each, from AV Manufacturing S/B (Malaysia) purchased in Kota Kinabalu, Malaysia; NattoEnzym nattokinase powder purchased in Hanoi, Vietnam marketed by DHG Pharam (Can Tho City, Vietnam), made from nattokinase from the Japanese Nattokinase Association (Osaka, Japan);

Enzyme Solutions Made, Listed with Assigned Names:

AmylaseA: BSG amylase, 1.137 g and BOST amylase, 0.717 g, were stirred unto 28.0 ml of water.

CellulaseA: 1.1 g of Shandong Longda cellulase powder and 0.45 g of Phygene cellulase powder were mixed into 22 ml of water.

CellulaseB: 1.3 g of Heshibi cellulase powder was mixed into 29 ml water.

CellulaseC: 1.8 g of Wanbang cellulase, 0.38 g of Phygene cellulase, 1.10 g of Yin cellulase, and 1 g of Heshibi cellulase were was mixed into 53.5 ml of water.

CellAmylA: 12.19 g of 2% NAC at pH 6.14 was combined with 5.2 g of 2% NAC at pH 9.17, 17.69 g of CellulaseC, 4 g of 2% NAC at pH 6.4, a few grains of citric acid to bring the pH from 9.5 to 8.82, and then 0.55 g of BOSF amylase powder.

LysoA: 1 tablet of E-Zyme® lysozyme chloride (200 mg) was dissolved into 8.5 ml of water.

LysoPap: Grind one table of Homecare Noflux® lysozyme chloride (90 mg of lysozyme) with one tablet of MCM Beazyme papain dissolved into 12 ml of water.

LysoB: Pulverize 2 tablets of E-zyme Troche lysozyme chloride (200 mg each) and dissolve in 30 ml water.

PAPA: 1.05 g of Phygene papain was combined with 21.7 ml of water.

PAPB: 1.3 tablets of MCM papain were ground and dissolved into 15 ml of water. Some residual solids remained even after heating. The slurry was then passed through a fine cloth to filter out some solids. 13 g of solution were obtained.

PAPC: 5.65 g of papain from Pangbo Enzymes (Nanning Pangbo Biol. Eng. Co.), 10,000 U/g, was combined with 53 ml of water.

PANNAC: 33 ml of 3.6% NAC, pH 4.9, combined with 0.643 g panthenol.

PANNAC2: 3.6 g of NAC and 1.65 g of panthenol powder were combined in 108 ml of water, with 2.1 g of NaHCO3 added to reach a pH of 4.7.

NattoNAC: 0.6 g of commercial nattokinase powder was purchased in Hanoi, Vietnam under the brand name of NattoEnzym marketed by DHG Pharam (Can Tho City, Vietnam), made from nattokinase from the Japanese Nattokinase Association made by Japan Bio Science Laboratory (Osaka, Japan). Capsules with 0.6 g of powder, said to have 670 FU (fibrin units, a measure of activity based on fibrinolytic activity) per capsule, were used.

### Biofilm Attack (BA) Agents

Pretreatments to attack biofilm were made as follows:

NAC-AL: To test the interaction of allantoin with NAC, 0.75 g of NAC were combined with 0.24 g allantoin in 46.5 g hot water. The pH was 3.16. The characteristic sulfur odor of NAC appeared to be absent, suggesting that allantoin may be useful in reducing the odor of NAC solution.

EGCD-1: 1.20 g EGCG powder was combined with 0.80 g ascorbic acid, 0.53 g citric acid, 1.51 g of hydroxypropyl beta-cyclodextrin, in 128 ml of water, heated to about 40° C. and stirred. Similar is EGCD-2: 1.72 g of EGCG powder with 1.03 g of ascorbic acid powder, 0.86 g of citric acid, and 0.70 g of hydroxypropyl beta-cyclodextrin in 118 ml of distilled water.

EGCD-A: 27.8 ml of EGCD-1 solution was mixed with 10 ml 70% ethanol. Similar is EGCD-B: 29 ml of EGCD-2 solution are withdrawn and combined with 10 ml of 70 wt% ethanol and put in a spray bottle to give spray EGCD-B. This solution displayed excellent color stability after multiple weeks at room temperature.

### NAC Solutions:

NAC powder was dissolved distilled water to give a 2.1% strength solution, a 1% solution, and a 20% solution. A NAC solution at 1.4% concentration was adjusted with citric acid and sodium carbonate to achieve a pH of 3.0. A NAC solution at 2% was made by mixing 3.9 g of NAC in 185 ml of water. 1 g of NAC in 50 ml of 0.1M KOH solution was prepared with a pH of 9.17. 1.0 g NAC plus 15 ml of 0.1 M KOH solution was prepared with 35 ml water, with a pH of 3.55. Na2CO3 was then added (0.18 g) to bring the pH to 7.8.

Another 2% NAC solution was prepared with KOH added to give a pH of 8.19 in 51 ml of water, to which another 0.22 g NAC was added to bring the pH down to 4.33. Adding 6 ml of 0.1M KOH solution brought the pH to 6.4.

28.1 ml of NIC (Naturally It's Clean®) enzyme solution was combined with 0.36 g NAC and 0.16 g sodium carbonate to give a pH of 8.37. This was adjusted by adding 0.04 g NAC to give a pH of 8.08. This is labeled 1.4% NAC in NIC.

A 2.1% NAC solution at pH 4.0 was made using 1.51 g of Biotal NAC, 0.648 g NaHCO3, and 71 ml of water.

### Pectinase Solutions

PNAC1: 0.2 g of BOSF pectinase powder (believed to be a fruit pectinase best suited for operation around a pH of 4 to 5, unlike typical laundry detergent pectinases which are engineered for higher pH solutions such as from 7 to 9) having an activity of 10 kU/g was combined with 0.41 g NAC powder and 0.13 g sodium bicarbonate. The powder was prepared and mixed, and placed in dry form into a sealed 100 ml spray bottle. After a period of time, distilled water was added, 57 ml. The mix dissolved rapidly at 22° C. The pH was 6.7. To better optimize performance of the pectinase, 0.21 g of NAC was further added to the solution plus 0.32 g ascorbic acid, bringing the pH to 4.6. This was spray PNAC1.

PNAC2: In 55.7 ml of water, 0.22 g of pectinase powder from BOSF was added with 0.44 g of NAC powder to form a pectinase-NAC solution having a pH of 3.2. Then in 12.65 ml of water, 0.26 g sodium bicarbonate was added. 4.5 ml of this solution was added to the pectinase-NAC solution, bringing the pH to 4.71. This was adjusted by adding 0.06 g NAC, giving a pH of 4.08. This was put into a 100 ml spray bottle and labeled PNAC2.

PNAC3: 0.6 g NAC are combined with 0.5 g BOSF pectinase pwder with 0.13 g sodium bicarbonate and 0.1 g ascorbic acid. The powder mix was then combined with 60 ml of water (references to water are generally to distilled water unless indicated otherwise). The pH was 4.31, believed to be suitable for the fruit pectinase used, but generally too low for typical laundry enzymes.

PNAC4: 1.14 g NAC powder was combined with 0.88 g of pectinase powder (BOSF polygactouronase, product G0200, CAS 9032-75-1, EC 232-885-6, >10 kU/g), 0.08 g citric acid powder, and 0.5 g NaHCO3 in 106 ml of water, resulting in a solution with a pH of 4.38, believed to be suitable for fruit pectinases.

PNACS: Combine 1.256 g NAC with 1.033 BOSF pectinase (polygalacturonase) into 106 ml g water.

PMIX1: 0.174 g of Phygene pectinase, 0.802 g of Pectinex® solution, and 24.5 ml of water were combined to create PMIX1 solution.

Lysozyme Solutions: Three Malaysian E-Zyme® Troche lysozyme chloride tablets, 200 mg each, from AV Mfg. (Malaysia) bought in Kota Kinabalu, Malaysia, were ground and dissolved in 51 ml of water to form 1.2% lysozyme solution, LYS1.

### Steps Toward Perma-Odor

An effort was made to artificially create persistent odor problems in several shirts, including the following shirts purchased at second-hand store in Shanghai:
Shirt RD1: a red 100% polyester sports shirt under the Voit brand
Shirt RW1: a striped shirt made from 75% cotton and 25% polyester.
Shirt Dec1: A 100% polyester men's sports top made by Decathlon of China.
Shirt M1: A maroon shirt with 47.5% Modal, 47.5% cotton, and 5% spandex.
Shirt BS1: a black casual short-sleeved shirt made from 100% polyester (purchased new in Shanghai but worn for four years prior to this work).

Two malodor sprays were created to add malodor and a biological load in an attempt to infect clothing with malodor sources formed from mixtures of odorous French cheeses, meat extracts, soy broth, etc. Several shirts with persistent odor were eventually brewed with such mixtures applied to the shirts for prolonged times. Once persistent odor was detected (odor that remained even after washing with commercial laundry detergents). The primary treatment was application of about 0.5-1.2 g of bacteria-rich Fourme D'Ambert cheese total to the both armpits followed by application of a solution with meat extract, and keeping the moistened shirt in a plastic bag for several hours. After several such treatments, Dec1 developed persistent malodor in both pits after washing. Then the right pit was sprayed with 1.6 g of 1.8% NAC solution (pH about 2) and washed with a standard wash cycle requiring 78 minutes in a Siemens front-loading washer, using Bright Blue Moon liquid laundry detergent, a Chinese enzymatic detergent. Although the detergent had a fragrance, after washing, the left pit appeared to have no malodor nor fragrance, while the right pit manifested fragrance. After air drying, the left pit still had no sign of malodor, while the right pit had some odor. This suggested that NAC can be effective when used in combination with other agents such as enzymes. It is also believed that biofilm material provides a substrate that can more readily retain many fragrances during washing relative to synthetic fibers alone. Thus, a reduction in retained fragrance after washing may be a sign of successful reduction of biofilm matter.

### UK Triathlon Shirt (TR1)

A volunteer triathlon runner from the United Kingdom provided a 100% polyester shirt suffering from persistent odor believed to be a prime example of perma-odor and a possible biofilm infection. The shirt, code named TR1, received in a triathlon event in 2013, had been worn periodically for heavy exercise for six years and was about to be discarded because of strong odor, even after washing, that would become strong after relatively short periods of exercising, unlike new shirts. The shirt was received after exercise, with both pits manifesting odor levels of about 5 on a scale of 0 to 5. The left pit was treated with Naturally It's Clean® (NIC) Laundry Spray by Enzyme Solutions (Garrett, Ind.) alone, with 5.9 g applied. The right pit was treated with a similar amount of blend of NIC with 1% NAC at pH 7.00. After five minutes, the shirt was rinsed in warm water at about 40° C. and then washed in a standard cycle with room-temperature water with Unilever Comfort® brand laundry detergent (Asia).

After drying the washed shirt, the right pit was substantially free of odor and fragrance, while the left pit manifested fragrance, again suggesting that attacking biofilm can reduce fragrance retention clothing made from synthetic fibers. After Applicant exercised vigorously while wearing the shirt, the right pit had very little odor while the left pit had rapidly developed uncharacteristically intense odor. It appeared that the left pit suffered from perma-odor in which odor rapidly develops, while the problem had been mitigated in the right pit with the NAC+ enzyme treatment.

The shirt was washed in a full cycle with Bright Blue Moon detergent. The left pit had slight fragrance while the right pit did not have readily detectable fragrance. After air drying, the left pit fragrance level was at about 1, while the right pit remained at a 0 rating. One tester detected both malodor and fragrance in the left pit, estimating the odor level at about 1. After two more hours, the right pit appeared to have some residual odor while the left pit odor was difficult to detect. After an exercise session, the left pit developed strong odor, a level of about 3, while the right pit had mild odor, about 0.5 or 1 (nearly no odor).

The shirt was again washed with Comfort® brand detergent. Both pits smelled acceptable (essentially no malodor). Then, after another exercise session similar to each of the two previous sessions with this shirt, followed by 1 hour of walking, the left pit had strong malodor as it did previously, at a level of about 3.5 or 4, while the right pit had much less malodor, at a level of about 2.

Now to treat the left pit, which appeared to have a perma-odor problem possibly from a biofilm, a combination of pectinase and NAC was tried. 8 g of PNAC2 spray was applied to the left pit and allowed to sit for 15 minutes at about 22° C. The shirt was then washed with Comfort® detergent in a fast cycle.

After drying, the shirt was worn for exercise similar to previous sessions and the pits were wetted with sweat, as usual. However, this time, there was relatively low odor in both pits. The high odor levels created previously in the left pit prior to treatment with biofilm-attack agents did not occur this time, and the two pits were substantially similar in odor levels (around 1). This suggests that the NAC-pectinase treatment was successful in reducing the source of the perma-odor.

### Neon Orange Champion Shirt

A neon orange sports top for women made under the Champion® brand, code named CH1, a semi-fitted L/G, 100% polyester shirt had been in regular use for exercise for 5 years and had symptoms of perma-odor. Slight odor would still generally be present after washing, would become strong after one exercise session. Treatments with EGCD-1 solution at low pH (added citric and acetic acid) followed by treatment with E2 showed some reduction of odor in the left pit, but odor still returned after exercise. Further trials were conducted in Borneo, Malaysia, after first finding NAC at a pharmacy in Kuala Lumpur and hypothesizing that NAC might assist in removing biofilm in clothing. Nova® brand N-Acetyl cysteine powder in 300 mg capsules (Nova Laboratories, Sepang, Selangor, Malaysia) was purchased from Sunlight Pharmacy in Kota Kinabalu, Malaysia. Each capsule contained 300 mg of acetyl cysteine and 70 mg of other materials, believed to primarily be gelatin. 1.97 g of NAC powder removed from the Nova® brand capsules was stirred into 52 ml of water to form a 3.2% NAC solution, slightly cloudy, which was applied to the right pit area of the neon orange shirt, with 2 g of NAC solution being applied to both the outside and inside surfaces of the right side over a roughly circular area about 12 cm in diameter. After two minutes of dwell time, the right pit was sprayed with NIC (Naturally It's Clean®) enzyme solution, with 2.33 g applied to the exterior surface and 2.5 g applied to the interior surface.

The left pit of the neon orange shirt was treated with NIC solution only, with 3.4 g applied to the outer surface and 4 g applied to the inner surface, for a total of 7.4 g on the pit. After five minutes, the entire shirt was handwashed in warm, soapy water using a clear shampoo provided by a local hotel. After air drying, the right pit, which previously smelled worse than the left, now smelled better than the left. Both smelled better than before washing, but there was residual malodor in the left pit.

A second biofilm-attack treatment was then applied to the right pit. A solution of NAC from an effervescent NAC tablet with 600 mg of NAC, also purchased in a Malaysian pharmacy, was made by dissolving the tablet in 100 ml of water. 8 ml of this solution was then applied to the right pit to substantially saturate it. Then 5.3 ml of solution EGCD-A was applied to the right pit and allowed to sit for 20 minutes before handwashing and air drying.

After an exercise session, it was observed that the right pit continued to smell better than the left pit. The same tendency applied to the shirt after being stored for 48 hours at room temperature, even though the odor intensity had increased over this time period, with the left pit exhibiting an odor intensity of about 4 to 5 (0 to 5 scale), while the right pit was rated at about 2 to 3.

The right pit was then treated again. First the right pit and sleeve were moistened with 21 g of 2% NAC solution made from 100 ml of water and 2 g of NAC powder extracted from Swanson's 600 mg capsules of N-acetyl cysteine (Swanson Health Products, Fargo, N. Dak.) which also contain gelatin (capsule shell) and magnesium stearate. Then 5.94 g of EGCD-A solution was applied to the moistened right pit area. After 10 minutes, the wetted region was sprayed with 7 g of NIC solution and rinsed after about 10 minutes and handwashed with laundry detergent and warm water. After drying, the right pit had no odor, neither malodor nor fragrance from the laundry detergent, while the left pit exhibited both malodor and fragrance.

After further washing and two exercise sessions, the right pit still smelled better than the left, but both have made progress in terms of decreased odor levels previously experienced after one session of exercise. It may be that both the EGCG treatment and the NAC treatment (and possibly the NAC plus EGCG treatment) have helped reduce the impact of a biofilm in this shirt. As odor developed, it was observed that the treatments (NAC+EGCG) appeared to make the shirt display longer lasting odor reduction when treated with a freshener after exercising such as Oderase™ from AqDot (Cambridge, UK). After further exercising and washing, the right pit of the shirt could still develop odor after exercise, but not as intensely as before, while the left pit had strong odor, even after being treated with fresheners comprising cucurbituril and also Febreze Free (Procter & Gamble).

Now the left pit was treated with a biofilm attack protocol. 10 g of a 2% NAC solution was applied to the pit and allowed to sit for 10 minutes, after which 9 g of NIC was sprayed on, sitting for 15 minutes, whereupon the shirt was rinsed by hand and then washed with commercial laundry detergent (Bright Blue Moon).

After further exercise, the right pit was still superior to the left pit (odor rating of about 1 in the right and 2 to 3 in the left). To further treat the left pit, the lysozyme solution LYS1 was applied, with 7.3 g of solution applied over an area of about 10 cm×8 cm around the left pit. This sat for 20 minutes, then 5 g of NIC was applied. After a 5-minute wait, the shirt was placed in a washing machine and washed. Following subsequent exercise, the left pit still had mild odor, though reduced in comparison with previous states while the right pit had very little odor. After several more hours of sitting, the two pits seems roughly equivalent when tested again, both rated at about 2 on a scale of 0 to 5.

The right pit was then treated with 3.11 g of EGCD-B spray, immediately followed by 3.46 g of 1% NAC spray at a PH of 6.4. The left pit was treated with 2% NAC at a pH of 9.17, 3.6 g applied, followed by treatment with 1% NAC at a pH of 7.8, 2.68 g applied. Then NIC was applied to the right pit, 2.0 g, and1.76 g NIC to the left pit. The shirt was hand washed in warm water with laundry soap and air dried. After an exercise session (a jog of 3 to 5 km is typical for the exercise sessions here), the right pit smelled better than the left. Perhaps the elevated pH NAC solutions are less effective than the low pH solutions in opening or attacking the biofilm. The left pit was then treated with EGCD-B spray, about 3 gm. After a 3-hour wait, both the right and left pits were sprayed with 2% NAC solution, 6 g on the left and 7.5 g on the right. After a five minute wait, the shirt was rinsed in warm water and air dried. After two exercise sessions, the pits were at an odor level of about 5. The left pit was treated with NIC, 1.48 g, while the right pit was treated with EN2, 1.44 g, and air dried. The odor in the right pit was estimated at 3 on a scale of 0 to 5, while the left pit had a level of about 3.5. A second evaluator gave scores of about 2 for each pit.

The pH 3.0 NAC solution was then applied to the right pit, 2.4 g, and after 5 minutes, the shirt was washed in a short cycle with Bright Blue Moon brand detergent. After washing, both pits had slight odor, about 0.5 on a scale of 0 to 5. After another exercise session, both pits had an odor level of about 4. The right pit was then treated with PNAC3 comprising pectinase. 7.3 g of PNAC3 was applied to the pit and surrounding region, saturating the pit area. After washing, the shirt was again evaluated following exercise. Both pits had low odor. But where odor existed, it appeared to be correlated with slightly darkened zones in the pits, believed to be staining associated with a prior biofilm where deposits of polysachharides, proteins, and other biofilm matter may have provided a platform for absorption of dyes or dyed particles. The darkened areas remained following the treatments with enzymes that the shirt has received, though the intensity of the darkened regions has declined.

After further exercise, with the odor level at 2 in the left pit and 2.5 in the right, solution 1.57 g of Aq14 freshener was applied to the right. After air drying, about 30 minutes later, the right pit odor level was about 1.

Steps were then taken to reduce the darkened color regions in the pits. The inner right pit was treated with 3.6 g of PNAC4 and allowed to sit for 5 minutes. Then 0.9 g of E2 was applied to that spot. After 2 more minutes, 1.4 g of NIC was applied, and finally 1.4 g of 2.1% NAC was applied. The shirt was then washed with Comfort® detergent (1.5 ounces of detergent used in a full cycle at 40° C. requiring slightly over one hour), and then air dried. After further exercise sessions, the shirt had odor levels of 1-2 in the right pit and 0.2-1 in the left. The left was then treated with 4.65 g of PNAC4, seeking to further eliminate the residual staining in the pit. The shirt was then washed using Comfort® brand detergent. After further exercise, the dark stain region on the inner right put was treated with PNAC4, saturating with 3.6 g of spray. After 5 minutes, 0.9 g of spray E2 was applied. After two more minutes, 1.4 g of NIC spray was applied to the pit and finally 1.4g of 2.1% NAC were applied. The shirt was then washed with 1.5 oz of Comfort® detergent in a full cycle at 40° C. After 5 more exercise sessions without washing, the pits now had strong malodor with an odor level of about 5. The right pit was treated with 2% NAC solution and washed. After exercise, the odor in the right pit was significantly reduced relative to the left pit.

### Additional Shirts: Series K

A blue Decathlon sports top, KB1, 100% polyester and essentially the same as the neon orange shirt above except for color, had also developed strong odor through repeated exercise and was a possible perma-odor candidate which still had malodor after washing. The left pit was treated with EGCD-1, with 6.3 g applied. It sat for 10 minutes, then the shirt was rinsed and washed. After air drying, the treated pit smelled much better.

### Additional Shirts, Series AA-AC

Several shirts from an athletic female volunteer were obtained, including:

Shirt AA, a pink Forever 21 shirt believed to be made from cotton and polyester with relatively stronger odor in the right pit after prior washing.

Shirt AB, a Downeast Basics “Wonder Tee” made from 95% cotton and 5% spandex, a brand said by some customers to have pronounced odor issues, perhaps due to surface sizing chemistry. After washing, both the right and left pits had malodor.

Treatments of 2.1% NAC solution were applied. For shirt AA, 12.7 g total was applied across both pits and adjoining shoulder area. For shirt AB, 8.2 g was applied to the right pit and shoulder area, leaving the left pit untreated. For shirt AC, 8.5 g was applied to the right pit. After about 10 minutes, each shirt was then treated with Naturally It's Clean (NIC) enzyme spray for laundry. For shirt AA, a total of 11 g of spray was applied to the previously wetted areas. Further, for the right pit only, 2 g of E2 bio-enzymatic spray was applied. For shirt AB, 3.3. g of NIC was applied to the right pit followed by 5.4 g of LPS1 also to the right pit. After about 15 minutes of dwell time, the shirts were washed with a standard cycle using Bright Blue Moon laundry detergent. In each case, treated pits smelled better than before and smelled better than the untreated pits or the pits treated without NAC. Following exercise, the results were mixed. Shirt AB was reported to smell better in general. Perhaps the enzymes in the detergent and the added enzymes and NAC present in the wash from the 3 treated shirts being washed contributed to effective odor reduction for both pits on shirt AB. But for shirt AA, after one work day the right pit was reported to smell again, while the left pit remained smelling fresh. For this shirt, additional treatment with NAC may be needed to achieve more complete odor reduction in the right pit.

### Perma-Odor Candidates: Series L

Exercise clothes from a heavy exerciser (male) were provided for further testing. Several items of clothing appeared to have perma-odor, for even after washing some residual odor remained, and the user had noted that malodor returns swiftly during or after exercise unlike the way the clothing behaved when it was relatively new. The clothing appeared to be suitable candidates for a perma-odor problems that may be due to a biofilm. Several approaches were tried.

Three items were involved: a red polyester shirt (shirt RL), a white polyester Lintrel shirt (shirt WL), and a blue polyester sports shirt (shirt BL). There were also three pairs of washable children's shoes that had serious odor issues that had not been removed with previous washing, including soaking in a solution made from Oxi-Clean® detergent with bleaching agents.

Initial treatments includes the use of E2 spray (about 3 g) on the right pit of RL, and a similar amount of E2 spray on the right pit of the white shirt WL. After sitting overnight to allow bacterial spores to activate and then being laundered with a washing machine and laundry detergent, the treated pit of the white shirt smelled significantly better than the other pit, while the pits on shirt RL both smelled about the same with some persistent odor still present. The blue shirt, BL, had both pits smelling acceptable after the treatment and wash.

An antimicrobial agent, PureShield® wound care spray, was applied to each of the right shoes among two of the pairs, followed later by washing. After drying, it was observed that this treatment by itself did not appear to have any effect.

Treatments with EGCG and NAC

Recognizing that biofilm may be present in some of the shirts, a new round was conducted aimed at reducing the impact of potential biofilm. A three-step program was implemented in some cases involving treatment with NAC, then acidic EGCG solution, followed by treatment with enzymes. The hypothesis was that the biofilm might be weakened or opened by the NAC and EGCG, allowing the enzyme solution to more effectively remove materials that may have been previously deposited or protected by the biofilm and perhaps help reduce the foothold of bacteria in the clothing. Testing showed reduction in odor after washing and reduced odor once the washed shirt was exposed to further sweating during exercise.

In the first trial following the initial treatments described above, 2.1% NAC solution was applied to the right pit of each of the shirts RL, BL, and WL, bringing the pits to saturation. 12 g were applied to RL, 12 g to WL, and 13.5 g to BL. Then RL was further treated with 5.5 g of EGCD-B solution on the right pit. BL was treated with 6.6 g of EGCD-2 solution on the right pit, and WL was treated with 8.7 g of EGCD-B on the right pit. After about 5 more minutes, shirt RL had 5.0 g of NIC applied to the right pit. Shirt WL received 6.3 g of NIC applied to the right pit. Shirt RL was then washed in a regular wash cycle, while shirts WL and BL were hand rinsed in warm water. The shirts were then air dried and later worn. When the owner later reported the results, it was determined that shirts treated with NAC solution had significantly reduced odor after washing, and after exercise, the odor in the treated pit would generally be less than in the untreated pit.

In a subsequent trial, after washing and exercise, shirt RL was reported to have an odor level of about 2 (scale of 0 to 5) in both pits, while shirt BL had an odor level of about 2 in the left and 1 in the right pit. Shirt WL had very little odor and was reported as being significantly better than it was prior to treatment. Shirt RL was treated in the right pit with 9.1 g of 2% NAC at a pH of 7.8. (Prior to treatment, odor level was estimated to be about 0.5 in the right pit and 1 in the left.) After about 11 minutes, NIC enzyme spray was applied with 5.8 g on the right pit and 10 g on the left and the shirt was washed. While the residual odor in the shirt appeared to have been eliminated, after heavy exercise, shirt RD was reported to have developed strong odor on both sides. It was speculated that a different enzyme treatment might be helpful. Thus, the right pit and surrounding area was treated with 15 g of PNAC3 and after about one hour was washed using liquid Tide® detergent. The owner reported substantial improvement in the shirt.

Shirt WL, manifesting odor levels of about 2 in the left pit and 0 in the right (following exercise) before treatment was treated with 4.8 g of 2% NAC (pH 7.8) in the left pit, then after 2 minutes, 6.5 g of NIC enzyme spray was applied. After 10 minutes, another 5 g of NIC spray was applied. After washing as usual with liquid Tide® detergent and exercising with the shirt, the owner reported substantial improvement in both pits. After exercising, however, the right pit had slightly more odor than the left, so an additional treatment was conducted aimed at the right pit, which was treated with PNAC3 (2.2 g) applied to the center of the pit, and then PNAC1 (7g) applied more broadly to the pit and sleeve. The left pit was treated with NIC only, 4 g. The shirt was then washed. The owner noted that the odor problems of the past had been essentially overcome, and the shirt could now be used for exercise without the residual odor that had previously been present after washing.

For shirt BL, the left pit was treated with 1.4% NAC in NIC solution, with 9.67 g applied, and after about 30 minutes the shirt was washed using liquid Tide® laundry detergent. Following further use during exercise, the owner reported substantial improvement. However, the left pit had slightly stronger malodor. The left pit was then treated with PNAC1, with 11 g applied to a broad area around the pit followed by 1.9 g of PNAC3 in the pit area itself. The shirt was them washed after about an hour. After exercise, the owner reported significant improvement with no residual odor. Odor no longer rapidly returned during exercise, more like a new shirt.

### Other Shirts: Series XH

A 100% cotton blue “Superman” T-shirt, codenamed NS, was reported to have perma-odor by an athletic adult male. The shirt was treated in the left pit only with 5.6 g of PNAC4 sprayed onto the pit area, followed by washing with Purex Free® detergent in a fast wash cycle. The owner, not knowing that only the left pit had been treated, later reported that there was substantial improvement in the left pit.

### Fluorescence and Dye Testing:

In the photographs discussed in this section, the following numbering system is used: 200 represents an item of clothing, 202 represents a stain or darkened spot on a fabric or other visible biofilm candidate, 204 represents a fluorescing region, 206 represents a region having diminished fluorescence following a treatment, 208 denotes a boundary marker for the a treatment zone (e.g., a rubber band or other object denoting the area to be treated or a circle drawn on the figure), and 210 denotes a treatment zone where particular compounds will be applied to reduce a biofilm or for other objectives. Initial tests with dyes explored the use of crystal violet to detect biofilms in textiles. Unfortunately, even with polyester, the dye was too strongly absorbed to readily distinguish biofilm from fibers themselves.

Three UV lamps were used in testing fluorescence in potential biofilms. These included a Lightfe® UV301D lamp providing a beam at 365 nm, a UVBeast V3 lamp operating at 395 nm, and a UV Nova 108-LED UV lamp operating at 395 nm.

In one approach, biofilm candidates were stained using Calcofluor White M2R dye, a fluorescent brightener purchased from Phyto Technology Laboratories (Shawnee Mission, Kansas), CAS No. 4404-43-7. A solution was prepared of 0.074% Calcofluor white in water, and given the name CF1.

Two 100% polyester sports tops, the above-mentioned orange shirt CH1, and a blue top from Danskin, BD1, both with similar design and material, were examined. Both had been used for exercise for several years with persistent odor issues, although CH1 now showed substantial improvement in both pits following the previously described treatments. At this time, the orange top CH1 had been used in multiple exercise sessions since the previously discussed treatments with very little washing to create odor trouble and possible to promote biofilm growth again .

In examining fluorescence, it was eventually noted that both an SLR camera and an iPhone camera could not easily capture the fine details of fluorescence when using any of the UV lamps available for this study, probably because the fluorescence, including some background fluorescence, may have interfered with the camera's visible light operations. Such images often required enhancement (increasing contrast to around 30% and decreasing brightness to around -15%, for example) to show the fluorescent regions clearly visible to the naked eye, though sometimes the enhancement resulted in non-fluorescent zones also appearing as bright as the fluorescent zones in black and white images. However, it was found that better images could be obtained by placing a yellow UV-absorbing lens form UV safety glasses over the eye of the camera. A rubber band was sufficient for holding it in place.

Shirt BD1 (Blue Danskin Shirt)

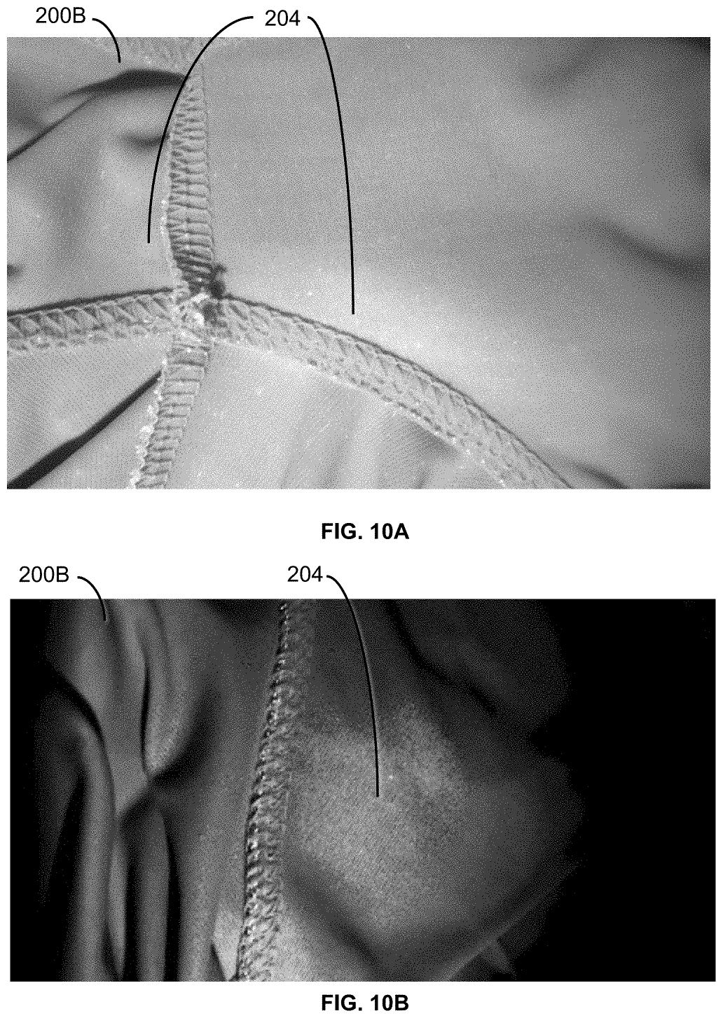

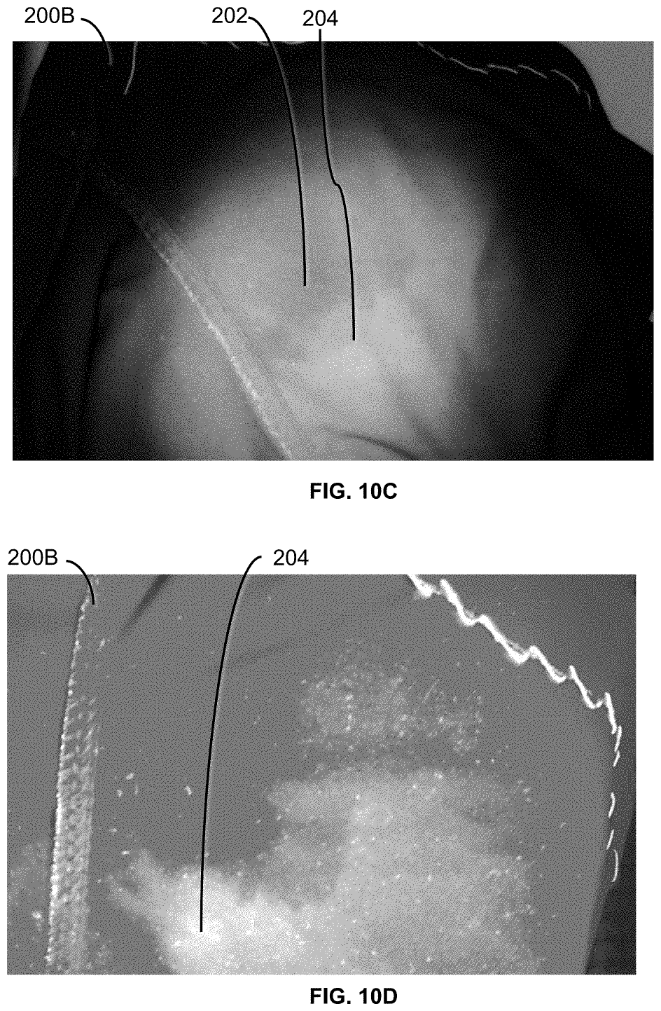

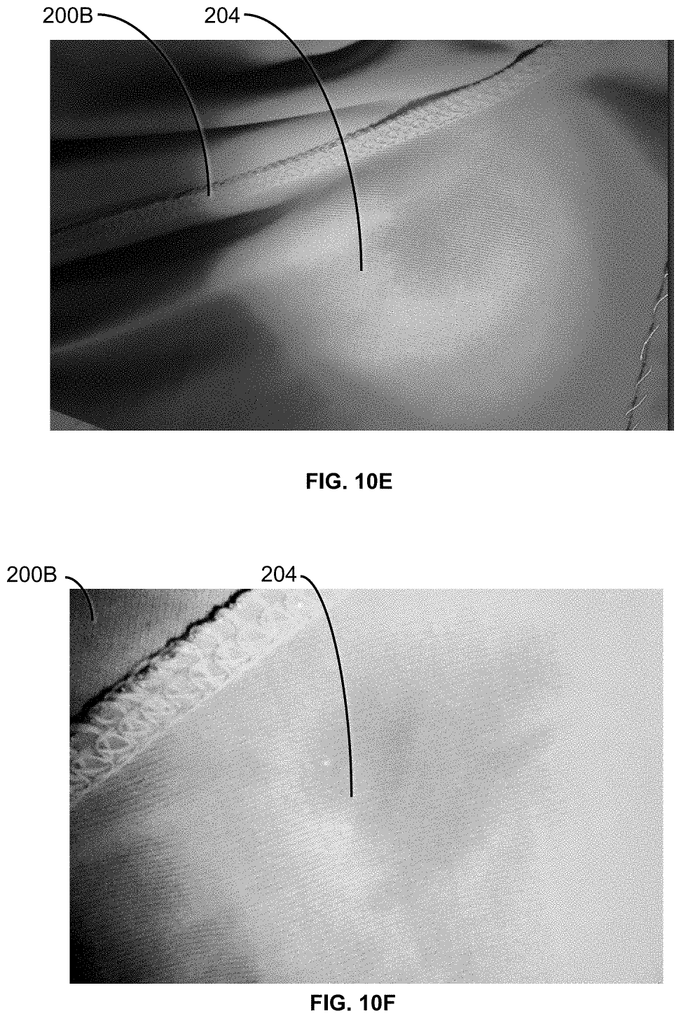

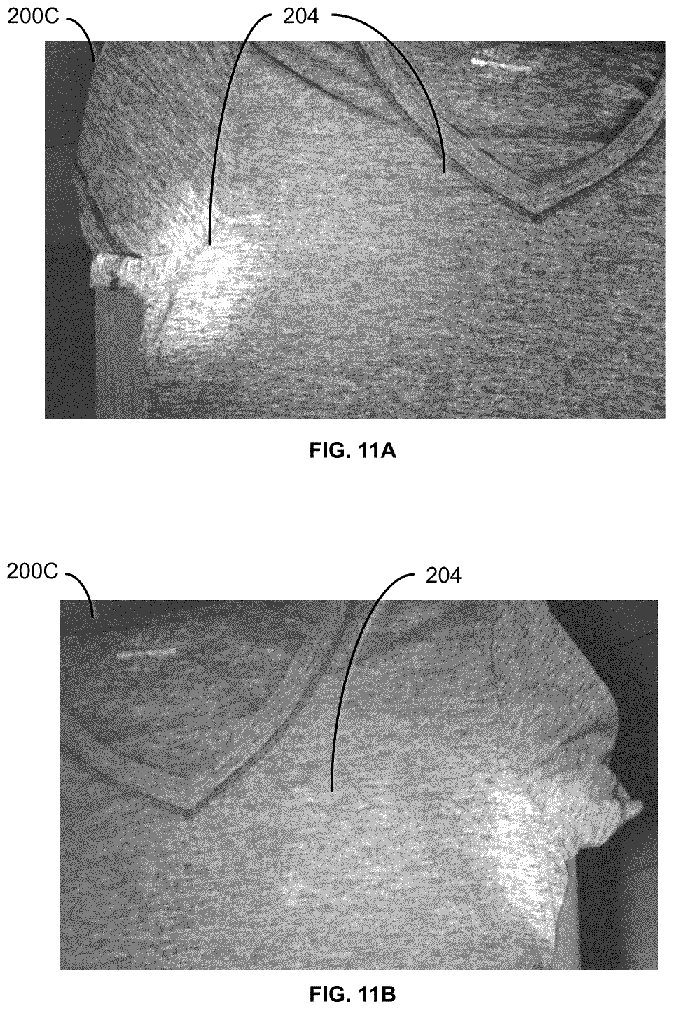

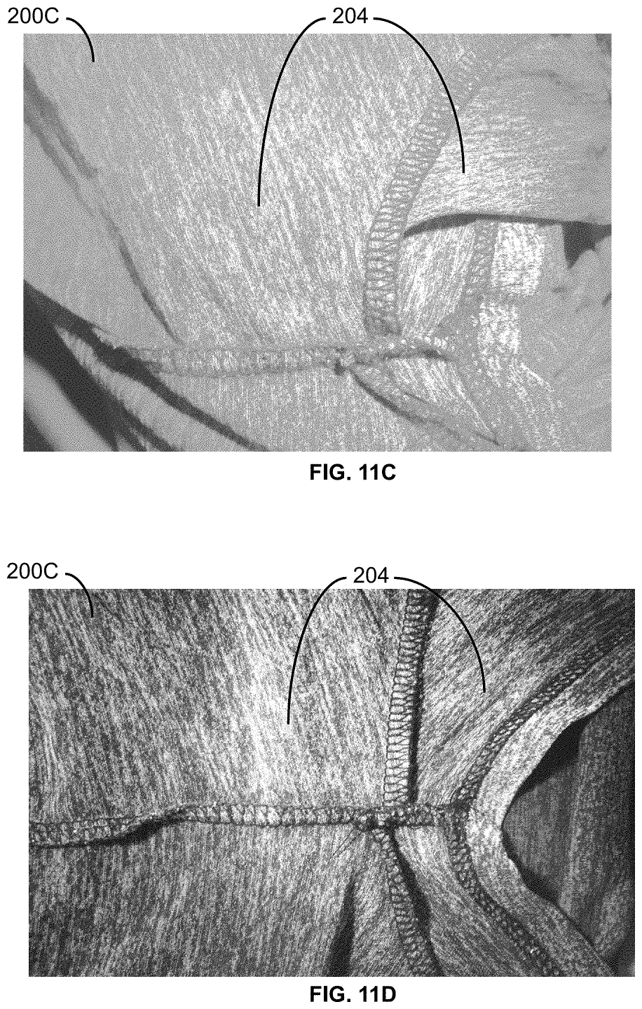

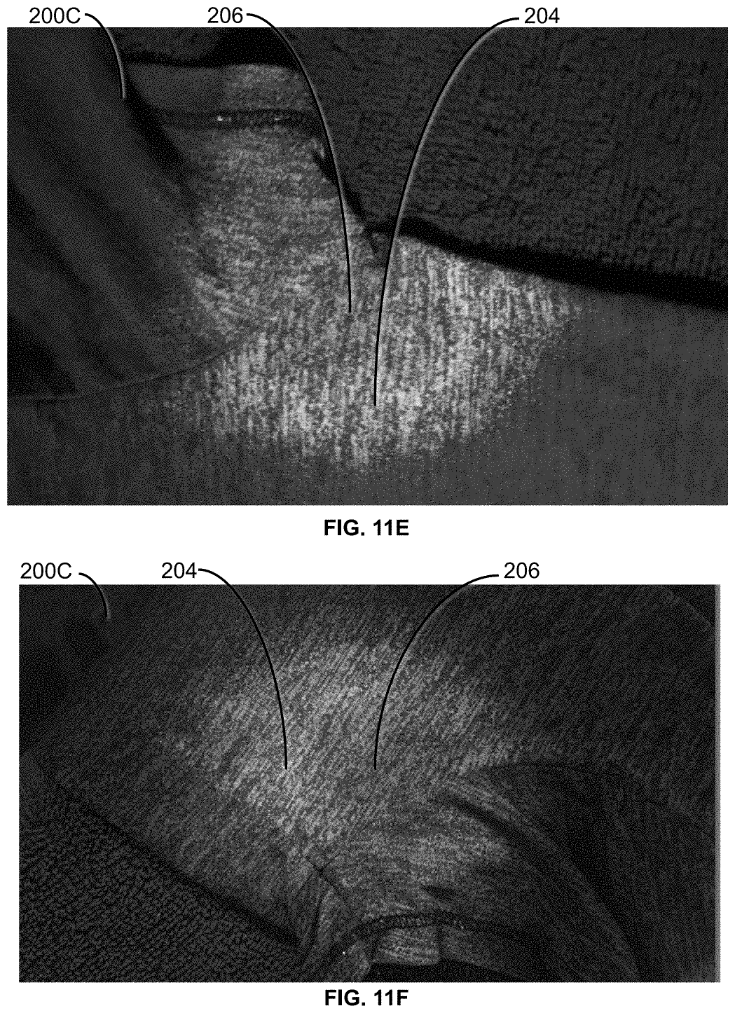

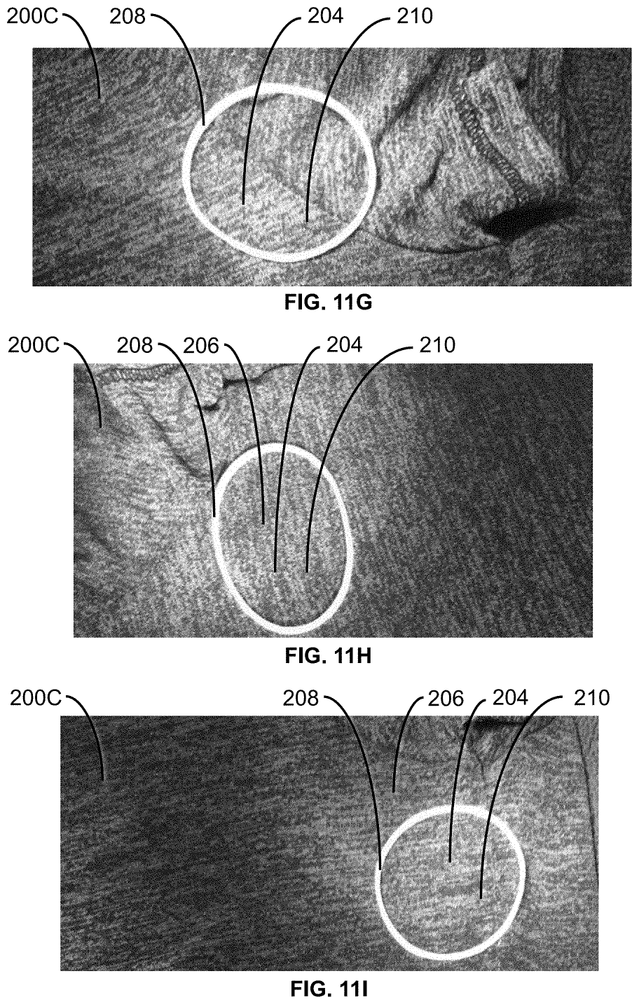

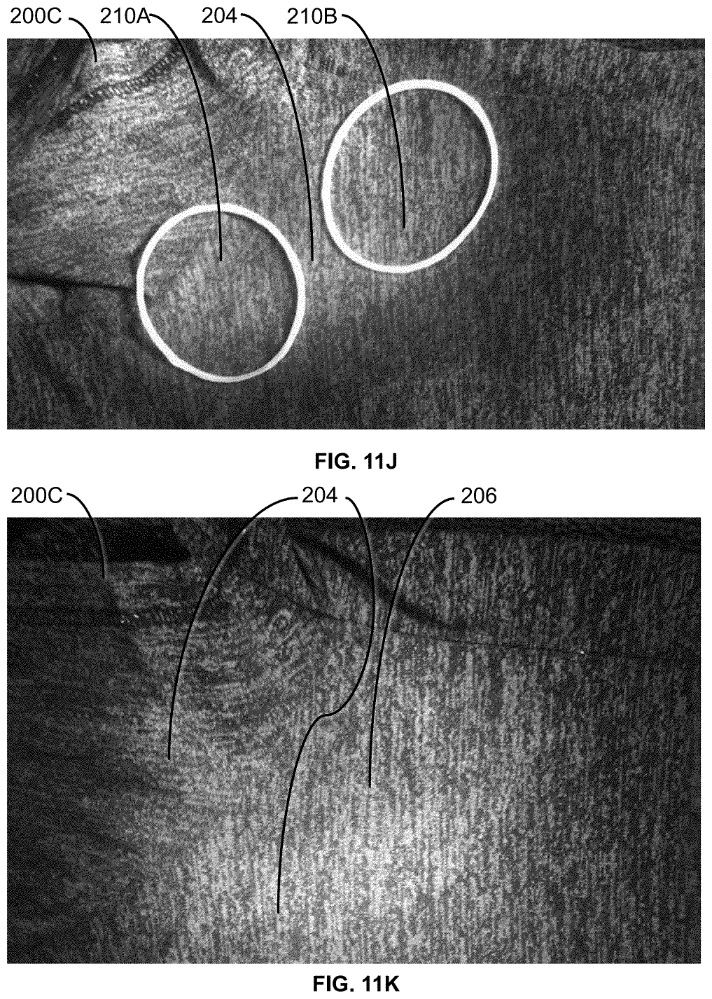

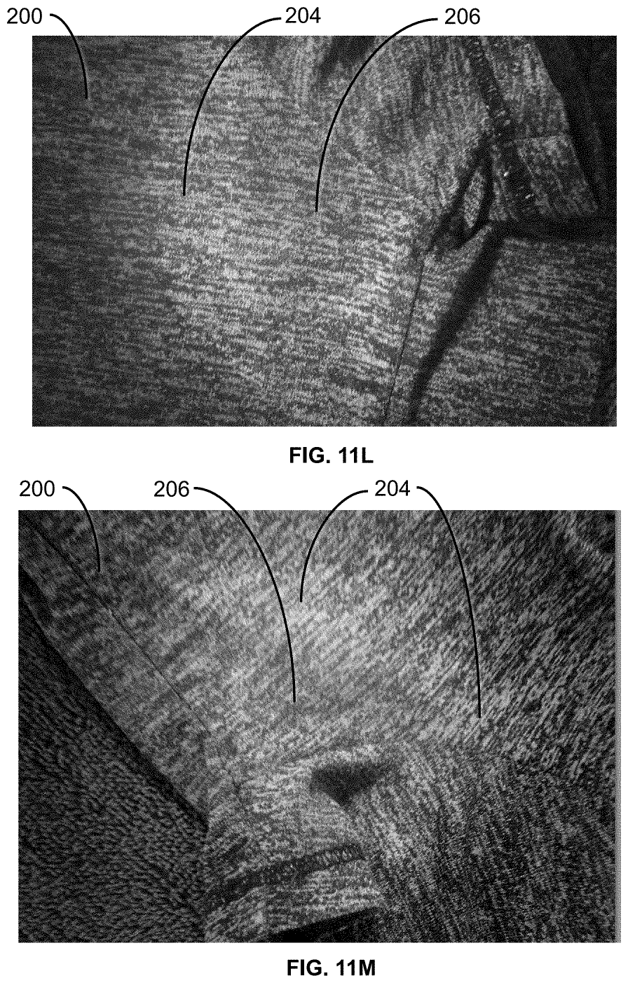

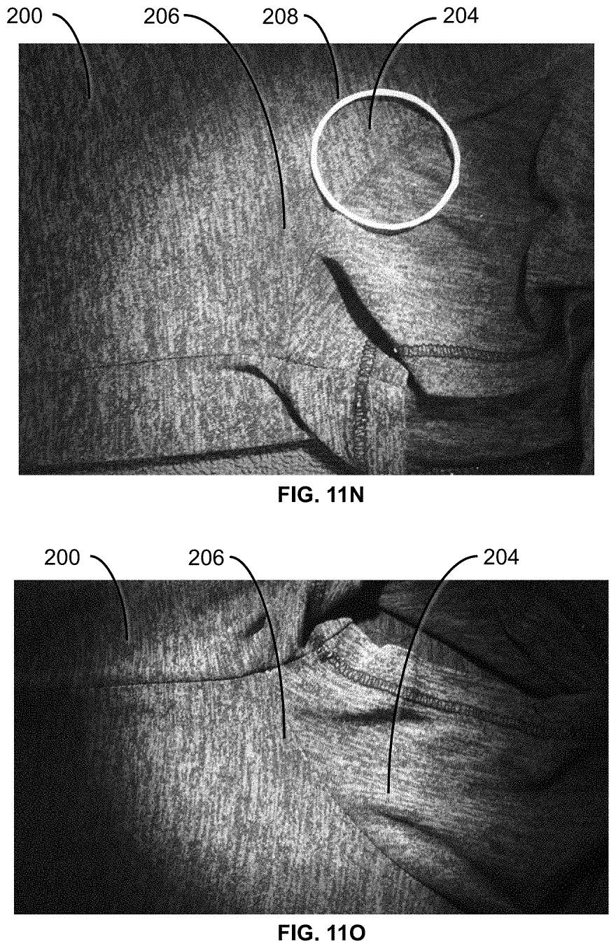

A blue Danskin shirt, BD1, was sprayed with CF1 on both pits, about 4.8 g each, then immersed in warm water for 1 minute. UV examination revealed little fluorescence after rinsing. After removing from immersion, the still wet shirt was further treated with 7.5 g CF1 to the right pit and 11.6 g to the left pit. The shirt was rinsed again. Fluorescence was still present in portions of the pits. For example, FIG. 10A shows fluorescent regions 204 in the right pit where the optical brightener adhered, photographed with an iPhone 6 Plus camera using a UV-absorbing yellow filer over the lens to block out some of the purple fluorescence of the shirt itself, while FIG. 10B, which shows a fluorescent region 204 in the left pit, was photographed without a filter, making it more difficult to get a meaningful image. FIG. 10C shows the fluorescent zone 204 also present in FIG. 11B, but with better clarity. BD1 had oblong patches of fluorescence about 2 cm wide and 6 cm long in the left pit and less in the right pit, apart from the above-mentioned fluorescent region 204 of FIG. 10B and 10C on the sleeve about 9 cm from the center of the pit. FIG. 10D is another view of the left pit taken without the UV filter and requiring increased contrast to make the fluorescent region 204 more visible (it was plainly visible to the naked eye).

After further exercise in shirt BD1, bringing both puts to an odor level of about 3, shirt BD1 was treated with 5.2 g of 2.1% NAC (pH 4) in the right pit, followed by 2.9 g of E3C. The left pit was untreated. The shirt was washed with Purex® detergent. After washing and drying, the right pit appeared to have an odor level of 0 while some residual odor remained in the left pit at a level of about 1 (scale of 1 to 5). The fluorescent zones were slightly decreased in intensity.

Further treatments were conducted in BD1. 5.2 g of 2.1% NAC at pH 6.4 was applied to the right pit followed by 3.0 g of E3D. The left pit was wetted 3.9 g of water followed by 3.28 g of E3D. The shirt was put in a plastic bag and kept at a temperature of about 33° C. for 2 hours, then washed in a full cycle at 40° C. (78 minutes) with liquid Tide® detergent. Fluorescent zones remained as revealed through use of a UV Beast V3 lamp (the default lamp used herein; exceptions with a different lamp will be noted), though again the intensity may have decreased slightly.

Shirt BD1 was then treated in the right pit only with multiple agents in this order, all applied via spray: 2.51 g of 2% NAC at pH 9, 1.54 g of LysoB, 1.26 g of CellulaseC, 1.305 g of AmylaseA, 2.38 g of PAPA, 1.06 g of PNACS, 1.37 g of PMIX1, and 1.21 g of E3D. The short was kept at about 35° C. for about one hour, then further treated with about 0.5 ml of Melaluca brand Lite Brite detergent that was rubbed in with warm water as the shirt was then rubbed and immersed into a tub of warm water, followed by washing with liquid Tide® detergent in a short cycle at 30° C. Fluorescent zones were somewhat visible after the rinse, but following the wash cycle, the treated fluorescent zones were largely removed in the right pit.

The untreated left pit still retained a fluorescent spot at the outside of a yellowish region in the blue shirt that did not fluoresce. The left pit was now treated.

Focused on the yellow zone and the adjacent fluorescent patch, 2.89 g of PAPA and 2.11 g of E3D were applied and rubbed into the treated area. The shirt was then rolled up and outer layers were wetted with about 50 ml of water. The shirt was placed in a bowl set in a metal pan with about 5 cm deep of hot water in the bottom, intended to help heat the environment and keep the shirt at a relatively stable temperature with a lid over the contents. The shirt in this environment was initially at a temperature of about 48° C. to 40° C. for the initial hour or so, followed by reheating about 2 hours later. The shirt stayed in the container overnight, with heating again in the morning bringing the temperature to about 40° C. Shirt BD1 was then washed with Tide® liquid detergent in a short cycle and then the left pit area was visualized in UV light. The fluorescent region was still present, though perhaps slightly weaker. In visible light, it was apparent that the previously noted yellow region (about 7 cm wide and 3 cm tall) was substantially reduced in size and intensity.

In hopes of repeating the removal of the white fluorescence that was seen in the right pit, the left pit was then further treated with a similar mix to the previous mix given to the right pit. In this order, the applied compounds were 3.5 g of NAC 2.1% at pH 9, 1.32 g of LysoB and 0.50 g of LysoB2, 1.3 g of CellulaseC, 1.18 g of AmylaseA, 1.58 g of PAPA, 1.0 g of PNAC5, 1.16 g of PMIX1, and 1.6 g of E3D rubbed into the fabric. This was stored in a covered pan with a bowl with some hot water inside the pan to keep the temperature at about 47° C. to 40° C. for about 70 minutes. About 0.5 g of Lemon Brite dish detergent was then applied to the treated region and rubbed into the shirt, then rinsed out in warm water. The targeted fluorescent zone was still present, though apparently slightly weaker, while the yellowish zone had been largely removed. The result for the treated left pit is shown in FIG. 10E showing the fluorescent region 204. The shirt was then washed in a full cycle with Tide® liquid detergent at 40° C. FIG. 10F shows the result for the treated left pit. These results in FIGS. 10E and 10F still show the fluorescent patch 204, but its intensity to the naked eye was significantly reduced through these treatments.

Fluorescent Testing with a Gray Perma-Odor Sports Shirt

An athletic female who exercises almost daily reported that her polyester sports top showed symptoms of perma-odor following extensive use. This shirt, code named RA1, was a 100% polyester gray Melange Jersey knit shirt from Academy, Ltd. (Katy, Texas), made in Kenya. It exhibited strong fluorescence as is in both pits, with no need to treat with Calcofluor. FIG. 11A shows a photo of the right pit under UV light, and FIG. 11B shows the left pit under UV light. After turning the shirt inside out, FIG. 11C shows a close-up of the right pit under UV light without a UV filter over the camera lens. The result with the filter in place is shown in FIG. 11D for the right pit for comparison.

It is believed that biofilm formation in the pits had created regions capable of firmly retaining optical brightening agents from typical laundry detergents. The shape, size, and position of the fluorescent zones were entirely consistent with biofilm regions formed by bacteria interacting with sweat from the armpit of an active exerciser. The fluorescent zones includes cuff regions of the short sleeves near the pits and occupied the center of the pits but centered slightly away from the center of the pit, shifted slightly toward the front of the body, consistent with the a slight forward lean during jogging or many other exercise routines that would allow the sweat to be inclined slight toward the front of the body. The intensity of the fluorescence was relatively high and seemed unaffected by ordinary washing. Several treatments were attempted to find ways to reduce the fluorescent zones.

Shirt RA1 was then treated with E3D, 9.2 g in the right pit and the left pit first treated with 2.1% NAC, 4.54 g, then 10.7 g of E3D. The initially dry shirt was then misted with about 40 g of water and placed in a plastic bag and kept at about 33° C. for 2 hours, then washed in a short cycle at 30° C. with Purex® Dirt Lift Action® Free and Clear detergent. After washing, the shirt was examined under UV light it was noted that the central region of the left pit showed significant reduction in fluorescence, giving a donut-shaped ring of fluorescence with a central void about 5 cm in diameter and an outer diameter of about 12 cm in diameter. See FIG. 11E, which was taken without the UV filter in place. The region with diminished fluorescent 208 is adjacent the more highly fluorescent region 204. The diminished fluorescence is clearer in color to the naked eye than in the images converted to black and white. The right pit (not shown) still appeared bright and lacked the visible reduction seen in the left pit, though it may have been slightly reduced in intensity also.

A second treatment was applied to the left pit of RA1 as 14 g of PNAC4 was applied to the pit and surrounding area. The shirt was heated to about 33° C. for 10 minutes. Then E3D was applied to both pits and adjacent areas, 9.6 g for the left and 9.9 g for the right. The shirt was them kept warm for about 10 more minutes then washed again in a short cycle. The washed shirt was exposed to UV light and a slight reduction in intensity was seen in both pits, but the glowing regions persisted with much the same size and shape they had prior to this wash cycle. The left pit under UV light is shown in FIG. 11F, also taken without the UV filter in place

The washed and dried shirt was now used to test different treatments applied to three sections of the major fluorescent area of the left pit, as shown under UV light in FIGS. 11G, 11H, and 11I, showing upper, middle, and lower treatment zones 210, each marked by a respective boundary marker 208. The entire left pit and sleeve area was treated with 6.1 g of NAC spray, 2.1% at pH 4.0, followed by individual treatments in the treatment zones.

In the upper treatment zone shown in FIG. 11G, relatively high in the fluorescent area (toward the shoulder region), the treatment zone 210 (roughly a 5-cm diameter circle) was treated with amylase solution, but was first sprayed with 1.76 g of 2% NAC at pH 9.17 to raise the pH to about 7, as confirmed with pH testing paper, followed by dropwise application by pipette of 2.6 g of AmylaseA solution.

The lower treatment zone shown in FIG. 11I, received 2.45 g of PMIX1 dropwise by pipette to apply a mix of pectinases to a roughly 5 cm diameter circle in a lower fluorescent zone in the pit. FIG. 11I shows the boundary marker 208 (here a rubber band) marking the upper treatment zone 210 for pectinase solution. Treatment zone 210 contains portions of the fluorescent zone 204 in the left pit.

In FIG. 11H, the middle treatment zone 210 between the above-mentioned two zones, received treatment with papain and lysozyme. 1.7 ml of LysoPap solution was pipetted onto the oval treatment zone 210 about 5 cm wide and 3 cm tall. Then the right pit was prepared by spraying about 2 g of 2.15% NAC solution at a pH of 6.4 over the lower half of the fluorescent pit zone (not shown), then 2.3 ml of CellulaseA solution was applied by pipette to that region. Then 1.0 g of E3D was sprayed onto the treated area of the right pit and 1.6 g of E3D was sprayed into the treated regions of the left pit. After 10 minutes, the shirt was rinsed in 1 liter of hot water (about 45° C.) containing 1 g of Lemon Brite dish detergent. The shirt was gently agitated by hand for about 1 minute and then rinsed in fresh water for about 1 minute.

The treated regions were then rinsed in warm water and wrung to partial dryness. It was observed that the region of the left pit that had been treated with LysoPap solution (lysozyme and papain), the middle zone of FIG. 11H, had reduced fluorescence. The other regions looked much the same as before, though may have had slightly reduced intensity. The lower left pit was now treated with 0.76 g of 2.15% NAC solution at pH 6.4, and then 1.1 ml of PAPB solution were applied via pipette, plus 1.0 ml of AmylaseA, all in a 5-cm diameter circles over a fluorescent zone. After 5 minutes, another 0.3 ml of PAPB solution was applied followed by 0.1 g of Lemon Brite dish detergent in the targeted spot, which was then rubbed in. The fluorescence was not dramatically different, though it seemed slightly attenuated in both cases.

Now two treatment zones in the left pit were considered, both circles about 5 cm in diameters, as shown with UV light in FIG. 11J, showing a first treatment zone 210A and a second treatment zone 210B. The first treatment zone 210A was on the seam between the sleeve and the shirt in the pit area, and the second 210B was centered about 9 cm lower than the seem toward the adjacent side of the garment. In the second treatment zone 210B, 1.6 g of 2.15% NAC (pH 6.4) was applied, then 1.856 g of LysoA solution was applied by pipette uniformly in the section. In the first treatment zone 210A, 1.7 g of LysoA solution and then 0.75 ml of PAPB were applied by pipette, followed by spraying 1.0 g of E3D. The shirt after these applications beut before washing is shown in FIG. 11K, taken with the UV filter About 3 minutes later, 0.4 gm of Lemon Brite dish detergent was applied roughly uniformly to the two sections and rubbed in. The shirt was then rinsed in warm water. Reduced fluorescence was observed in the second treatment zone 210B of the left pit. See FIG. 11L, taken with the UV filter.

Now 2.2 g of 2.15% NAC was applied to the lower half of the fluorescent zone in the left pit, and 1.3 g of LysoA solution was the glowing portions on the cuff of the sleeve, with 1.6 g of 2.1% NAC at pH 6.4 and 0.3 g of Lemon Brite detergent over the sections. In the lower part of the left pit area, 2.3 g of LysoB were applied, with 1.67 g of PAPB and 2.58 g of CellulaseB, using a pipette. The shirt was kept at 32° C. for about 10 minutes in a plastic bag. The bag was then removed and the treated region was further provided with 7.7 g of PNAC5 (fluorescing regions: the lower left pit area and the cuff region on the left sleeve).

To raise the pH, a solution at pH 9.89 was prepared from 1.56 g sodium carbonate and 1.0 g NaHCO3 in 91 ml of water. 13 g of this alkaline solution were applied to the treated regions of the shirt and it was then returned to the plastic bag and kept at about 32° C. The shirt was then rinsed and examined. The fluorescence was perhaps slightly less but the dimensions of the fluorescing areas were substantially the same. See FIG. 11M for the left pit.

The left pit was treated again with 3.76 g of 2.15% NAC at pH 6.4 applied to the lower half of the left pit along with 2.16 g of 2.15% NAC at pH 9.17. The upper half of the left pit was sprayed with 5 g of water. Then 5.6 g of CellulaseC solution was applied dropwise to both the upper and lower left pit, along with 1.94 g of AmylaseA. The shirt was kept at about 28° C. for 30 minutes, then rinsed with a roughly 1% solution of Comfort® brand laundry detergent. Residual fluorescence was still visible, but had declined more strongly in the lower half of the pit.

In a further test, 12 g of CellAmylA was applied by pipette to the entire fluorescing area of the lift pit and sleeve. After 5 minutes, 2.5 g of E3D was applied to the fluorescing areas of the left side. Then 1.4 g of 2% NAC at pH 6.4 and 2.25 g of PAPA solution was applied by pipette to the upper portion of the glowing zone, as shown in FIG. 11N under UV light and with the UV filter in place, also showing the state of fluorescence in the left pit with significant decline compared to early states and a prominent central region of diminished fluorescence 206, more plainly visible in color to the naked eye. The shirt was put in a plastic bag and held at about 33° for 1 hour. Slightly reduced fluorescence was again observed.

Next the right pit was considered. An upper zone, Section A, in the pit comprising the cuff of the right shirt sleeve having an oval shape about 5 cm wide and 3 cm tall was treated with 3 g of water and then 2.6 g of PAPA. A lower region of similar dimensions was denoted Section B was centered on the seam at the side of the shirt about 8 cm below the seam connecting the sleeve to the shirt. It was treated with 1.1 g of 2% NAC at pH 6.4 and 1.8 g of PAPA. After 20 seconds of mild rubbing, and rinsing, UV light showed further progress in removing the fluorescing material. The same pit was treated again. 3.46 g of 2% NAC solution at pH 9.17 was applied to the upper portion of the pit, while 2.35 g of LysoB was then applied to the upper regions and 2.25 g of LysoB was applied to the lower area. After rinsing, it was observed that fluorescence had been slightly reduced again. See FIG. 11O.

In another series, the effect of high sodium citrate concentration was tested. Based on a speculative hypothesis regarding high ionic strength and citrate ions in particular, a 12% solution of sodium citrate was prepared and 7 g was applied dropwise to the remaining fluorescent zone of the left pit and to a previously untreated fluorescent spot near the center of the shirt several inches below the neckline, followed by spraying 1.72 g of E3D over the treated regions. This was kept at about 30° C. for 3 hours, then rubbed with 0.3 g Lemon Brite detergent and rinsed in warm water. Water was then wrung out by wringing the shirt rolled up in a dry towel, and the treated area was visualized. The previously treated pits showed only very slight improvement at best, but the previously untreated fluorescent spot had been significantly reduced in brightness and appeared to be slightly smaller in extent. A reddish fluorescent zone that was adjacent the more central blue fluorescent zone, possibly from a newly incubated biofilm during a period of illness in which the shirt was worn, also showed significant reduction.

The right pit, whose fluorescence was much brighter than the left pit since the right pit had received relatively fewer biofilm busting treatments, was now treated. Two zones in the right pit were defined, a lower and an upper, both with strong fluorescence and both about 5 cm in diameter. Each received about 2.3 g of the 12% citrate solution. The upper received no further treatment agents, while the lower zone was sprayed with 1.86 g of E3D. The shirt was then incubated at about 40-45° C. for two hours, and then washed and rinsed as described for the left pit above. Examination in UV light showed only little reduction in fluorescence. The benefit of the citrate treatment may be most useful for biofilms that have not been treated multiple times already, though it is also believed to have an impact in disrupting living bacteria to reduce their potential to form further biofilms.

In another test, a strongly fluorescent zone on the cuff of the left arm closest to the left pit was treated with nattokinase and NAC by applying 2 g of the NattoNAC solution, waiting 5 minutes, and then applying 1.0 g of E4D solution. This was kept at 21-22° C. for about 4 hours, with about 0.7 g of moisture added again after 4 hours to keep the cuff moist to best permit bacterial spores to be effective. *

In another test, a fluorescent zone under the right pit, on the front of the shirt about 10 cm below the pit along the seam, was treated with both GASTRO-1 and PANNAC. First 0.79 g of PANNAC was applied to a circular area about 2 cm in diameter, and after about 5 minutes 1.0 g of GASTRO-1 was applied to the same spot. After 15 further minutes, 0.75 g of E4D was applied. This was kept at about 22° C. for about 4 hours.

### The Triathlon Shirt, TR1

The triathlon shirt TR1 was examined. Since initial biofilm busting treatments, it had been worn many days without washing and the pits had a cheesy smell. CF1 was applied to both pits, 6.48 g to the left and 4.45 g to the right. In a test spot elsewhere on TR1, it was observed that the Calcofluor White dye persisted after rinsing with water, but could be substantially removed with the aid of a surfactant.

A laundry cycle (short cycle, 38 minutes at 30° C.) was run with shirt TR1 and Dec1. Based on UV visualization, the optical brightener washed out of TR1 except in the pits, suggesting strong attachment, perhaps due to biofilm material.

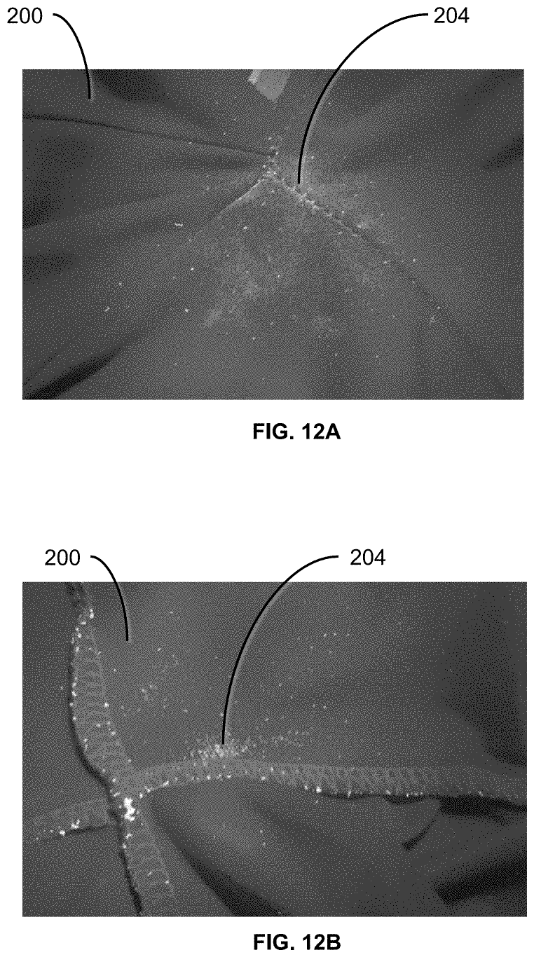

FIGS. 12A and 12B show pits of shirt TR1 under UV light from the Lightfe® mini-UV lamp with the UV filter in place. This image was taken after the initial perma-odor problem had been overcome with biofilm buster treatments previously described. Since that time, it had been worn during roughly a dozen exercise sessions and many hours of wear to try to revive the biofilm problem. UV visualization shows what may be biofilm material.

### Confocal and Fluorescent Microscopy

To further examine potential biofilm zones in various clothing items with a history of perma-odor, work was carried out with confocal and fluorescent microscopy at the NanoCenter at the University of Minnesota using a Nikon C2 Confocal microscope operated with Nikon Elements software. The microscope functions as a manual inverted microscope, a fluorescence-enabled microscope, or a confocal microscope system, depending on preference. Further details are provided in K. VanderWaal, “University of Minnesota Nano Center Standard Operating Procedure [for the Nikon C2 Confocal Microscope],” 2016; http://apps.mnc.umn.edu/pub/pdf/equipment/nikon_confocal_sop.pdf. For observing fluorescent regions in shirts, rather than cutting and mounting samples, the shirts were preserved by measuring them in situ while stretched across the measurement space. For confocal microscopy, the UV laser at 405 nm wavelength was used, while for fluorescent microscopy, the UV fluorescence was observed from a widefield white light observed through a DAPI filter cube was used to see the resulting blue fluorescence (this filters the light to an excitation band of 340-380nm, and then filters the emission band to 435-485nm). In both cases, no fluorescent dyes were added to the material, but the inherent fluorescence in the clothing, believed to be due to optical brighteners, was relied on.

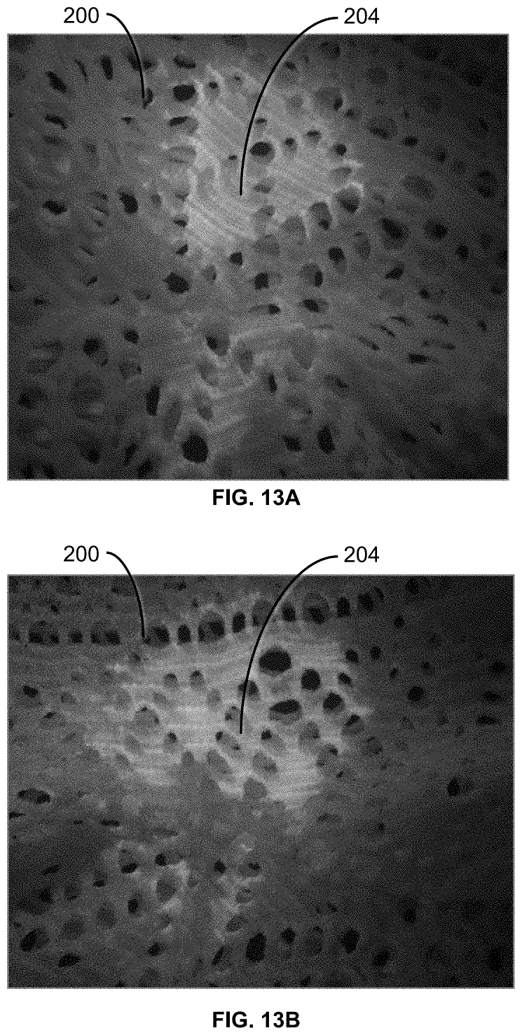

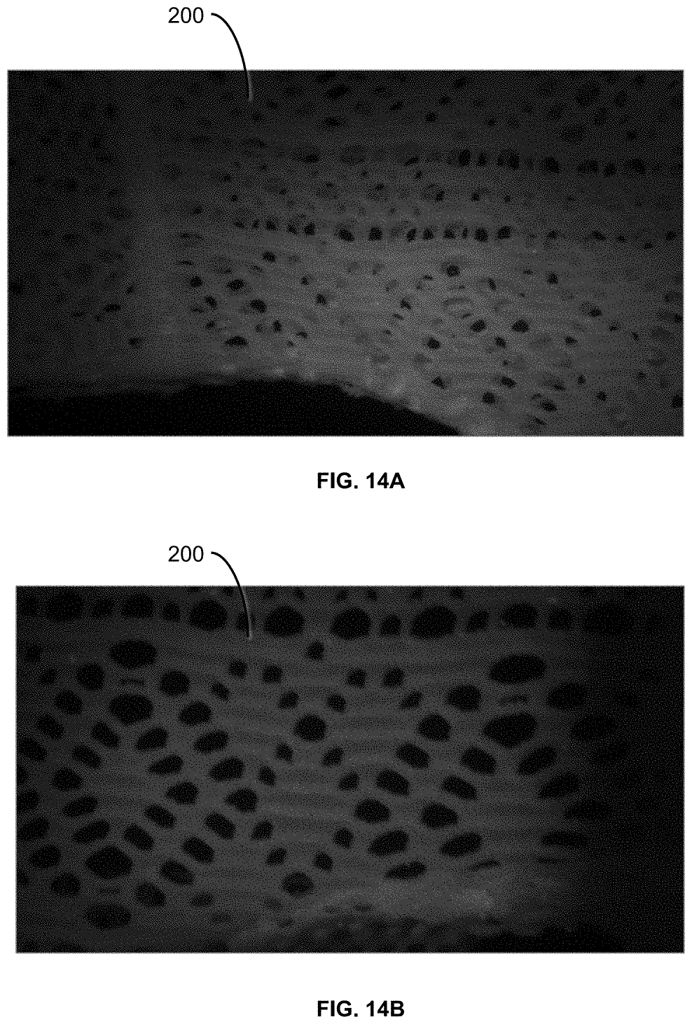

FIGS. 13A and 13B show the left and right pits in UV light, respectively, of a lace dress provided by a subject who complained of persistent odor that would not wash out from the dress. The washed dress 200 was examined under UV light and prominent fluorescent zones 204 in the arm pit areas were observed, with typical characteristics: the were biased toward the front of the body and in the pits, consistent with typical sweat patterns in clothing. The fluorescent zones 204 were examined with both fluorescent and confocal microscopy (discussed below). The pits of the dress were then treated. The right pit was treated with 0.7 g of E6C (a bioenzymatic mix described above), with added moisture present in that portion of the dress resulting in roughly a 2:1 dilution. For the left pit, first a pretreatment was applied by spraying 2 g of a biofilm attack solution, PANNAC, onto the biofilm region and adjacent fabric. After a 5-minute wait, 1.54 g of E6D was applied to the same region. With some moisture present in the dress, it is estimated that the effective dilution of the E6C solution was about 3:1. The dress was wrapped in a plastic bag and kept at about 27° C. for 11 hours, then washed by hand in warm water with GAIN® detergent. Surprisingly, as shown in FIGS. 14A and 14B for the left and right pits, respectively, in UV light after treatment, the fluorescent matter in both pits was almost completely eliminated, with only a small region (about 2% of the original extent) still fluorescing in the left pit, but essentially nothing visible to the eye remaining in the right pit.

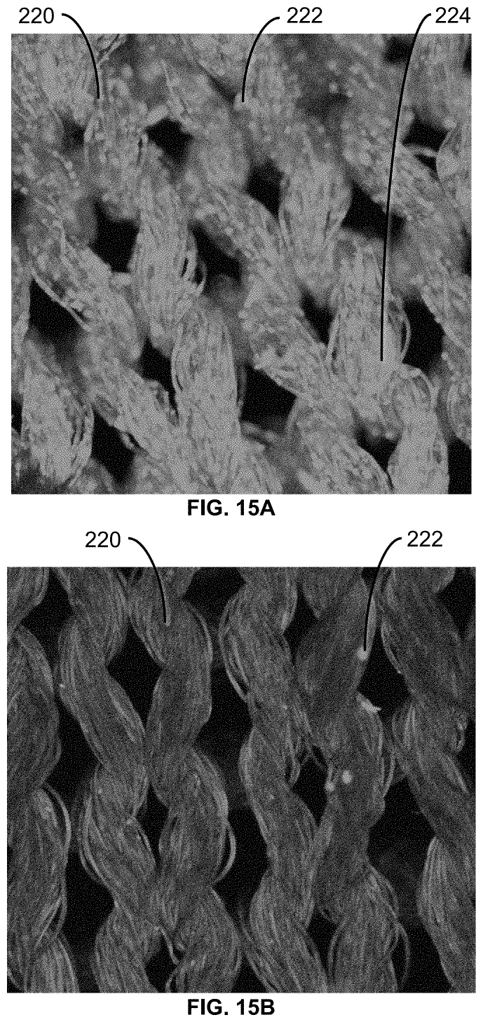

FIGS. 15A and 15B show before and after confocal microscopy views of what was the original fluorescent region in the left pit, using the same settings for laser intensity, dwell time, and other characteristics of the microscope using the UV laser. FIG. 15A shows the fluorescent matter prior to the bioenzymatic treatment, showing the presence of fibrous yarns 220 with numerous fluorescent “islands” 222 on the fibers, and occasionally larger patches 224 where fluorescent matter seems to bridge multiple fibers. What was the fluorescent region is again shown after the bioenzymatic treatment in FIG. 15B, where a few lone islands 222 of fluorescence remain, but overall showing much less presence of apparent biofilm matter. The bioenzymatic spray was effective, but was somewhat more effective when coupled with the NAC plus panthenol mixture, the PANNAC spray.

Further Details and Examples for Personal Care

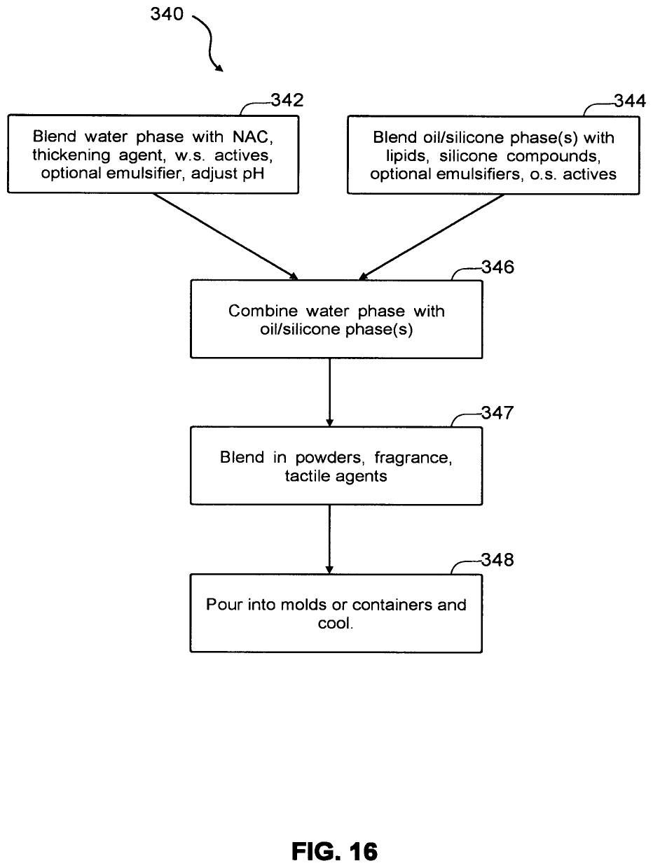

FIG. 16 is a flow chart showing one aspect of a method 340 for making a stick composition for various products described herein. In step 342, a water phase as prepared by blending water with NAC, one or more thickening agents, water soluble actives for the intended function (e.g., Vitamin C, mandelic acid, antimicrobial agents such as cationic steroidal antimicrobials, sunblock agents, anti-wrinkle agents, etc.), optional emulsifiers, pH control agents, thickeners, etc. In step 344, one or more non-aqueous phases such as oil and/or silicone phases are prepared, which may include various lipids, silicone compounds, optional emulsifiers, oil soluble actives, gelling agents, etc. The water phase from step 342 and the non-aqueous phases from step 344 are then combined in step 346, which may include operations such as heating both phases to desired temperatures, blending by mechanical stirring, sonification, use of a homogenizer (rotary, high pressure, ultrasonic), ultrasonification, static mixers, screw extruders, etc. After step 346, step 347 comprisies blending of other ingredients such as powders, fragrance, tactile agents, colorants, shear-sensitive ingredients, etc. Following step 347, composition from step 346 is then poured into molds or containers and cooled in step 348.

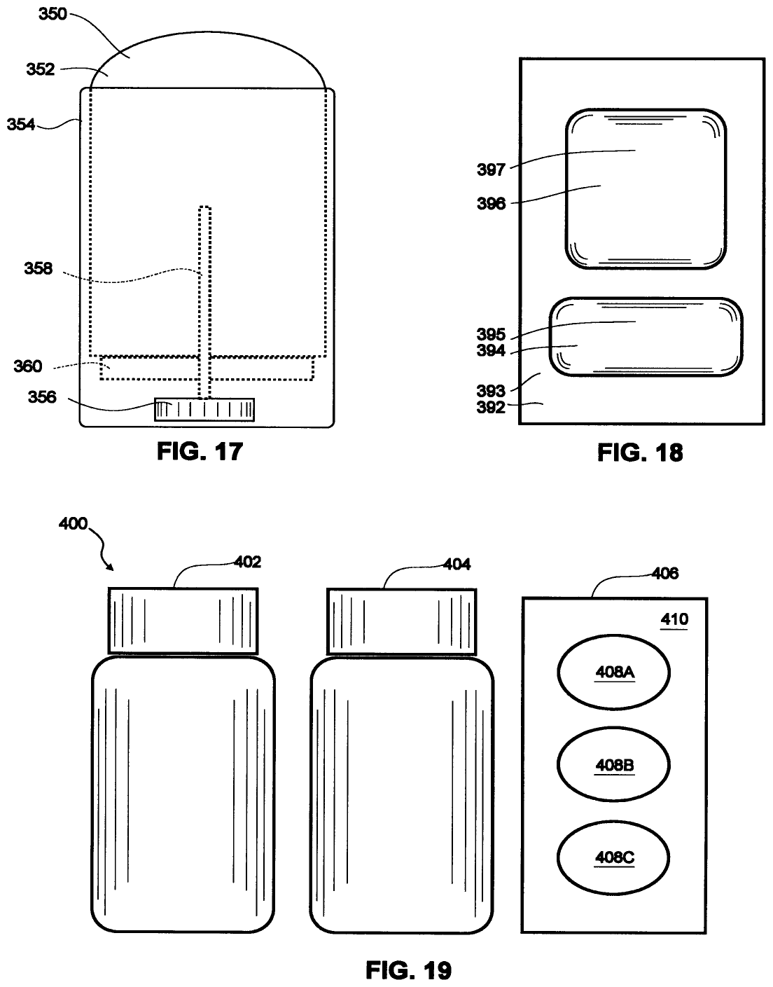

FIG. 17 depicts a product 350 comprising a stick 352 of a material such as a cosmetic material, personal care material, health care material, cleaning material, etc., such a cosmetic material including any one of a deodorant or antiperspirant composition, a lip balm, a sunblock, a wound treatment material, an antifungal or antibacterial composition, a soap or cleaning agent, a material for scrubbing on textiles or various hard or porous surfaces, etc. The stick 352 is contained within the walls of a barrel 354 with an upper opening from which the stick 352 may be dispensed (e.g., pushed out). In the lower portion of the product 350 there is disposed a turnable knob 356 attached to a threaded spindle 358 (threads not shown) that drives the motion of an associated platform 360 on which the stick 352 rests. By turning the knob 356, the amount of the stick 352 rising above the walls of a container 354 can be adjusted to a selected height above the barrel 354. The stick 352 has an upper surface that is generally dome shaped for comfortable application to the body of the user. (A cap for the product 350 is not shown.)

FIG. 18 depicts a container 392 comprising a first well 394 and a second well 396 which are surrounded by a containment surface 393 which may be a flat or contoured solid surface with a closure or lid (not shown). In one aspect, the container is intended for cosmetic use. In that case, the first well 394 comprises a first composition 395 such as a foundation, cleanser, or moisturizer that can be applied to the skin, while the second well 396 comprises a second composition 397 such as a cream, sunblock, anti-microbial agent, colored cosmetic, etc. The first and second compositions 395, 397 may be intended for different usage such as broad application for one and while the other may be intended for application to a subset of regions for touch-up or other purposes. In one aspect, the first composition is an anti-wrinkle agent or Vitamin C serum that comprises 0.1% or more NAC, while the second composition may be a powdery or mineral-based pigment, or, alternatively, a sunblock agent and/or moisturizer that may also comprise at least 0.1% NAC. The container may be small enough to serve as a single-dose unit, or may be suitable for many uses. Application of the first and second compositions 395, 397 may be done by common or different means such as by use of an applicator comprising foam, cotton, a textile, etc., direct use of fingers, use of a wipe or tissue (not shown), etc.

In an alternative aspect, the container 392 is intended to support cleaning functions, and the first composition 395 may then comprise a paste, solid powder, slurry, or solution comprising cleaning agents such as enzymes and detergents, while the second composition 397 may comprise NAC powder or solution, coupled with other agents such as panthenol. The first and second compositions 395, 397 are thus separated until ready to use, and then can both be combined with a quantity of water to create a cleaning mixture (not shown). In one aspect, the container 392 is water soluble such as a water soluble film such that placing the container in water causes the container and the first and second compositions 395, 397 to dissolve and become available for use in a cleaning solution (not shown). The second composition 397 may be a solid such as a powder or solid capsule comprising NAC and optionally other biofilm attack agents, antimicrobials, buffering agents, cleaning agents such as borax, boric acid, borax, sodium carbonate peroxyhydrate, etc., and first composition 395 may comprise enzymes, surfactants, bacterial spores, with suitable chelants, solvents, rheology modifiers, builders, and the like. In one aspect, the entire container 392 or just the opened and emptied contents of the first and second wells 394, 396 may be placed in a washing machine (for either laundry or dishes, etc.) and run in a wash cycle with or without other items placed therein to reduce biofilm matter in the washing machine (not shown).

FIG. 19 depicts an assembly 400 comprising a first container 402 with a comprising an enzyme and/or detergent and/or bacterial spores for use as a pretreatment of a surface or item, and a second container 404 comprising a second cleaning agent which may also comprise one or more enzymes and detergents to be applied after the pretreatment. NAC may also be present in either or both of the containers 402, 404. The assembly may further comprise a third container 406 which may comprise a blister pack 410 or other packaging system for providing solids such as three tablets 408A, 408B, and 408C. The tablets 408A, 408B, 408C can be detached from the blister pack 410 and placed in a washing machine to run a sanitizing cycle, in which the antimicrobial ingredients of the tablets 408A, 408B, 408C can be effective in reducing microbes dwelling in the washing machine (not shown). Alternatively, the tablets 408A, 408B, 408C may be placed in a toilet tank or bowl to reduce biofilm growth and may provide controlled release of NAC and other anti-biofilm agents. The contents of the first and second containers 402, 404 may be used in a pretreatment and then cleaning treatment of solid surfaces in a bathroom or kitchen, for example, or of clothing items, etc.

As used herein, “acid paste” refers to an aqueous or polar/hydrophilic phase comprising an acid that is combined with a non-aqueous/non-hydrophilic phase (e.g., an oil phase or silicone phase) in methods for preparing an acidic deodorant stick disclosed herein.

Thickeners for cosmetic preparations may include starches such as native starches, modified starches, cold-water soluble starches, and the like, including but not limited to corn starch, tapioca starch, potato starch, cassava starch, arrowroot starch, wheat flour, sago, cationic starches such as cationic corn starch, etc. Thickeners may also include gums such as xanthan gum, guar gum, Sclerotium gum, locust bean gum, acacia gum, konjac gels, alginin and its derivatives, namely, alginic acid, sodium alginate, potassium alginate, ammonium alginate, and calcium alginate, and the like. Polysaccharide gums and other polysaccharide thickeners may be used such as pullulan, pectin, agar, gelatin, and carrageenan (both kappa and iota forms) can be considered. Cellulose derivatives may also be used. Mineral agents may be used such as slurries of clay materials such as kaolin, hectorite, thickening waxes sold for cosmetic purposes, betonite, laponite, silica, alumina, attapulgite, montmorillonite, hydroxyapatite, talc, etc. Various polymers may also be used such as polyvinyl alcohol, polyacrylic compounds such as carbomer, polylactic acid, carboxomer polymers, various superabsorbent polymers, and the like.

Polyols for cosmetic preparations may include glycerin, propylene glycol (1,2-propanediol), 1,3-propanediol, 1,2-butanediol, 1,3-butanediol, 1,2-pentanediol, 1,5-pentanediol, isopentyldiol, 1,2-hexanediol, 1,6-hexanediol, diethylene glycol, diglycerin, dipropylene glycol, triethylene glycol, 1,2,3-hexanetriol, 1,2,6-hexanetriol, or combinations of the suitable polyols in any given ratio. 1,6-Hexanediol may also be considered. In general, any alkyl diol having from 3 to 9 carbons and a viscosity at 20° C. of at least 20 mPa-s and more specifically any 1,n-alkanediols for n less than 9 may be considered such as methylpropanediol. Liquid alkyl triols may be considered such as butanetriol. Polyols, whether used as a thickener or a solvent or both, may be present at levels such as 0.3% to 25%, 0.3% to 20%, 1% to 25%, 0.5% to 15%, 0.5% to 10%, 0.2% to 6%, 0.5% to 5%, or 0.5% to 3%, or less than 3%.

Lipids of use herein may include (1) fatty alcohols such as stearyl alcohol, oleyl alcohol, behenyl alcohol, isostearyl alcohol, cetyl alcohol, myrsityl alcohol, laurel alcohol, erucyl alcohol, palmitoleyl alcohol, arachidyl alcohol and other C12-C36 alcohols; (2) fatty or oil-like esters such as alcohol esters of C1-C30 carboxylic acids and of C2-C30 dicarboxylic acids including straight and branched chain materials as well as aromatic derivatives such as diisopropyl sebacate, diisopropyl adipate, isopropyl myristate, isopropyl palmitate, methyl palmitate, myristyl propionate, 2-ethylhexyl palmitate, isodecyl neopentanoate, di-2-ethylhexyl maleate, cetyl palmitate, myristyl myristate, stearyl stearate, isopropyl stearate, methyl stearate, cetyl stearate, behenyl behenrate, ethylene glycol distearate, etc.; (3) fatty acids such as stearic acid, palmitic acid, oleic acid, glycerin monostearic acid, glycerin distearic acid, glycerin monooleic acid, myristic acid, isopropyl myristic acid, isopropyl stearic acid, butyl stearic acid, other C12-C28 acids, and the like; and (4) fatty acid amides,. Lipids may include oils such as vegetable oils including avocado oil, safflower oil, grapeseed oil, coconut oil, cottonseed oil, menhaden oil, palm kernel oil, palm oil, rapeseed oil, linseed oil, and mixtures thereof.

Silicone compounds useful herein may include numerous silicone derivatives used in cosmetic chemistry and personal care applications, including siloxanes such as cyclopentasiloxane, dimethicones, alkyl dimethicones, silesequioxanes including powders such as polymethylsilsequioxane, various liquid silicones or silicone oils such as polydimethylsiloxane (dimethicone), polymethylphenylsiloxane (diphenyldimethicone), phenyltrimethicone, diphenylsiloxyphenyltrimethicone, amino-modified silicones, alkyl-modified silicones, phenyldimethicone, cyclomethicone (octamethylcyclotetrasiloxane), hexamethylcyclotrisiloxane, poly(methylphenylsiloxane), cetyldimethicone, behenoxydimethicone, etc.

One challenge is obtaining a stable emulsion with silicone compounds blended with oil or water, particularly for silicone levels about roughly 5% of the composition and perhaps especially at low pH. Some of our initial trials revealed that silicone levels above 5% or so could lead to syneresis (sweating) and other stability issues, but it is believed that the inventive use of a suitable thickener combined with the mandelic acid or other alpha-hydroxy acid (e.g., lactic acid, glycolic acid, etc.) can lead to enhanced stability for the mixture and better integration of elevated silicone levels. In some tests, we have successfully integrated over 30% silicone compounds into a mix also comprising lipids and an aqueous phase, which is believed to be unusual. Thus, in some embodiments, there is provided a stable composition comprising lipids (esters and waxes) at 5% to 70% by weight, significant silicone compounds (5% to 40% by weight), and a thickened aqueous phase carrying enough of one or more acids such as NAC or an alpha-hydroxy acid that is solid in its pure form at room temperature such as mandelic acid to provide at least 1% or at least 2% of the acid in the stick but less than 20% water in the stick or less than 12% or 11% water. Likewise, in some embodiments, a method is provided for making such a stick by combining the lipids and silicones in a molten phase, adding at least one of an emulsifier or gelling agent, blending in a thickened aqueous phase comprising the alpha-hydroxy acid to form a low pH molten mass, and optionally adding a powder prior to pouring the molten mass to form a deodorant stick having an effective pH from 2 to 6, or from 2 to 5.5, or from 2.5 to 5.

As used herein, a “semi-solid” refers to a combination of solid and liquid materials or a composite material with multiple phases or discrete components which does not readily flow under the force of gravity when a unit such as a 5-cm cube of the material rests on a flat surface at 20° C., but which can deform and flow under shear. When measured at a shear rate of 0.5 sec⁻¹, the viscosity may be at least 15,000 centistokes, such as from 15,000 to 10,000,000 centistokes, etc.

### Skin Care Products and Serums

A variety of skin care serums can be produced using NAC. A serum may comprise 0.1% to 25%, 0.1% to 10%, 0.15% to 5%, or 0.5% to 4% NAC as an antioxidant and microbiome control agent, coupled with one or more of: a) other antioxidants such as natural plant extracts, plant metabolites such as equol, flavanols, etc.; b) peptides such as tripeptides, pentapeptides, etc., c) amino acids and derivatives thereof, such L-cysteine, hydrochlorides of amino acids such a cysteine or cysteine, d) NAC-odor control agents aids for reducing the odor of NAC, typically in water as a solvent, e) solvents such as glycerine, propane diol, ethyoxydiglycol, propylene glycol, etc., f) emulsifiers or stabilizers such as laureth-23, g) skin care agents such as hyaluronic acid, and so forth. Vitamin C serums are of particular interest, but face difficulty due to the tendency for Vitamin C to oxidize if the pH is too high or its difficulty in penetrating the skin. It is believed that the NAC in combination with panthenol and/or skin permeability enhancers such as propane diol may be able to enhance Vitamin C serums through NAC's antioxidant and pH-lowering capacity, and serums based on NAC in combination with Vitamin C appear to have proven effective in initial testing in terms of the effect on wrinkles, though more extensive testing will be helpful. In some aspects, such serums are substantially free of acrylamide compounds such as polyacrylamide and particularly crosslinked polyacrylamide, which can break down into acrylamide, a carcinogen.

Serums may be substantially free of silicone compounds or lipids, or may have relatively small amounts such as less than 10%, 9%, 7%, 5%, 3%, 2%, or 1% combined of lipids and silicones, or of lipids alone or silicones alone. Serums may comprise at least 40%, 50%, 60%, 70%, or 80% water, and may comprise from 0.5% to 5% of an NAC odor control agent, which alternatively may have a mass ratio relative to NAC of 0.15 to 3, 0.2 to 2, 0.2 to 1, 0.25 to 1.5, 0.2 to 1.3, or from 0.3 to 1.1.

### Oral Care Products

For biofilm control, combinations of NAC with other biofilm attack agents or enhancers can be effective, such as the combination of NAC with EGCG and/or panthenol and/or lysozymes or other suitable enzymes, optionally coupled with odor control agents to mitigate the sulfurous odor that can characterize NAC solutions. In particular, without wishing to be bound by theory, we have found benefits with a variety of compounds that may be able to interact with the sulfur groups of NAC or its oxidation products. Agents that may be useful in reducing the negative perception of odor and/or taste may include compounds with phosphonium ions such as hexametaphosphate salts, sultaine derivatives such as hydroxysultaines; betaine compounds such as cocoa betaine; quaternary ammonium compounds; etc.

Films that can be dissolved in the mouth for oral care can also be formulated with NAC optionally coupled with a NAC-odor control agent such as sodium hexametaphosphate (SHMP), and with flavoring agents that most effectively cover the taste and/or odor of NAC such as citrus extract, including sweet orange or other orange extract, lemon-lime, lime, mint, etc. The same applies to toothpaste formulations, which may use SHMP or other NAC-odor control agents at concentrations similar to those of NAC, such that the NAC-odor control agent/NAC ratio on a weight basis is from 0.3 to 3, 0.5 to 2, or 0.6 to 1.6. For example, a toothpaste, mouthwash, or film may comprise from 0.1% to 2% NAC, and the NAC-odor control agent may be within ±50% of the NAC concentration.

### Cleaning Products

It has been discovered that biofilm on a variety of surfaces, including clothing, textiles, and hard surfaces such as those in bathrooms and kitchens, can be weakened, reduced, or largely with the assisting biofilm attack agents such as N-acetyl cysteine in combination with other agents such as enzymes and/or surfactants. For mitigating “perma-odor” in clothing, especially in synthetic fabrics and sports apparel, biofilm attack agents coupled with enzymes can be applied for an effective period of time, followed laundering with a laundry detergent, treatment with other soaps and detergents, or simply rinsing with water. Biofilm attack agents such as N-acetyl cysteine or N-acetyl cysteine combined with panthenol or derivatives thereof may be provided in a solution, either with enzymes or in a separate container, or provided at least partially in solid form such as a capsule, a powder, a tablet, a stick, etc., to be dissolved in a solution before, after or during application to an item.

In describing various versions and aspects of the methods and products disclosed herein, it should be understood that the elements, steps, features, etc. of any version or aspect are combinable with any other version or aspect or collection of versions and aspects unless stated otherwise or clearly unsuitable.

Thus, in one aspect, a method is provided for treating a solid material with biofilm attack agents in combination with cleaning agents such as enzymes and/or surfactants. The solid material can be a fibrous material including textiles, items of clothing, woven and nonwoven materials or combinations thereof, etc., or hard surfaces such as surfaces of a toilet, sink, floor, shower stall, drains, faucets, refrigerators, light switches, walls, medical equipment, water fountains, food and drink dispensers, cutting boards, cutlery and utensils in a kitchen, wherein the material is suspected of having microbial biofilm matter, or used in an environment or application at risk of developing biofilm and/or persistent odor, the method comprising applying an enzymatic composition to the one or more regions of the solid material, providing suitable time for the enzymatic mixture to attack biofilm, and then washing the textile item, wherein the enzymatic composition comprises: (a) water, (b) from 5% to 60% of a surfactant, (c) from 1% to 20% of an enzyme mixture comprising at least two of lysozyme, proteinase, amylase, mannanase, lipase, pectinase, DNAse and cellulase; and (d) from 0.1% to 10% of N-acetyl cysteine. The enzymatic composition in some aspects is packaged with indicia instructing a user to wait at least 5, 10, 15, or 30 minutes between applying the enzymatic composition and washing the textile, wherein washing generally comprises washing in water with a laundry detergent but may comprise rinsing without use of further detergents.

### Further Details

Other ingredients may be present in the acidic sticks described herein, including Vitamin C derivatives such as sodium ascorbyl phosphate, magnesium ascorbyl phosphate, or other ascorbyl phosphate salts, and the Vitamin C compounds and other ingredients listed in US RE38623, US Appl. No. US20070172436A1, US Patent App. No. 20180071205, “Stable Vitamin C System,” published Mar. 15, 2018 by J. Disalvo. U.S. Pat. Nos. 4,647,672 and 5,149,829 describe stable, 2-polyphosphorylated species of L-ascorbic acid and its stereoisomers. The ascorbate 2-polyphosphate esters and other esters of Vitamin C, such as ascorbyl palmitate, ascorbyl dipalmitate, ascorbyl stearate, and other fatty acid or fatty alcohol esters, etc., may be considered for use herein.

### EXAMPLES

Solution Y1 was made by combining 0.72 g of sodium hexametaphosphate (SHMP) powder with 2.45 g of NAC powder and 15 ml of water. Solution Y2 was made according to the same formula but with 0.73 g of sodium citrate replacing the SHMP. After sitting covered overnight, the odors were compared. Y2 exhibited a strong sulfurous odor, while the odor of Y1 was greatly reduced.

A solution was made with 98 g water, 4.26 g NAC, and 2.955 g NaHCO₃ at a pH of 4.0. This was split equally between two jars labeled O1 and O2. In 02, 1.00 g of SHMP was added, giving a pH of 4.3. Testing from two parties confirmed that the odor in O2 was significantly less than in O1. Solution Y1 was then combined with two hand sanitizers to evaluate product odor and remaining odor on the hands. In one example, 23.5 g of Everyone™ Hand Sanitizer Spray, lavender and aloe, was combined with 1.00 g of solution Y1. In spite of the significant NAC content, the product had no discernible sulfurous or NAC-like odor, neither in the spray bottle or on the hands after spraying or after allowing the spray to dry. This route has the potential to deliver the benefits of NAC to the skin without noticeable malodor.

In another example, 1.00 g of solution Y1 was combined with 4.2 g of an alcohol-gel hand sanitizer. While the viscosity of the gel was significantly reduced, the result was still reasonably viscous and pleasing to use. While the gel lacked any noteworthy fragrance, with the large amount of added NAC there was still no clear sulfur smell. SHMP as an NAC-odor control agent may be especially useful.

Several enzymatic solutions were described above, including enzymatic blend labeled E1, E2, E3, E4C, E6C, E6D, E6D2, an PANNAC. In Example C1, a toilet in the house of a large family had recurring biofilm, both with a red color bacteria at the water line in the bowl and apparently a black mold or mildew under the water line. The water level was lowered and the left side of the toilet bowl was wetted with sprays of the PANNAC solution, about 0.6 g applied, allowed to sit for 5 minutes, and then E6D was sprayed across both sides of the toilet bowl and again allowed to sit for about 5 minutes. One fourth of the toilet bowl area (representing roughly the regions associated with a clock at 12, 1, and 9 o′clock) were scrubbed with a melamine foam pad (Magic Eraser®) and the entire toilet bowl was scrubbed with a conventional bristle toilet brush. Ten days later, when the biofilm material would normally have long been entrenched again, the toilet seemed relatively clear, but a few days after that, signs of the biofilm recurred, with extensive biofilm on the right side of the toilet bowl that had been treated with the enzymatic cleaner alone, while the left side was largely free of biofilm except some at the 9 o'clock position (which had been scrubbed with melamine foam). The results suggest that the PANNAC material may have assisted in undermining the biofilm. Several days later, though, the biofilm was back across most of the toilet bowl. In a second treatment, the bowl was drained and NAC powder was sprinkled over the biofilm material. Then dishwashing detergent was applied to the left side and enzymatic toilet cleaner to the right side. After 5 minutes, the bowl was scrubbed with melamine foam, including under the toilet rim where biofilm could be seen, and rinsed.

Example C2. A bathroom sink showed signs of a dark biofilm on the metal ring around the drain. Scrubbing with a coarse pad or melamine pad had little effect. One spray of PANNAC solution was applied to the left side of the ring and 3 sprays of E6D (one spray is about 0.15 g) were applied to the entire ring and allowed to sit for 5 minutes. A melamine pad was then applied to the ring and the biofilm came off readily. It is believed that the PANNAC material had spread around the ring prior to scrubbing. A second sink in the bathroom was resistant to cleaning a similar biofilm ring with a melamine foam pad alone. Some progress occurred after applying E6D for 10 minutes, but more complete cleaning occurred after a second treatment of E4D with a 2 minutes wait before using the melamine pad again.

### Stability and Efficacy of NAC+Enzymes

Testing with combined enzymes and NAC began with a combination of 0.725 g panthenol, 2175 g NAC, 3.4 g water, and taking 1.32 g of the resulting solution and blending it into 22 g of E7C and further adding 0.5 g NaHCO₃ and 2.03 g EBD. This mix is LPN1. Then 2.00 g panthenol, 6.02 g NAC, 6.5 g water and 3.0 g NaHCO₃ were combined and 6.5 g water. After heating and loss of carbon dioxide formed, the mass was 17.5 with 34.4% NAC and the solution was labeled as PNC3. 3.0 g of PNC3 were then combined with 22 g of E7C giving about 1% NAC in the composition, labeled as LPN2. Then 21.6 g of E6C was combined with 2.93 g PNC3 and labeled as LPN3. These mixes would be compared to the original E6C and E7C solutions during extended thermal stability testing at 40° C. for 1, 2, and 3 months. Testing of enzyme activity was done for lipase, protease, and amylase and revealed that LNP and LNP2 had excellent stability, while LPN3 eventually became highly viscous, possibly due to NAC-enzyme interactions at too high a concentration

Measurement of enzyme efficacy was done using pre-stained fabrics purchased from Testfabrics, Inc. (West Pittston, Del.), TestFabrics.com. Protease efficacy was tested using the fabric CFT C-S-101, a cotton fabric stained with dried bovine blood. Amylase was tested using fabric CFT C-S-29, a cotton fabric stained with an orange-colored tapioca starch. Lipase efficacy was tested using fabric CFT P-02, a polyester fabric stained with olive oil and carbon black. In general, testing involved preparing regular sections of the stained cloth, 1 inches by 2 inches, and applying an amount of the enzyme to moisten the cloth and allow it to sit for a fixed period of time at room temperature, followed by immersion of the cloth sections into water for another fixed period of time, and then blotting and allowing the samples to dry, after which the color intensity was measured with a colorimeter. The more effective the enzyme, the more of the stain was removed and the brighter/whiter the fabric sample. The colorimeter was an AMTAST Model AMT599 AMTAST Colorimeter (8MM) sold by Amtast (Lakeland, Fla.). In making measurements, the meter was moved in a regular pattern over cloth samples to make a series of at least 3 measurements that were averaged. Measurements were reported in the L-a-b system, with the lightness value, L, being of most use in the measurements.

For the blood stained cloth, it was necessary to first “set” the blood stain by immersion in hot water to reduce the ability of the blood to diffuse away in water without enzymatic attack. A constant temperature hot water bath was used, set to 65.4° C., and each test sample was first immersed for 5 seconds and then withdrawn and immediately dipped into room temperature water for 5 minutes, then blotted.

About 0.7 g of enzyme solution was applied to each sample, typically enough to wick into the sample and wet all or nearly all the cloth. For the first series of tests after 30 days of aging at 40° C., each sample after application of the enzyme solution was allowed to sit for 15 minutes at room temperature (about 22° C.), and was then immersed into a clean tub of water at 21° C. to soak for 10 minutes. The sample was then withdrawn after a gentle shake under the water and allowed to dry and then L-a-b measurements were recorded on multiple spots to obtain a representative average. Then lipase testing was done in the same manner with the olive oil stained cloth and the orange stained cloth, but without a need for heat treatment.

Results from initial protease testing of the blood stained cloth follow in Table 1, where solution 4 is the control, water; 5 is fresh E6D that was not thermally aged and has been fully diluted (3 parts water to 1 part E6C); 6 is aged LPN3, the solution of NAC and E6C; 7 is aged LPN2, the mixture of NAC and E7C; 8 is aged E6C; 9 is aged E7C, and 10 is aged LPN1, a mix of NAC and E7C and EBD. Note that the thermal aging was done to concentrates, but for the testing, a portion of the concentrate was diluted to normal strength (1 part concentrate to 3 parts water) prior to application to the stained cloth. For these early results, the thermal treatment was at a higher temperature than the standard protocol used hereafter and with less uniformity, resulting in stain that was somewhat harder to remove. A surprising outcome in is that LPN2 resulted in a higher brightness gain and thus better removal of blood due to protease activity than the fresh or aged enzymatic mixes themselves.

TABLE 1
Protease testing for aged (30 days,
40° C.) and fresh enzymatic mixes.

| Solution: | 4 | 5 | 6 | 7 | 8 | 9 | 10 |
|---|---|---|---|---|---|---|---|
| Mean L* | 48.66 | 64.41 | 64.14 | 66.18 | 61.55 | 60.78 | 59.62 |
| Mean a* | 15.28 | 8.99 | 8.54 | 8.31 | 9.76 | 9.90 | 9.33 |
| Mean a* | 12.55 | 11.37 | 10.50 | 11.09 | 10.67 | 10.94 | 10.67 |
| Sample st. dev. | 0.42 | 0.55 | 0.58 | 0.50 | 1.10 | 0.22 | 0.78 |
| Conf. int., L* | 0.42 | 0.44 | 0.47 | 0.40 | 0.81 | 0.18 | 0.58 |
| N (# of msrmts) | 4 | 6 | 6 | 6 | 7 | 6 | 7 |

Further protease test results with the proper heat set procedure are shown in Table 2, where Solution 13 is fresh E6D, 14 is aged E6C, 15 is aged E7C, 16 is aged LPN3, 17 is aged LPN1, and 18 is aged LPN2. Again LPN2 outperforms the equally aged enzymatic mixes, and here the other NAC-containing mixtures also perform well. The ability of NAC combined with an enzyme to improve its performance rather than degrade it is surprising. and suggests that NAC-protein mixtures, when properly formulated, may have the potential to have improved thermal stability relative to similar compositions without NAC, a highly unexpected finding. Thus, there may be potential for improving the shelf stability or overall performance of a variety of enzyme products, including stain removers, prespotters, laundry detergents, enzymatic cleaners, and other products through the use of a suitable amount of NAC.

TABLE 2
Protease testing for aged (30 days,
40° C.) and fresh enzymatic mixes.

| Solution | 13 | 14 | 15 | 16 | 17 | 18 |
|---|---|---|---|---|---|---|
| Mean L* | 73.59 | 68.49 | 67.33 | 68.54 | 67.62 | 69.10 |
| Sample st. dev. | 0.23 | 0.98 | 0.40 | 0.82 | 1.50 | 0.65 |
| Conf. int., L | 0.23 | 0.96 | 0.39 | 0.80 | 1.47 | 0.64 |
| N | 4 | 4 | 4 | 4 | 4 | 4 |

Similar results were obtained with testing for lipase and amylase efficacy after 30 days, and similar results were also found after 60 days of testing for all 3 enzymes tests based on the removal of stains from prestained fabrics. For testing of lipase based on the olive oil +carbon black stained cloth, results after 30 days of thermal aging were:

TABLE 3
Lipase testing for aged (30 days, 40° C.) and fresh enzymatic mixes

| Solution | Mean L* | Conf. int. |
|---|---|---|
| Control, water | 56.83 | 0.4 |
| Fresh E6D | 60.67 | 0.4 |
| Aged E7D | 59.8 | 0.36 |
| LPN1, aged | 59.74 | 0.25 |
| Fresh E6D | 60.63 | 0.27 |
| Aged E7D | 60.45 | 0.63 |
| LPN1, aged | 59.55 | 0.21 |
| Aged E6D | 59.82 | 0.55 |
| LPN3, aged | 60.02 | 0.23 |
| LPN2, aged | 60.61 | 1.18 |
| Untreated | 56.59 | 0.28 |

Amylase testing was done on 1.5 in by 2 in sections of cloth. Comparing the efficacy of the aged enzymes to that of the E6D enzyme that had not been thermally, all aged enzymatic mixes experienced a drop in performance as shown in Table 3:

TABLE 3
Loss in amylase efficacy for aged enzyme mixes relative to unaged E6D

| LPN1 | LPN2 | LPN3 | E6C | E7C |
|---|---|---|---|---|
| 7.59% | 4.62% | 5.45% | 16.52% | 14.24% |

Thus while the thermal aging decreases amylase efficacy in all samples, those with NAC fared better than those without, again a surprising finding pointing to the potential of NAC-protein combinations for enhanced thermal stability or increased shelf life for low concentrations of NAC (e.g., about 6% or less, 5% or less, 4% or less, 3% or less, or 2% or less, such as from 0.03% to 3% or 0.05% to 1.5%) in a variety of enzymes and perhaps other protein systems in industry and life sciences.

In any case, the possibility clearly exists that NAC can be prepared in solution with laundry enzymes without decreasing their efficacy, and in some cases, may even improve enzyme performance. Thus, it is believed that a variety of the solutions proposed herein, including one- and two-step laundry treatment systems, enhanced laundry detergents, enzymatic cleaners and biofilm removal aids for solid surfaces such as walls, bathroom fixtures, kitchens, etc., may have excellent shelf stability for reasons that go beyond NAC's antimicrobial capabilities.

### COSMETIC EXAMPLES

The ingredients mentioned below were generally drawn from the following:
Acrylate copolymer, CAS #129702-02-09, acrylate octylacrylamide copolymer: Making Cosmetics, Inc., Redmond, Wash.
almond oil: Formulator Sample Shop, Iron Station, N.C.
aluminum chlorohydrate powder: Formulator Sample Shop, Iron Station, N.C.
Aminosyl™ L30: sodium lauroyl sarcosinate, Jarchem Industries, Newark, N.J.
Aminosyl™ SCG: sodium cocoyl glutamate, Jarchem Industries, Newark, N.J.
arrowroot starch: Bob's Red Mill, Milwaukie, Oreg.
beeswax: Sky Organics, Delray Beach, FLUORESCENT
behenyl alcohol: Formulator Sample Shop, Iron Station, N.C.
Bentone Gel GTCC V (a gel-making compound comprising pre-dispersed modified hectorite clay in an oleophilic base; INCI name is caprylicc triglyceride and stearalkonium hectorite and propylene carbonate): Elementis, East Windsor, N.J.
C26-28 alkyl dimethicone (Botanisil AD-1): DDChemco, Chatsworth, Calif.
cacao butter: Cacao Butter Wafers, Terrasoul Foods, Fort Worth, Tex.
caffeine: 200 mg capsules, Bulk Supplements, Henderson, Nev.
candelilla wax: TKB Trading, Oakland, Calif.
caprylyl dimethicone (Botanisil CPM-10): DDChemco, Chatsworth, Calif.
caprylic capric triglycerides MCT: Formulator Sample Shop, Iron Station, N.C.
castor wax (hydrogenated castor oil): Health and Beauty Oils Center, Ebay.com
cetyl alcohol: Formulator Sample Shop, Iron Station, N.C.
cocoamidopropyl hydroxysultaine: Making Cosmetics, Inc., Redmond, Wash. (a liquid surfactant used in some baby shampoos due to its gentleness)
coconut oil : LouAna Coconut Oil, Ventura Foods, Brea, Calif.
corn starch: Hodgson Mill, Effingham, Ill.
CreamMaker® Behenyl: Making Cosmetics, Snoqualmie, Wash.
cyclopentasiloxane: TKB Trading, Oakland, Calif.
dimethicone and dimethicone/vinyl dimethicone copolymer (Lotioncrafter EL61): Lotioncrafter, Eastsound, Wash.
DM6 dimethicone (dimethicone with a viscosity of 6 cst): Lotioncrafter, Eastsound, Wash.
DM350 dimethicone (dimethicone with a viscosity of 350 cst): Lotioncrafter, Eastsound, Wash.
diphenyl siloxy phenyltrimethicone (Lotioncrafter LC1550): Lotioncrafter, Eastsound, Wash.
ECOMulse™ (an emulsifier made from glyceryl stearate, cetostearyl alcohol and sodium stearoyl lactylate): Lotioncrafter, Eastsound, Wash.
Ecosil (Fision® EcoSil from Tri-K, a naturally derived blend of hydrogenated ethylhexyl olivate and hydrogenated olive oil unsaponifiables): Formulator Sample Shop, Iron Station, N.C.
Ectoin: IDA Skincare Products Lab, China
emulsifying wax: Milliard® Emulsifying Wax (cetostearyl alcohol and polysorbate 60), Milliard Brands, Lakewood, N.J. (unless otherwise specified, “emulsifying wax” refers to this product)
ethoxydiglycol: Making Cosmetics, Snoqualmie, Wash.
ethylhexyl palmiate: Making Cosmetics, Snoqualmie, Wash.
FSS Sensolv (isoamyl laurate): Formulator Sample Shop, Iron Station, N.C.
GLDA: Tetrasodium Glutamate Diacetate, Jarchem Industries, Newark, N.J.
Hyaluronic acid: SMLW (super-low mol. wt., 8,000-15,000 Daltons) hyaluronic acid, Making Cosmetics, Snoqualmie, Wash.
hydroxpropylcocoate PEG-8 dimethicone (Botanisil TE-3): DDChemco, Chatsworth, Calif.
jojoba oil: Shaoxi Fanglio Studio (Plant Lab), China
Kostol PGP (an emulsifying wax comprising polyglyceryl-3 stearate, beheneth-5): Koster Keunen, Watertown, Conn.
laponite powder: Laponite XL21, BYK USA, Inc., Gonzales, Tex.
lauryl laurate: TKB Trading, Oakland, Calif.
Leucidal SF Max preservative, Formulator Sample Shop, Iron Station, N.C.
lip stick base: TKB Trading, Oakland, Calif. (a mixture of castor seed oil, cetyl stearyl alcohol, olive fruit oil, beeswax, hydrogenated castor oil, glycine soybean lipids, lauryl laurate, carnauba wax, candelilla wax)
magnesium myristate: TKB Trading, Oakland, Calif.
magnesium stearate: MarkNature, location unknown
Olivem 1000 (cetearyl olivate +sorbitan olivate): Hallstar Beauty (Chicago, Ill.).
mandelic acid powder: Pure Health Botanicals, St. Charles, Ill.
panthenol (vitamin B5): L′eternal World LLC, Aurora, Ohio
palmitic acid 98%, Acme-Hardesty, Blue Bell, Pa.
PEG-8 beeswax (esterification of the free fatty acids of beeswax with polyethylene glycol): Koster Keunen, Watertown, Conn.
polyethylene wax: Making Cosmetics, Snoqualmie, Wash.
polymethylsilsesquioxane (Botanisl SP-360): DDChemco, Chatsworth, Calif.
1-3 propanediol (hereafter simply pronanediol): Formulator Sample Shop, Iron Station, N.C.
propylene glycol: Earthborn Elements, American Fork, Utah
shea butter (unrefined): TKB Trading, Oakland, Calif.
Softisan: FSS Softisan 378, Formulator Sample Shop, Iron Station, N.C. (this material is a lanolin-like material made from a blend of triglycerides based on saturated even-numbered, unbranched natural fatty acids of vegetable origin)
soluble starch, product IS28205, CAS #9005-84-9, Aldon Corp., Avon, N.Y.
stearyl alcohol: Alcohol 1989 NF Pastilles, Acme-Hardesty, Blue Bell, Pa.
sunflower wax: Making Cosmetics, Snoqualmie, Wash.
Synkos 2050 wax: Koster Keunen, Waterford, Conn.
tapioca starch: Erawan Marketing Co., Bangkok, Thailand
TKB gelmaker CC: TKB Trading, Oakland, Calif. (this material is a blend of dicaprylyl carbonate, stearalkonium hectorite and propylene carbonate, and is used to create gels)
Vitamin C, buffered powder: Pure Encapsulations (Sudbury, Mass.)
Vitamin C, pure powder: Resurrection Beauty, Holmen, Wis.
water is distilled water unless otherwise specified
xanthan gum: Carrington Farms, Closter, N.J.
zinc stearate: TKB Trading, Oakland, Calif.

Any of these ingredients or those described elsewhere herein can be considered for addition in suitable quantities to anything considered herein.

Unless otherwise stated, the cosmetic stick compositions described below were made in a double boiler constructed by using a muffin baking pan with 4×3 muffin wells and external dimensions at the rim of about 13.9 inches×10.6 inches and a well depth of about 1.2 inches and a well diameter of about 2.75 inches. The muffin pan could fit snugly within a large Wilton® baking pan having internal dimensions near the top of the slightly tapered pan of about 14.4 inches×10.8 inches×2 inches. During formulation work, the baking pan was placed on a gas stove covering two burners, then filled with water to a depth that allowed the muffin pan to float. The burners could then be turned on to bring the water to a suitable temperature for melting wax and other components in one or more of the wells. The muffin pan came with a detached well that had not been welded to the main pan, a manufacturing defect that provided additional convenience since the loose well could serve as a convenient weighing pan and could, when needed, be placed directly inside one of the other wells to melt and mix ingredients, after which the contents could be weighed if desired to see, for example, how much moisture may have evaporated. The open well port allowed an easy way to add water conveniently or to preheat utensils such as whisks or spoons.

Illustrative runs made with significant antiperspirant content are shown in runs P1—P4 below and later in runs P5—P9. For runs P1—P4, ingredients added to the oil-silicone phase are shown in Table 1A, including the “water phase add (addition),” which states how much of the acid paste for each run was combined with the oil-silicone phase. The respective acid paste composition is shown in Table 1B. The overall composition of the final stick is shown in Table 1C.

TABLE 1A
Several antiperspirant runs with oil-silicone phases.

| Run: | P1 | P2 | P3 | P4 |
|---|---|---|---|---|
| Oil phase + silicone phase | | | | |
| aluminum chlorohydrate | 5.5 | 4.2 | 5.03 | 3.994 |
| arrowroot starch | 2 | 3.56 | 3.56 | 4.15 |
| behenyl alcohol | | | 1.03 | |
| Bentone Gel GTCC V | 1.608 | 1.77 | | |
| C26-28 alkyl dimethicone | 1.302 | 1.56 | 1.06 | 1.13 |
| cacao butter | | | | 0.45 |
| caprylyl dimethicone | 1.949 | 0.12 | 1.55 | 0.90 |
| CreamMaker ® Behenyl | | | | 0.69 |
| DM6 dimethicone | 6.03 | 6.63 | 3.93 | 2.28 |
| DM350 dimethicone | 0.85 | 0.94 | 1.72 | 1.00 |

TABLE 1B
Acid paste compositions corresponding to the “acid paste
addition” listed in Table 1A.

| Water Phase | | | | |
|---|---|---|---|---|
| Composition | AP21 | AP29 | AP30 | AP31 |
| Water | | 10.25 | 2.46 | 0.30 |
| Tapioca Starch | | | 0.00 | |
| Mandelic Acid | 8.89 | 6.90 | 1.65 | 2.80 |
| NAC | | 3.34 | 0.80 | 2.00 |
| Glycerin | | | 0.00 | |
| Propane(1,3)diol | 20.28 | 4.14 | 0.99 | 5.30 |
| Propylene glycol | | | 0.00 | |
| Caffeine | 0.00 | | 0.00 | |
| NaOH | 0.00 | 0.26 | 0.06 | |
| Alum. Chlorohydrate | | 3.90 | 0.93 | |
| Allantoin | | | 0.37 | |
| GLDA | | | 0.13 | |
| Cocoamido Hyd. | | | 1.59 | 0.47 |
| Sultaine | | | | |
| Initial mass: | 29.18 | 28.79 | 8.99 | 10.87 |
| Ecosil | | | 1.446 | |
| Gelmaker CC | | | 1.15 | 0.67 |
| isoamyl laurate (Sensolv) | 4.083 | 4.326 | 1.737 | 2.489 |
| Jojoba oil | | | 1.526 | 0.455 |
| Kostol PGP | 0.216 | 0.409 | 0.518 | |
| panthenol | 0.251 | | 0.15 | 0.217 |
| polyethylene wax | | | | 2.143 |
| polymethylsilsesquioxane (SP-360) | 2.896 | 2.547 | 2.12 | 2.54 |
| squalane | | | 0.26 | 0.15 |
| stearyl alcohol | 2.5 | 1.3 | 3.23 | 2.076 |
| Synkos 2050 wax | 8 | 7.59 | 5.261 | 3.686 |
| Acid paste addition: | 7 | 3.95 | 7.17 | 6.05 |
| Water correction (est. evap. loss) | 0 | | 0.1 | 0.05 |
| Total mass (g): | 44.19 | 38.91 | 42.34 | 35.02 |

TABLE 1C
Overall percentage of ingredients in final sticks.

| Summary of Key | | | | |
|---|---|---|---|---|
| Components: | P1 | P2 | P3 | P4 |
| Aluminum chlorohydrate %: | 12.4% | 12.2% | 13.6% | 11.4% |
| Caffeine %: | 0.00% | 0.00% | 0.00% | 0.00% |
| Mandelic acid %: | 4.83% | 2.43% | 3.12% | 4.45% |
| Silicone compounds %: | 29.5% | 30.3% | 24.5% | 22.4% |
| Synthetitc wax %: | 18.1% | 19.5% | 12.4% | 16.6% |
| Starch %: | 4.53% | 9.15% | 8.41% | 11.8% |
| Water %: | 0.00% | 3.61% | 4.39% | 0.33% |
| Glycerin %: | 0.00% | 0.00% | 0.00% | 0.00% |
| Esters (with triglycerides) %: | 9.2% | 11.1% | 11.7% | 10.1% |
| Fatty alcohols & acids %: | 5.66% | 3.34% | 10.1% | 5.9% |
| NAC: | 0.00% | 1.18% | 1.51% | 3.18% |
| Diol/glycol %: | 11.0% | 1.46% | 1.87% | 8.42% |
| NaOH: | 0.00% | 0.09% | 0.12% | 0.00% |
| Gelling agents, emulsifiers: | 4.13% | 5.60% | 3.94% | 3.88% |
| Panthenol: | 0.57% | 0.00% | 0.35% | 0.62% |
| Allantoin | | 0.00% | 0.70% | 0.00% |
| GLDA | | 0.00% | 0.24% | 0.00% |
| Hydroxysultaine | | | 3.00% | 0.75% |
| Total: | 100% | 100% | 100% | 100% |
| pH: | 3.9 | 3.8 | 3.5 | 3.7 |

After pouring into round deodorant molds, it was observed that the solid sticks had a good feel and a uniform texture. Sticks P1 and P2 were tested on human underarm skin without irritation and no sense of grittiness. The hardness of stick AP2 was measured using an AMS 59032 E-280 Pocket Penetrometer, measured by increasing the applied pressure slowly as the tip engaged the wax until there was a sudden breakthrough and then reading the peak pressure indicated by a movable rubber ring. The units are in kg/sq. cm or tons/sq foot (1 kg/sq cm =1.02 tons/sq foot). A hardness of 1.25 was recorded.

Observations on Reducing the Odor of NAC. These sticks were tested in human use to various degrees. Stick P4 had a noticeable unpleasant smell, apparently due to NAC perhaps particularly in combination with lavender. Stick P3 had no readily detected odor from the NAC, even though one of the more malodorous versions of NAC found on the market was used. Without wishing to be bound by theory, it is proposed that the cocoimidopropyl hydroxysultaine interacted with the NAC, possibly via its amido group, to capture sulfurous impurities or reduce oxidation of NAC to reduce the production of sulfurous odorants over time. After storage for several weeks there was no apparent sulfur smell in the product.

The reason cocoimidopropyl hydroxysultaine was employed in this NAC-containing deodorant was that in trials of odor suppression conducted in Appleton, Wisconsin in support of this investigation, a variety of household products were combined with a relatively strong-smelling NAC solution at 5% concentration, and the mixtures were then examined for odor response. A mixture with an HONEST™ brand baby shampoo containing a large percentage of cocoimidopropyl hydroxysultaine was observed to have an unusually low odor of NAC odor, and thus it was hypothesized that cocoimidopropyl hydroxysultaine and other sultaine compounds may be effective in reducing NAC odor. The particular mixture had 21 ml of water, 1.08 g of NAC, and 2.3 g of Honest Shampoo and Body Wash. Cocamidopropyl hydroxsultaine was the first ingredient after water. It also contained a significant amount of sodium methyl cocoyl taurate. Pure cocoimidopropyl hydroxysultaine was then obtained for runs using it as an ingredient in a deodorant stick. It was also tested at 2% concentration in a 6% NAC solution and appeared to have low NAC odor immediately and still after several days.

Other compounds with amidoalkyl groups of quaternary ammonia groups or both may also be considered for such functions, including lauramidopropyl betaine, cocamidopropyl betaine, other betaine compounds and other sultaine compounds such as lauramidopropyl hydroxysultaine, oleamidopropyl hydroxysultaine, tallowamidopropyl hydroxysultaine, erucamidopropyl hydroxysultaine, lauryl hydroxysultaine, etc. Sodium methyl cocoyl taurate, especially when dispersed in a water phase or in an oil/water emulsion, also may have a helpful role in suppressing NAC odor, and was also tested in some runs described below. In one test, 0.5 g of sodium methyl cocoyl taurate was dispersed in about 20 ml of water comprising 3 g of dissolved NAC and 1 g of cocoamidopropyl hydroxsultaine. After dispersion, the mixture had some bubbles over the solution surface, but these gradually dissipated. Odor reduction of the mix was not as effective as with EDTA, however, and, without wishing to be bound by theory, it may be that the taurate interfered with the cocoamidopropyl hydroxsultaine in suppressing the odor.

Similar tests of various agents blended into NAC solutions at concentrations of 3 to 10% suggest that the following may also be useful in reducing odor, again possibly because of interaction with nitrogen groups in the compounds: GLDA, panthenol, ectoin, sarcosinates such as sodium lauroyl sarcosinate, EDTA, and urea. In some tests, it appeared that calcium ions or compounds such as calcium phosphate could be helpful. For example, 1.0 g of EDTA was combined with 1 g of NAC in 50 ml of water and exhibited low odor. After several weeks, the solution had evaporated to give concentrated NAC solution with significant crystal formation, and still in this concentrated form the NAC odor appeared greatly reduced. Combinations of EDTA, GLDA, sultaines, betaines, taurates, ectoin, sarcosiates, and the like may result in enhanced odor control, particularly as a function of pH. Of course, using higher-grade NAC such as pharmaceutical grade with low initial odor can also be helpful as a strategy in reducing odor in NAC-containing products. Odor can also be masked to some degree with suitable fragrances or essential oils, but there is a need for more effective means to reduce odor release or formation rather than masking it. In a further test, 8.12 g from stick P4 were removed and melted again, then combined with 0.111 g of sodium hexametaphosphate that had been dissolved in 0.329 ml of water, with 0.83 g cacao butter added to help compensate for the added water content. After thorough mixing, the mass was cooled and kept covered, then its odor compared to the original stick P4, showing good but not complete reduction.

TABLE 2A
Further antiperspirant runs with oil-silicone phases.

| Run: | P5 | P6 | P7 | P8 | P9 |
|---|---|---|---|---|---|
| Oil phase + silicone phase | | | | | |
| Almond oil | | | | 1.691 | |
| Aluminum chlorohydrate | 7.33 | 5.18 | 6.276 | 6.24 | 4.7 |
| AqStar M1 ® | 0.351 | | 0.821 | 0.255 | |
| Arrowroot starch | 5 | 3.54 | 3.5 | 1.62 | 4.03 |
| Bentone Gel GTCC V | | 0.90 | 0.90 | 0.80 | 1.20 |
| C26-28 alkyl dimethicone | 0.33 | | | 0.78 | 1.14 |
| Cacao butter | 2.25 | 1.50 | 1.51 | | 2.62 |
| Caprylyl dimethicone | 1.53 | 0.72 | 0.72 | 0.64 | 0.96 |
| DM6 dimethicone | 3.89 | 3.59 | 3.61 | 3.22 | 4.81 |
| DM350 dimethicone | 1.70 | 1.49 | 1.49 | 1.33 | 1.99 |
| Ethylhexyl palmiate | | | | 1.687 | |
| Gelmaker CC | 1.14 | | | | |
| GLDA | 0.66 | 0.56 | 0.29 | | 1.11 |
| Isoamyl laurate | 3.56 | 4.58 | 4.606 | 1.39 | 4.665 |
| Jojoba oil | 1.065 | 0.28 | 0.28 | 1.32 | |
| Kostol PGP | 0.419 | 0.33 | 0.335 | 0.356 | 0.343 |
| Olivem 1000 | | | | 1.988 | 0.833 |
| Panthenol | 0.279 | 0.198 | 0.224 | | |
| Pea starch | | | | 2.63 | |
| Polymethylsilsesquioxane | 4.00 | 2.345 | 2.795 | 2.19 | 2.84 |
| Sodium cocoyl glutamate | 1.276 | | | | |
| Sodium methyl cocoyl | 1.59 | 3.2 | 3.412 | | |
| taurate | | | | | |
| Squalane | 0.26 | | | | |
| Stearic acid | | 0.756 | | | |
| Stearyl alcohol | 4.06 | 2.55 | 3.323 | 3.66 | 2.436 |
| Synkos 2050 wax | 4.74 | 5.04 | 5.16 | 5.166 | |
| Water phase addition: | 4.57 | 5.00 | 4.16 | 5.17 | 7.51 |
| Water correction (est. | 0.1 | 0.1 | | | |
| evap. loss) | | | | | |
| Total mass (g): | 49.90 | 41.65 | 43.42 | 42.14 | 41.19 |

Good results, with reasonable stability and good texture of the solid material, were obtained in these runs except for Run P6, where upon addition of the powders at the end (starch, antiperspirant material and polymethylsilsesquioxane), there was large-scale agglomeration and instability, making it impractical to even fill a deodorant barrel. It was speculated that the presence of stearic acid and/or the absence of the cucurbituril emulsifier, AqDot's AqStar M1®, may have contributed to the instability. Run P9 was similar but instead of AqStar M1® had added Olivem 1000® emulsifier and also exhibited excellent stability and good tactile properties

TABLE 2B
Acid paste compositions corresponding to the “acid
paste addition” listed in Table 2A.

| Water Phase | | | | | |
|---|---|---|---|---|---|
| Composition | AP32 | AP32 | AP33 | AP34 | AP35 |
| Used in runs: | P5 | P6 | P7 | P8 | P9 |
| Water | 14.90 | 14.80 | 2.00 | 4.83 | |
| Mandelic Acid | 6.10 | 6.10 | 2.57 | 2.13 | 3.28 |
| NAC | 3.05 | 3.05 | 3.04 | 2.22 | 1.80 |
| Glycerin | | | | | 6.00 |
| Propane(1,3)diol | 8.20 | 8.20 | 8.96 | 2.36 | 2.80 |
| Caffeine | 1.00 | 1.00 | | | |
| NaOH | | | 0.612 | | |
| GLDA | | | | 7.11 | |
| Hyaluronic acid | 0.20 | 0.20 | | | |
| Soluble starch | 0.24 | 0.24 | | | |
| Acrylic copolymer | 0.01 | 0.01 | | | |
| Citric acid | | | 0.508 | | |
| Ectoine | | | 0.157 | | |
| N-acetyl glucosamine | | | | | 0.55 |
| Sodium lauroyl sarcosinate | | | | 2.18 | |
| Sodium cocoyl glutamate | | | | 1.15 | |
| Acrylate copolymer | | | | | 0.02 |
| Cocoamid. Hyd. Sultaine | 2.61 | 2.61 | | 1.17 | |
| Initial mass: | 36.30 | 36.20 | 17.84 | 23.15 | 14.45 |

TABLE 2C
Overall percentage of ingredients in final sticks.

| Summary of | | | | | |
|---|---|---|---|---|---|
| Key Components: | P5 | P6 | P7 | P8 | P9 |
| Aluminum | 14.66% | 12.41% | 14.46% | 14.81% | 11.41% |
| chlorohydrate %: | | | | | |
| Caffeine %: | 0.25% | 0.33% | 0.00% | 0.00% | 0.00% |
| Mandelic acid %: | 1.54% | 2.01% | 1.38% | 1.13% | 4.14% |
| Silicone compounds %: | 22.9% | 19.5% | 19.8% | 19.4% | 28.5% |
| Synthetitc wax %: | 9.5% | 12.1% | 11.9% | 12.3% | 0.0% |
| Starch %: | 10.06% | 8.56% | 8.06% | 10.08% | 9.78% |
| Water %: | 3.75% | 4.92% | 1.07% | 2.56% | 0.00% |
| Glycerin %: | 0.00% | 0.00% | 0.00% | 0.00% | 7.57% |
| Esters (with | 14.3% | 15.2% | 14.7% | 14.4% | 17.7% |
| triglycerides) %: | | | | | |
| Fatty alcohols & acids %: | 8.1% | 7.9% | 7.7% | 8.7% | 5.9% |
| NAC: | 0.77% | 1.01% | 1.63% | 1.18% | 2.27% |
| Diol/glycol %: | 2.06% | 2.70% | 4.81% | 1.25% | 3.53% |
| NaOH: | 0.00% | 0.00% | 0.33% | 0.00% | 0.00% |
| Gelling agents, | 3.81% | 2.94% | 4.82% | 8.07% | 5.77% |
| emulsifiers: | | | | | |
| Panthenol: | 0.56% | 0.47% | 0.52% | 0.00% | 0.00% |
| GLDA | 1.33% | 1.35% | 0.67% | 3.77% | 2.69% |
| Sultaines, taurates, | 6.39% | 8.53% | 7.86% | 2.38% | 0.69% |
| sarcosinates, glutamates, | | | | | |
| and glucosamines | | | | | |
| Other (hyaluronic acid, | 0.05% | 0.07% | 0.27% | 0.00% | 0.03% |
| acrylate copolymer, | | | | | |
| citric acid) | | | | | |
| Total: | 100% | 100% | 100% | 100% | 100% |
| PH | 4 | | | 4 | 3.7 |

This approach to acid stick production is built upon inventive work seeking to overcome the basic challenges of producing an acidic solid stick. The related experimental work for that initial phase of developing the inventive product as claimed herein is shown in the examples below, illustrating some of the scope of the novel approach to creating acidic sticks.

In many runs prior to run 100, separate oil and silicone phases were prepared and heated, and after heating to 70° C. to 85° C., depending on the particular mix of compounds, were then combined in a single well in the double boiler system and mixed by hand with a whisk or whisk and spoon, together or in succession. Then the acid paste/water phase mixture was added and blended using a whisk or combination of spoon and whisk, followed by addition of starch and possible other powdered materials such as polydimethylsilsequioxane. At that point final ingredients could be added such as essential oils and/or caprylyl dimethicone, though in later embodiments (after run 106) caprylyl dimethicone was blended into the silicone and oil phase prior to mixing with the water phase. After blending in of the starch and other powdered ingredients and the final ingredients, if any, the hot mixture was immediately poured into a deodorant mold, using various molds such as repurposed commercial deodorant containers, 15 ml oval shaped molds, 2.2 ounce round plastic molds, and clear acrylic cylindrical Juvitus® brand (Culver City, Calif.) 1-ounce molds.

Starting with run 106, all silicone compounds including caprylyl dimethicone, if present, were combined and heated with the oil phase. Starting with run 98, the Bentone gel and dimethicones or other silicone liquids were combined in a large batch, large enough for over 3 runs, and then blended with an immersion mixer before adding to the oil phase and other ingredients, and the mixture was then heated and stirred/whisked together prior to the addition of a heated acid paste, followed by arrowroot starch and polymiethylsilsequioxane powder, when present.

In Tables 3A through 5C below, ingredients blended into the combined oil and silicone phase are shown in Tables 3A, 4A, and 5A, including oils, waxes, and esters including triglicerides, emulsifiers, silicone compounds, and powders that were blended into the mix. The water phase ingredients (also sometimes called the acid paste) are show in Tables 3B, 4B, and 5B, and the amount of the respective water phase/acid paste blended with the oil and silicone phase is listed as the entry for “Water phase add. (addition)” toward the end of each of Tables 3A, 4A, and 5A, which each have slight differences in the collective group of ingredients used. With the combination of the oil and silicone phase, the water phase, and other final ingredients (arrowroot starch, optionally caprylyl dimethicone, optionally polymethyl-silsequioxane and fragrances in some early runs), the calculated net composition by ingredient categories is shown in each of Tables 3C, 4C, and 5C. In some cases, as estimate for water loss during mixing is provided which is based on measured mass losses for water during its blending into a hot oil phase, based on rough measurements made as a heated mass was blended over time, using the removable well as an easy-to-weigh container in some experiments, and considering the duration of time at elevated temperature prior to pouring and cooling. The estimated water loss during processing is in Tables 3A, 4A, and 5A below “Water Phase Addition.”

Not all runs are shown, sometimes because they involved peripheral experimental work outside the scope of this disclosure, or occasionally involves experimental mistakes (e.g., adding excessive starch) or other problems. Many early runs focused on simply demonstrating the possibility of making a stable and non-gritty deodorant at all with high mandelic acid content and employed combinations with existing commercial products that often resulted in problems with texture, stability, etc. For example, combinations of the acid paste with existing deodorants high in alkaline materials such as sodium bicarbonate or magnesium hydroxide resulted in frothing, instability, or other setbacks or could not reach desired pH levels without excessive and wasteful additional mandelic acid. Some of these are reported but not all.

TABLE 3A
Series of runs with oil, silicone, and water.

| | Run: | | | | | | | | | | |
|---|---|---|---|---|---|---|---|---|---|---|---|
| Oil + silicone phase | 74 | 75 | 76 | 77 | 78 | 79 | 80 | 81 | 83 | 84 | 85 |
| Arrowroot starch | | | 2.82 | 2.71 | 2.81 | 8.68 | 3 | 5.3 | | 7.38 | 7.31 |
| Beeswax | 1.834 | | | | | | | | | | |
| Behenyl alcohol | | | | 1.281 | | 4.078 | 2.4 | | | | |
| Behenyl CreamMaker | | | | 0.523 | | | | | 0.51 | 0.607 | 0.607 |
| Bentone Gel GTCC V | 3.011 | 2.51 | 3.041 | 2.01 | 0.8 | 2.05 | 2.2 | 2.45 | 1.123 | 1.676 | 1.676 |
| C26-28 alkyl DM | 1.21 | 4.907 | 4.628 | 0.429 | | 1.093 | 0.62 | 3.2 | 1.572 | 2.514 | 2.514 |
| Cacao butter | 0.929 | 4.225 | 7.74 | | | | | | | | |
| Caffeine (oil/sil. phase) | | | | 0.2 | | | 0.2 | 0.2 | 0.2 | 0.2 | 0.1 |
| Candelilla wax | 1.021 | 1.206 | 0.743 | 0.538 | | 0.535 | 1.754 | 0.37 | | 0.505 | 0.505 |
| Caprylic/capric trigly. | | | | 5.128 | | | | | | | |
| Caprylyl dimethicone | | | | | | | | | 0.3 | | |
| Castor wax | | | | | | | | | | 0.723 | 0.73 |
| Cetyl alcohol | | | | 2.17 | 3.321 | 1.623 | | | | | |
| DM-v-DM copolymer | | | | | | | | | | | |
| DM6 dimethicone | | | | 0.241 | 0.376 | 0.25 | | 0.355 | 1.172 | 0.262 | |
| DM350 dimethicone | | 20.683 | 0.37 | 0.638 | 0.652 | 0.232 | 0.917 | 0.986 | 0.67 | 0.495 | 0.495 |
| DM4200 dimethicone | | | | | | | | 0.441 | | | |
| Diphenyl siloxy PTM | | | | 0.205 | 0.372 | 0.353 | 0.54 | 0.603 | 0.154 | 0.27 | 0.27 |
| Ecosil | | | 1.777 | | | 16.21 | 10.9 | 12.84 | | | |
| Ethylhexyl palmiate | | | 1.64 | 0.87 | | 0.223 | 0.669 | | 0.402 | | |
| Glycerin (oil phase) | | | 1.26 | 0.73 | 0.635 | 0.787 | 0.787 | 1.569 | | | |
| Hennisqualane | 2.99 | | | | | | | | | | |
| Hydroxpr.-cocoate | 0.841 | | | | | | | | | | |
| PEG-8 DM | | | | | | | | | | | |
| Isoamyl laurate | | | | | 4.958 | | 2.61 | | 4.26 | 7.07 | 7.08 |
| Kostol PGP | | | | | | 0.26 | 0.403 | 0.505 | 0.105 | 0.176 | 0.176 |
| Lauryl laurate | | | | 4.49 | 2.3 | 7.4 | 3.41 | 4.028 | | | |
| Magnesium stearate | | | | | | | | | 0.492 | | |
| Panthenol | | | | | 0.147 | 0.285 | 0.352 | 0.3 | 0.151 | 0.253 | 0.253 |
| Polymethylsilsesquiox. | 3.011 | | 1.00 | | | | 2.93 | | | 1.85 | 1.59 |
| Silica dimethyl silylyl | | | | 0.78 | | 1.303 | 0.365 | | | | 0.48 |
| Squalane | | 0.904 | 0.83 | 0.53 | 0.383 | | | 0.586 | 0.809 | 0.399 | 1.048 |
| Stearyl alcohol | | | 1.69 | 1.008 | | 2.778 | 4.068 | 8 | 3.033 | 5.005 | 5.005 |
| Water phase add.: | 9.2 | 3.07 | 2.4 | 2.465 | 2.433 | 3.51 | 3 | 4 | 2.63 | 4.26 | 4.49 |
| Water loss (est.) | 0.2 | 0.1 | | 0.1 | 0.1 | 0.1 | | | | 0.1 | 0.1 |
| Total mass (g): | 23.85 | 37.41 | 29.94 | 26.85 | 19.09 | 51.55 | 41.13 | 45.73 | 17.09 | 34.04 | 34.23 |

Not listed are fragrances in some cases. For example, run 74 had 3 drops (0.076 g) of elemi essential oil added before pouring.

In run 74, the polymethylsilsequioxane powder (3.011 g) was added to a first oil-silicone phase with 1.83 g beeswax, 1.021 g candelilla wax, 0.929 g cacao butter, and 1.21 g C26-28 alkyl dimethicone, while an oil-gel phase was made from 0.841 g of hydroxypropyl-PEG-8 dimethicone, 3.011 g of Bentone gel, 2.999 g hemisqualane, and essential oil. Once heated and blended separately, the two were combined at 80° C. and then 9.2 g of Acid Paste 10 was gradually blended in with a whisk. This occurred in the removable well allowing weighing of the unit before, during, and after the blending process. Acid Paste 10 comprised glycerin as the thickener with about 15% glycerin and about 15% mandelic acid present in the aqueous phase. The final product had 24% water, 6% each of glycerin and mandelic acid, over 21% silicones, etc. The resulting product was too soft and not a viable candidate for a stick, possibly because of too high a water level for a silicone+oil+water+acid+thickener formulation. In this case, in retrospect it is proposed that a water level less than 23%, less than 20%, less than 18%, or less than 16%, 15%, 14%, 13%, 12%, 11%, 10% or 9%, such as from 2% to 20%, 3% to 20%, 4% to 18%, 5% to 23%, 1% to 12%, etc., may have been helpful in providing a more suitable, harder composition.

Several acid pastes were used for runs 75-85, as shown in Table 3B.

TABLE 3B
Water phase compositions used for “water phase” addition
listed in Table 3A for the runs listed.

| Water Phase ID | AP10 | AP10A | AP 11 | AP 12 |
|---|---|---|---|---|
| Used in runs: | 74 | 75 | 76-81 | 82-85 |
| Composition: | | | | |
| Water | 21.7 | 24.73 | 31 | 10.90 |
| Tapioca Starch | 0 | 0.44 | 1.35 | 0.47 |
| Mandelic Acid | 5.108 | 4.06 | 1.878 | 0.66 |
| NAC | 0 | 0.62 | 1.901 | 0.67 |
| Glycerin | 5.04 | 3.40 | 0 | 2.50 |
| Propane(1,3)diol | 0 | 0 | 0 | 1.10 |
| Propylene glycol | 0 | 0 | 0 | 1.52 |
| Caffeine | 0 | 0 | 0 | 0.00 |
| NaOH | 1.29 | 0.87 | 0.00 | 0.00 |
| Initial mass: | 33.14 | 34.11 | 36.13 | 17.82 |

TABLE 3C
Overall percentage of ingredients in final sticks.

| | Run: | | | | | | | | | | |
|---|---|---|---|---|---|---|---|---|---|---|---|
| Oil + silicone phase | 74 | 75 | 76 | 77 | 78 | 79 | 80 | 81 | 83 | 84 | 85 |
| Caffeine %: | 0.00% | 0.00% | 0.00% | 0.74% | 0.00% | 0.00% | 0.49% | 0.44% | 1.10% | 0.57% | 0.29% |
| Mandelic acid %: | 5.95% | 0.98% | 0.42% | 0.48% | 0.66% | 0.35% | 0.38% | 0.45% | 0.54% | 0.45% | 0.47% |
| Silicone %: | 21.2% | 68.4% | 20.0% | 8.54% | 7.33% | 6.27% | 13.1% | 12.2% | 27.3% | 17.8% | 17.6% |
| Synthetitc wax %: | 0.00% | 0.00% | 0.00% | 0.00% | 0.00% | 0.00% | 0.00% | 0.00% | 0.00% | 0.00% | 0.00% |
| Starch %: | 0.00% | 0.11% | 9.72% | 10.4% | 15.2% | 17.1% | 7.57% | 11.9% | 0.39% | 21.5% | 21.2% |
| Water %: | 24.4% | 5.68% | 6.88% | 7.51% | 10.4% | 5.65% | 6.26% | 7.50% | 8.84% | 7.19% | 7.55% |
| Glycerin %: | 5.87% | 0.82% | 4.21% | 2.72% | 3.33% | 1.53% | 1.91% | 3.43% | 2.03% | 1.72% | 1.80% |
| Esters, triglycerides %: | 28.4% | 16.9% | 42.5% | 43.1% | 40.0% | 47.3% | 47.0% | 39.0% | 30.1% | 25.0% | 26.7% |
| Fatty alcohols, acids %: | 0.00% | 0.00% | 5.64% | 16.6% | 17.4% | 16.5% | 15.7% | 17.5% | 16.7% | 14.4% | 14.3% |
| NAC: | 0.00% | 0.15% | 0.42% | 0.48% | 0.67% | 0.36% | 0.38% | 0.46% | 0.54% | 0.46% | 0.48% |
| Diol/glycol %: | 0.00% | 0.00% | 0.00% | 0.00% | 0.00% | 0.00% | 0.00% | 0.00% | 2.12% | 1.80% | 1.88% |
| NaOH: | 1.50% | 0.21% | 0.00% | 0.00% | 0.00% | 0.00% | 0.00% | 0.00% | 0.00% | 0.00% | 0.00% |
| Gels, emulsifiers: | 12.6% | 6.71% | 10.2% | 9.44% | 4.19% | 4.48% | 6.33% | 6.46% | 9.56% | 7.06% | 7.02% |
| Panthenol: | 0.00% | 0.00% | 0.00% | 0.00% | 0.77% | 0.55% | 0.86% | 0.66% | 0.83% | 0.73% | 0.72% |
| Other (MG + ZN salts): | | | | | | | | | | 1.41% | |
| Total: | 100% | 100% | 100% | 100% | 100% | 100% | 100% | 100% | 100% | 100% | 100% |
| pH | | 3.3 | 3.2 | | | | | | 3.0 | 4.5 | 3 |

Table 4A shows formulations for runs 93-101, with respective acid pastes shown in Table 4B and final stick compositions by category shown in Table 4C.

TABLE 4A
Series of runs with oil, silicone, and water.

| | Run: | | | | | | | | |
|---|---|---|---|---|---|---|---|---|---|
| Oil phase + silicone | 93 | 94 | 95 | 96 | 97 | 98 | 99 | 100 | 101 |
| Arrowroot starch | 2.54 | 3.8 | 2.51 | 4.31 | 3.71 | 3.82 | 3.82 | 3.71 | 3.55 |
| Bentone Gel GTCC V | 0.92 | 1.06 | 1.06 | 1.68 | 1.82 | 1.78 | 1.59 | 1.65 | 1.65 |
| C26-28 alkyl DM | 2.01 | 1.45 | 1.47 | 1.47 | 2.59 | 2.09 | 2.45 | 2.4 | 1.25 |
| Caprylyl dimethicone | 1.4 | 1.3 | 1.76 | 1.76 | 1.74 | 0 | 3.4 | 1.84 | 1.89 |
| DM6 dimethicone | 1.96 | 2.71 | 2.97 | 4.96 | 5.12 | 5.69 | 6.36 | 6.06 | 6.06 |
| DM350 dimethicone | 0.49 | 0.29 | 0.47 | 0.68 | 0.86 | 0.89 | 0.76 | 0.86 | 0.86 |
| Diphenyl siloxy PMT | 0.94 | | | | | | | | |
| Ecosil | 0.35 | | | | | 4.01 | | | |
| Ethylhexyl palmiate | 1.89 | | | | | | | | |
| Isoamyl laurate | 3.01 | 1.97 | 2.18 | 3.85 | 3.49 | | 4.12 | 4.23 | 4.35 |
| Kostol PGP | 0.28 | | 0.24 | 0.32 | 0.40 | 0.43 | 0.42 | 0.46 | 0.46 |
| Panthenol | 0.24 | 0.27 | 0.11 | 0.18 | 0.20 | 0.20 | 0.27 | 0.25 | 0.25 |
| Polyethylene wax | 3.73 | 5.10 | 4.68 | 7.97 | 8.03 | 7.06 | 7.5 | 8 | 8 |
| Polymethylsilsesquioxane | 2.1 | 2.01 | 2.01 | 2.95 | 3.50 | 3.79 | 3.79 | 3.05 | 3.05 |
| Stearyl alcohol | 1.70 | 1.93 | 1.89 | 3.22 | 3.30 | 3.33 | 2.5 | 2.5 | 2.5 |
| Synkos 2050 wax | | | | | | | | | |
| Water phase add.: | 5.42 | 5.8 | 4.72 | 9.2 | 7.65 | 7.55 | 7.46 | 7.46 | 7.4 |
| Water loss (est.) | 0.2 | 0.2 | 0.2 | 0.5 | 0.4 | 0.4 | 0.4 | 0.3 | 0.3 |
| Total mass (g): | 28.8 | 27.5 | 25.9 | 42.1 | 42.0 | 40.2 | 44.0 | 42.2 | 41.0 |

TABLE 4B
Water phase compositions used for “water phase”
addition listed in Table 4A for the runs listed.

| | Water Phase Composition | | | | | | |
|---|---|---|---|---|---|---|---|
| | AP14 | AP15 | AP16 | AP17 | AP18 | AP18B | AP19 |
| Used in runs: | 93 | 94 | 95 | 96 | 97 | 98 | 99-101 |
| Water | 50 | 22.2 | 19.79 | 20.27 | 12.27 | 11.50 | 19.40 |
| Tapioca Starch | 3 | 0 | 1.53 | 1.41 | 0.90 | 0.90 | 1.44 |
| Mandelic Acid | 7.94 | 8 | 11.93 | 10.00 | 6.35 | 6.35 | 10.00 |
| NAC | 1.28 | 0 | 0.00 | 0.00 | 0.00 | 0.00 | 0.00 |
| Glycerin | 14 | 3.29 | 2.77 | 0.00 | 0.00 | 0.00 | 0.00 |
| Propane(1,3)diol | 2.75 | 0 | 0.00 | 1.62 | 2.42 | 2.42 | 2.53 |
| Propylene glycol | 2.04 | 0.00 | 0.00 | 0.00 | 0.00 | 0.00 | 0.00 |
| Caffeine | 1.2 | 3.2 | 4.09 | 4.00 | 2.54 | 2.54 | 3.80 |
| NaOH | 0 | 0 | 0.66 | 0.33 | 0.21 | 0.21 | 0.25 |
| Initial mass: | 82.21 | 36.69 | 40.77 | 37.63 | 24.68 | 23.91 | 37.42 |

As Acid Paste 19 was used in several runs with reheating prior to each use, additional water evaporated. The content of 19.40 g of water initially was estimated to be reduced, in effect (in terms of the overall original composition), to 19.10 g for runs 100 and 100. The resulting composition by percentage of the resulting sticks are shown in Table 4C:

TABLE 4C
Overall percentage of ingredients in final sticks.

| Summary of | Run: | | | | | | | | |
|---|---|---|---|---|---|---|---|---|---|
| Key Components: | 93 | 94 | 95 | 96 | 97 | 98 | 99 | 100 | 101 |
| Caffeine %: | 0.27% | 1.84% | 1.83% | 2.33% | 1.87% | 1.99% | 1.72% | 1.81% | 1.85% |
| Mandelic acid %: | 1.82% | 4.60% | 5.34% | 5.81% | 4.68% | 4.98% | 4.53% | 4.77% | 4.87% |
| Silicone compounds %: | 30.9% | 28.2% | 33.6% | 28.1% | 32.9% | 30.9% | 38.1% | 33.7% | 32.0% |
| Synthetic wax %: | 13.0% | 18.6% | 18.1% | 18.9% | 19.1% | 17.5% | 17.0% | 19.0% | 19.5% |
| Starch %: | 9.52% | 13.8% | 10.4% | 11.1% | 9.49% | 10.2% | 9.33% | 9.48% | 9.37% |
| Water %: | 10.8% | 12.0% | 8.08% | 10.6% | 8.10% | 8.03% | 7.87% | 8.39% | 8.56% |
| Glycerin %: | 3.21% | 1.89% | 1.24% | 0.00% | 0.00% | 0.00% | 0.00% | 0.00% | 0.00% |
| Esters, triglycerides %: | 18.2% | 7.17% | 8.43% | 9.15% | 8.31% | 9.97% | 9.35% | 10.0% | 10.6% |
| fatty alcohols & acids %: | 5.89% | 7.00% | 7.32% | 7.66% | 7.85% | 8.29% | 5.68% | 5.93% | 6.10% |
| NAC: | 0.29% | 0.00% | 0.00% | 0.00% | 0.00% | 0.00% | 0.00% | 0.00% | 0.00% |
| Diol/glycol %: | 1.10% | 0.00% | 0.00% | 0.94% | 1.78% | 1.90% | 1.15% | 1.21% | 1.23% |
| NaOH: | 0.00% | 0.00% | 0.30% | 0.19% | 0.15% | 0.16% | 0.11% | 0.12% | 0.12% |
| Gels, emulsifiers: | 4.17% | 3.86% | 5.02% | 4.76% | 5.29% | 5.50% | 4.58% | 5.01% | 5.15% |
| Panthenol: | 0.83% | 0.99% | 0.43% | 0.43% | 0.48% | 0.51% | 0.61% | 0.59% | 0.61% |
| Total: | 100% | 100% | 100% | 100% | 100% | 100% | 100% | 100% | 100% |
| PH | 2.5 | 25-2.9 | 2.9 | 2.9 | 3 | 2.5 | 2.8 | 2.7-2.9 | 3.2 |

Run 93 included some N-acetyl cysteine in the acid paste. Without wishing to be bound by theory, it is proposed and believed that the low pH of N—acetyl cysteine coupled with its potential antimicrobial or anti-biofilm capabilities may be compatible with the mechanisms of mandelic acid in enhancing the skin microbiome and thus may be a particularly useful ingredient for a deodorant, although in high concentrations it can provide a sulfurous odor. The 0.3% concentration in this sample did not lead to obvious sulfurous odors and appeared to be compatible with the formulation. Other earlier runs also showed that even higher concentrations of NAC could be successful and gave positive results in testing on human subjects, though the sulfurous smell of NAC was sometimes noted.

Run 101 was repeated but with 3 different pour temperatures, 78° C., 68° C., and 63° C., with substantially the same quantity poured into identical 2.2-ounce round deodorant molds and cooled to about 72° C. Hardness was measured using the AMS 59032 E-280 Pocket Penetrometer. A hardness of 0.6 was recorded for the pour at 78° C., 0.5 for 68° C., and 0.4 for 63° C.

Table 5A shows formulations for runs 102-110, with respective acid pastes shown in Table 5B and final stick compositions by category shown in Table 5C.

TABLE 5A
Series of runs with oil, silicone, and water.

| | Run: | | | | | | | |
|---|---|---|---|---|---|---|---|---|
| Oil phase + silicone | 102 | 103 | 104 | 105 | 106 | 108 | 109 | 110 |
| Arrowroot starch | 3.59 | 3.56 | 3.55 | 3.54 | 3.55 | 3.55 | 3.67 | 3.62 |
| Bentone Gel GTCC V | 1.16 | 1.64 | 1.64 | 1.64 | 1.61 | 1.62 | 1.64 | 1.66 |
| C26-28 alkyl DM | 0.95 | 1.25 | 1.25 | 1.25 | 1.25 | 1.25 | 1.25 | 1.24 |
| Caprylyl dimethicone | 1.89 | 1.89 | 1.89 | 1.84 | 1.932 | 1.88 | 1.96 | 1.94 |
| DM6 dimethicone | 4.25 | 6.00 | 6.00 | 6.01 | 6.05 | 6.10 | 6.17 | 6.27 |
| DM350 dimethicone | 0.60 | 0.86 | 0.86 | 0.86 | 0.86 | 0.86 | 0.88 | 0.90 |
| Isoamyl laurate | 4.3 | 4.35 | 4.38 | 4.38 | 4.37 | 4.37 | 4.36 | 4.54 |
| Kostol PGP | 0.31 | 0.46 | 0.46 | 0.46 | 0.46 | 0.46 | 0 | 0.47 |
| Panthenol | 0.26 | 0.28 | 0.28 | 0.28 | 0.29 | 0.27 | 0.27 | 0.27 |
| Polyethylene wax | 8.03 | 8.04 | 8.03 | | | | | |
| Polymethylsilsesquiox. | 3.3 | 2.87 | 2.86 | 2.86 | 2.87 | 2.02 | 1.76 | 1.83 |
| Stearyl alcohol | 2.51 | 2.5 | 2.51 | 2.51 | 2.51 | 2.5 | 2.5 | 2.66 |
| Synkos 2050 wax | | | | 8.04 | 8.04 | 8.01 | 8.01 | 8.09 |
| Water phase add.: | 7 | 7.39 | 7.39 | 7.14 | 7 | 7.37 | 7.53 | 6.75 |
| Water loss (est.) | 0.3 | 0.2 | 0.2 | 0.2 | 1 | 0.1 | 0.1 | 0.1 |
| Total mass (g): | 37.8 | 40.9 | 40.9 | 40.6 | 39.8 | 40.2 | 39.9 | 40.1 |

TABLE 5B
Water phase compositions used for “water phase” addition
listed in Table 5A for the runs listed.

| Water Phase | | | | | |
|---|---|---|---|---|---|
| Composition | AP19 | AP20 | AP23 | AP24 | AP25 |
| Used in runs: | 102 | 103 | 108 | 109 | 110 |
| Water | 19 | 20 | 19 | 9.7 | 13 |
| Tapioca Starch | 1.44 | 1.43 | 1.44 | 1.56 | 0.68 |
| Mandelic Acid | 10 | 10 | 10 | 11.11 | 10 |
| Propane(1,3)diol | 2.53 | | 2.54 | 11 | 6.5 |
| Propylene glycol | 0 | 2.54 | | | |
| Caffeine | 3.8 | 3.8 | 3.73 | 3.8 | 3.8 |
| NaOH | 0.25 | | 0.325 | 0.345 | 0.347 |
| Initial mass: | 37.0 | 37.8 | 37.0 | 37.5 | 34.3 |

As Acid Paste 20 was used in several runs with reheating prior to each use, additional water evaporated. The content of 20.0 g of water initially was estimated to be reduced by evaporation, in effect, in terms of the overall original composition, to 19.5 g in Run 104, 19.2 g for run 105, and 18.9 g for run 106. The resulting composition by percentage of the resulting sticks are shown in Table 5C:

TABLE 5C
Overall percentage of ingredients in final sticks.

| Summary of | Run: | | | | | | | |
|---|---|---|---|---|---|---|---|---|
| Key Components: | 102 | 103 | 104 | 105 | 106 | 108 | 109 | 110 |
| Caffeine %: | 1.90% | 1.82% | 1.84% | 1.81% | 1.82% | 1.85% | 1.91% | 1.86% |
| Mandelic acid %: | 5.00% | 4.79% | 4.85% | 4.75% | 4.80% | 4.96% | 5.59% | 4.90% |
| Silicone compounds %: | 29.0% | 31.5% | 31.4% | 31.6% | 32.6% | 30.2% | 30.1% | 30.3% |
| Synthetic wax %: | 21.2% | 19.7% | 19.6% | 19.8% | 20.2% | 19.9% | 20.1% | 20.2% |
| Starch %: | 10.2% | 9.39% | 9.37% | 9.39% | 9.61% | 9.55% | 9.99% | 9.35% |
| Water %: | 8.70% | 9.08% | 8.97% | 8.64% | 6.55% | 9.17% | 4.63% | 6.12% |
| Glycerin %: | 0.00% | 0.00% | 0.00% | 0.00% | 0.00% | 0.00% | 0.00% | 0.00% |
| Esters, triglycerides %: | 11.4% | 10.6% | 10.7% | 10.8% | 11.0% | 10.9% | 10.9% | 11.3% |
| Fatty alcohols & acids %: | 6.63% | 6.11% | 6.14% | 6.17% | 6.30% | 6.22% | 6.27% | 6.63% |
| Diol/glycol %: | 1.26% | 1.22% | 1.23% | 1.21% | 1.22% | 1.26% | 5.53% | 3.18% |
| NaOH: | 0.12% | 0.00% | 0.00% | 0.00% | 0.00% | 0.16% | 0.17% | 0.17% |
| Gelling agents, emulsifiers: | 3.88% | 5.14% | 5.13% | 5.18% | 5.21% | 5.18% | 4.11% | 5.31% |
| Panthenol: | 0.68% | 0.69% | 0.68% | 0.70% | 0.72% | 0.67% | 0.68% | 0.67% |
| Total: | 100% | 100% | 100% | 100% | 100% | 100% | 100% | 100% |
| pH: | 2.7 | 2.5 | N/A | N/A | 2.5 | 2.7 | 2.5 | 2.5 |

The majority of the runs shown above resulted in sticks that solidified well with a range of textures suitable for a solid stick. Granules of mandelic acid could not be perceived if they were present. Rather, the sticks were smooth and generally seemed highly uniform. A number of products were tested on human volunteers with excellent performance, both in terms of application and non-irritation, but also in terms of odor control performance. Water levels between 3 and 20% or 5 and 15% appeared to be capable of providing surprisingly high concentrations of mandelic acid without the problem of graininess and irritation of the skin. Based on further experimental work in which large quantities of caffeine and mandelic acid were dissolved in various elevated viscosity fluids such as water and tapioca starch, glycerin, propanediol, and propylene glycol, it was observed that these liquids often can be easily saturated with the dissolved solids at elevated temperature (e.g., 70° C., 75° C., 80° C., 85° C., 90° C., 95° C., 100° C., 110° C. and 120° C.) and then, upon cooling o room temperature, while solids can precipitate, the precipitate tends to be very fine and often difficult for human skin to perceive the existence of a solid phase. While mandelic acid dissolved in water alone can readily give large crystals after cooling, the thickened fluids described herein seemed, without wishing to be bound by theory, to help control crystallization to reduce the formation of large grains, though fine feathery, needlelike particles believed to be caffeine crystals could be seen in a microscope. It is also possible that caffeine preferentially precipitated leaving high levels of mandelic acid in the liquid.

Run 56. A new Acid Paste was made using N-acetyl cysteine (NAC) instead of mandelic acid. 50 ml of water were combined with 4.40 g of corn starch and 5.0 g NAC. This was place in a 100-ml beaker and heated by microwave, stirring between brief bursts of power, to finally create a smooth, uniform paste. This is Acid Paste 8.

The oil phase was made from 7.50 g cacao butter, 2.00 g sunflower wax, 0.89 g coconut oil, 0.2 g caffeine, 1.58 g emulsifying wax, 5.03 g caprylic capric triglycerides MCT, 5.56 g stearyl alcohol, 0.66 g palmitic acid, 0.118 g magnesium myristate, and 0.297 g silica dimethyl silylate. This was blended with 2.17 g Acid Paste 8 and then with 3.00 g arrowroot starch, and then with 2 drops of elemi oil. The effective pH was about 3.5.

Run 57. The oil phase was made from 9.57 g cacao butter, 2.17 g candelilla wax, 1.39 g coconut oil, 0.3 g caffeine, 1.89 g emulsifying wax, 7.43 g caprylic capric triglycerides MCT, 5.15 g stearyl alcohol, and 1.8 g ethylhexyl palmitate. To the oil phase was added 2.06 g Acid Paste 8, 3.45 g arrowroot starch, 1 drop elemi oil and 2 drops lavender oil. After cooling, this was too soft, so it was remelted and combined with 2.00 g castor wax, 1.15 g behenyl alcohol, and 1.35 g tapioca starch.

Dimethicone Series: Three dimethicones were used with viscosities of 4200-4800 cst (DM4200), 350 cst (DM350), and 6 cst (DM6).

### Examples of Vitamin C Serums

7.39 g of 99.93% ascorbic acid powder (Resurrection Beauty, Holmen, WI) was combined with 0.45 g panthenol, 1.28 g NAC, 45 ml of water, 2.20 g of lactic 1.2 g NaHCO₃, showing a pH of 3.4. Of this, 39 g was put in a spray bottle and labeled as Serum A. 16.0 g was put into another bottle to which 0.1 g caffeine was added and 0.15 g hyaluronic acid (SLMW). This was Serum A1. Both products were used on the faces of two subjects for testing over a period of several weeks, with one subject reporting noticeable improvement relative to facial wrinkles. However, the application sometimes caused mild stinging or a noticeable film forming effect. An improved formulation was requested that would be gentler or smoother.

A new formulation was made with Phase A comprising 67.8 g water, 0.963 g NAC, 0.754 g panthenol, and 0.394 g sodium carbonate. The mixture was placed in a wide dish and 0.158 g hyaluronic acid (SLMW) were sprinkled onto the surface and allowed to slowly hydrate. Phase B was prepared with 20 g ethoxydiglycol, 14.9g propanediol, 2.40 g glycerin, 0.77 g of Vitamin E oil from Spring Valley (Walmart, Bentonville, AR) 400 IU capsules, 0.44 g phenylpropanol, and 4.00 g laureth-23 from Lotioncrafter LLC. After Phase B was heated to about 60° C. and blended, it was stirred into Phase A. The appearance immediately became cloudy. 21 g of water and 0.95 g coco betaine were added to see if the cloudiness could be reduced, without success, but the creamy appearance, due to phenylpropanol, is not necessarily a negative. Then 6.03 g of buffered ascorbic acid from Pure Encapsulations (Sudbury, Mass.) was added with 9.6. g of ascorbic acid powder from Resurrection Beauty and further adjustments to pH, namely, 1.99 g citric acid, 16 g water, 1.74 g NAC, giving a pH of about 3. This was labeled Serum B1. It was noted that the odor of the mixture is very faint, raising the possibility that the betaine was assisting in odor control.

The odor control effect of coco betaine was tested by mixing 2 g of NACA in 60 g of water and dividing the solution evenly between two jars. One jar was given 1.5 g of added water while the other was given 1.5 g added coco betaine. Both were allowed to sit covered for a period of time and then tested for odor. The jar with the added betaine had distinctly less odor. Over an hour later, some sulfur odor was detected, so 0.5 g of cocoamidopropyl hydroxysultaine was also added, but this did not significantly improve odor control. (This was before noting the effect of SHMP.)

Serum C was made with 73.6 g water, 1.71 g NAC, and 0.326 g hyaluronic acid (SLMW) in phase A, with phase B having 1.15 g panthenol, 14.91 g ethoxydiglycol, 3.67 g propylene diglycol, 1.42 g cocoa betaine, 6.95 g propane diol, 0.62 g phenylpronol, 0.35 g Vitamine E oil, 0.08 g of HandSan Clean Lemon scent of Air-Scent International (Pittsburgh, Pa.), and 10.87 g ascorbic acid powder. After the two phases were blended, 0.68 g NaHCO3 was added, giving a pH of 2.8.

Serum D was made with 81.9 g water, 0.88 g NAC and 0.25 g hyaluronic acid (SLMW) in Phase A. Phase B had 24.0 g ethyoxydiglycol, 0.9 g panthenol powder, 3.91 g propylene glycol, 2.8 g propane diol, 2.60 g laureth-23, 0.40 g Leucidal SF Max preservative, 0.04 g orange essential oil, 0.03 g frankincense essential oil, 9.79 g ascorbic acid powder, 1.34 g buffered ascorbic acid (Pure Encapsulations), with a pH of 3.26. Batch D was tested on the faces of two subjects daily for over one month, with positive results suggesting increased skin smoothness and apparent decrease in fine wrinkles. The serum seemed to absorb into skin faster than expected, meaning noticeably faster than water alone.

Serum D2 was made from 4.76 g of Serum D, with 0.44 g almond oil added, 0.15 g jojoba oil, and 0.29 g coco betaine, blended thoroughly. This creamy preparation felt smooth and comfortable when applied to the skin, like a lotion.

Serum E was made from 58.3 g water, 1.15 g NAC, 0.316 g hyaluronic acid (SLMW) in Phase A. Phase B had 0.31 g Vitamin E oil, 11.38 g propanediol, 2.14 g glycerin, 5.96 g ethoxydiglycol, 0.379 g panthenol, 0.57 g jojoba oil, 2.04 g cocobetaine, 1.20 g laureth-23, 0.046 g HandSan Clear Lemon scent, 0.20 g Leucidal preservative, 1.57 g coffee seed extract (Making Cosmetics, Inc.). After blending the two phases, 0.46 g lactic acid and 0.183 g phenyl propanol were added (the latter largely dissolved rather than forming a milky colloid). Then 8.93 g ascorbic acid powder and 1.303 g of buffered ascorbic acid powder were added, giving a pH of about 3.0. This serum had a pleasant tan color and a good skin feel. This was tested on a subject over a course of one week with a positive response in terms of skin feel and appearance.

The above formulations appear to have better tactile properties in use than the initial Serum A or A1, though all may be suitable, depending on the user.

A second batch of serums was made. For serum Z1, Phase A comprised 78.8 g of water and 0.607 g of hyaluronic acid (SLMW) gently sprinkled onto the surface of the water. After more than 30 minutes, the hyaluronic acid was fully dissolved and the mixture was stirred. Then 0.822 g panthenol was added in 10.8 g water with 1.241 g NAC, 1.120 g SHMP, and 0.21 g sodium carbonate and blended as Phase A. Phase B comprised 3.31 g of Olivem 1000, 19.3 g ethoxydiglycol, 4.00 g propanediol, 1.42 g Luicidal preservative, 4.61 g propylene glycol, 2.2 g glycerin, 0.15 g Vitamin E, 9 g PuriShield CSA solution. Phases A and B were mixed and combined with 10.53 g of buffered Vitamin C powder. The pH was 3.6, which was reduced to 3.3 by adding a small amount of lactic acid.

Serum Z2: Phase A had 63 g water, 1.336 g NAC, 0.851 g panthenol, 1,15 g SHMP, and 0.57 g hyaluronic acid (SLMW). Phase B had 1.126 g Olivem 1000, 1.23 g coco betaine,7.94 g ethoxydiglycol, 5.69 g propanediol, 0.86 g phenylpropanol. Phases A and B were heated to about 50° C. and blended. The 9.83 g of pure Vitamin C powder was added plus 4.28 g of buffered Vitamin C powder. Some precipitate formed, possibly due to a reaction with the betaine or hyaluronic acid. The pH was 2.8. The pH was raised to 3.3 with 0.11 g sodium carbonate, and 76.7 g of decanted liquid was separated from the precipitate and some froth.

Serum Z3: Phase A had 74.6 g of water, 0.139 g ectoin, 1.585 g NAC, 0.423 g panthenol, 0.678 g trisodium phosphate, 22.89 g PuriShield CSA solution, 0.249 g sodium carbonate, and 0.558 g hyaluronic acid (SLMW). Phase B had 6.22 g aminosyl SCG, 0.93 g laureth-23, 0.17 g Vitamin E, 11.54 g propanediol, 6.00 g ethoxydiglycol, and 0.994 g phenylpropanol. Phases A and B were mixed and had a pH of 6.4 in a clear solution. Then 14.7 g of pure Vitamin C powder was added, giving a pH of 3.2. This serum was applied daily for about 2 weeks to two subjects who reported good skin feel and a penetration into the skin that appeared to be significantly faster than water alone, and without leaving a tacky residue, suggesting that the Vitamin C was penetrating into the skin. Without wishing to be bound by theory, it is believed that the NAC and panthenol in combination may be effective in increasing skin penetration, and thus may assist entry of Vitamin C into the skin, though further investigation is needed to better understand the effect.

Many other ingredients can be considered for serums and other skin care compounds. Water may often be the primary ingredient, followed by 5% to 30% polyol compounds such as one or more of the group comprising propanediol or other diols, glycerine, ethoxydiglycol, propylene glycol or other glycols, etc.; 1% to 25% acids or derivatives thereof such as one or more of the group comprising ascorbic acid, gluconic acids, gluconolactone, lactic acid, mandelic acid, glycolic acid, succinic acid, etc.; optionally 0.5% to 10% of one or more emollients such as butters, oils, esters, lipids, and fatty acids; NAC, typically from 0.1% to 3% or from 0.1% to 1.5%, or from 0.5% to 2%; optionally 0.5% to 8% or 0.5% to 4% of skin permeability enhancers such as panthenol or derivatives thereof, *****; 0.05% to 2% anti-wrinkle agents such as hyaluronic acid or sodium hyaluronate or other salts, particularly the low-molecular weight compounds with a molecular weight of from 1,500 to 150,000, 1,500 to 100,000, 2,000 to 60,000, and 2,000 to 30,000; 0.01% to 5% optional silicone compounds such as dimethicone; suitable emulsifiers when emollients and/or silicone compounds are present and emulsification is needed; optionally 0.1% to 4% or 0.2% to 3% of botanicals, plant extracts, and/or essential oils; optional biofilm control agents; optional preservatives; optional fragrance, etc.

Natural skin care agents such as botanicals, plant extracts, etc., may include Tremella fuciformis extract, Camellia sinensis leaf extract, Rubus idaeus (raspberry) extract, Cupressus sempervirens extract, melon extracts. Salvia officinalis leaf extract, etc.

### Oral Care Examples

Mouthwash M1 was made by combining 53.7 g of Goodsense® Antiseptic Mouth Rise (Geiss, Destin, and Dunn, Inc., Peachtree City, Ga.), “blue mint” flavor, with 0.64 g NAC, 0.91 x xylitol, 4.5 g water, and 0.47 h NaHCO₃. The original pH of 4.3 was now 6.0.

Mouthwash M2 was made by combining 47.5 g of aloe vera juice (filtered whole lead juice, preservative free) from Lily of the Desert (Denton, Tex.) with 2.55 g NAC, 0.10 g peppermint oil, 178 g water, 7.28 g xylitol, 5.67 g sorbitol, 4.91 g propanediol, 2.27 g glycerine, and 1.43 g NaHCO_{3,} having a pH of 4.6.

M3 was made from 4.74 g xylitol, 3.8 g NAC, 9.64 g sorbitol, 61.9 g aleo vera juice, 210 g water, 10.35 g propanediol, 8.13 g glycerin, and 0.1 g sweet orange essential oil (Healing Solutions, LLC, Phoenix, Ariz.),

M4 was made from 5,74 g sorbitol, 8.42 g xylitol, 1.89 g SHMP (sodium hexmetaphosphate), 2.08 g NAC, 67.1 g aloe vera juice, 0.2 g Vitamin E oil from a capsule, 11.1 g glycerin, 11.1 g glycerin, 5.2 g propanediol, 2.07 g coco betaine, 227.9 g water, and 1.29 g NaHCO₃ to give a pH of 4.9.

M5 was made by taking 40.2 g of Schmidt's® Wondermint mouthwash, comprising water, glycerin, xylitol, blue magnolia bark extract, goji berry extract, etc., and combining it with 50 g of mouthwash M4.

M6 was made from 104 g water, 3.3. g NAC, 0.899 g sodium citrate, 1.38 g SHMP, 1.21 g NaHCO₃, 2.03 g propanediol, 4.19 g xylitol, 32.62 g aloe vera juice and 1.2 g glycerin.

M7 was made from 50 ml of M2 with 1.9 g added NAC and saturated with zinc citrate (2.0 g was added, stirred, and then eventually the solute was decanted from the undissolved solids). Then 38 g aloe vera juice was added to the solute with 1.3 g NaHCO₃ to give a pH of 5.04.

M8 was made with 0.17 g ECGC (98% pure epigallocatechin gallate extracted from green tea), 1.13 g NAC, 42 g water, 0.47 g sodium citrate, 11.9 g aloe vera juice, 1 drop sweet orange essential oil, 3.46 g propane diol, 1.9 g xylitol, and 0.77 g sorbitol, 1.21 g glycerin. After adding 0.58 g NaHCO₃ to raise the pH to slightly over 6, a light pink color developed in the solution, believed to be due to EGCG dimerization. The taste also was somewhat bitter. Then 0.52 g NAC was further added to bring the pH down to 5.2, causing the pink color to fade away. The slight tartness seemed to also improve the taste.

Samples M1 through M8 were sealed in jars overnight and then each individually opened and evaluated by two testers checking for malodor from NAC. Both testers independently rated sample M4, a sample containing SHMP, as being nearly free of malodor. M3 was also favorably rated for the light orange smell seemed to mask NAC odor well. M7 also had only faint NAC odor. The strong mint of M1 and M5 covered much of the NAC odor, but the combination was not completely effective.

The mouthwash solutions were tasted after being stored overnight at room temperature. M1 had a strong mint flavor. M2 has a pleasant citrus flavor. M3 had a citrus flavor similar to grapefruit. M4 was unpleasant. M6 had a salty taste and some NAC flavor that could be detected. M7 had a neutral taste with no distinct flavor. M8 had an unpleasant taste and had developed a slightly purple tinge.

A 3% NAC solution in water was prepared and adjusted with NaOH to a pH of 4.05 and used to make several mixes to test odor control. In mix Z1, 0.533 g of EDTA was added to 50 ml of the 3% NAC solution. In mix Z2, 0.725 g of TSGD (tetrasodium glutamate diacetate) was added to 50 ml of 3% NAC solution. In mix Z3, 0.49 g of TSGD was combined with 50 ml of 3% NAC solution. In mix Z4, 0.583 g of Aminosyl SGC were combined with 50 ml of 3% NAC solution. After being sealed in a 200 ml vessel overnight and then opened and smelled, Z1 was rated at 1 on a scale of 0 to 5 for malodor, being nearly odor free, and Z2 was also rated favorably at 2. Z3 and Z4 had more apparent malodor, being rated at 4 and 5, respectively. Thus sodium cocoyl glutamate and EDTA may be relatively effective in reducing NAC malodor under the conditions studies. A higher amount of TSGD may have contributed to a slightly lower odor level, but the effect was not as strong as observed with some of the other compounds tested.

At this point, deodorant stick P4 containing NAC was opened after being stored for about 10 months. A distinct sulfurous odor was present. 8.12 g of the stick was combined with 0.83 g of cacao butter, 0.321 g water, and 0.111 g SHMP. These were heated in a double boiler and melted together, then mixed and cooled, and stored in a plastic bag. When smelled several hours later, the sulfurous odor was clearly reduced, again suggestive of the power of SHMP in reducing NAC odor.

### Creams, Ointments, Lotions, etc.

Several examples of creams, ointments, lotions, and other consumer products were also made with NAC and related compounds. For example, about 0.3 gram of NAC powder was blended into 5 ml of a diabetic skin care cream, Goicoechea® DiabetTX® Skin Lotion, manufactured by Genomma Lab USA (Houston, Tex.), with listed ingredients including, in order: Water, Glycine Soja (Soybean) Oil, Cetearyl Alcohol, Ceteareth-20, Imidazolidinyl Urea, Peroxidized Corn Oil, Hydrogenated Butylene/Ethylene/Styrene Copolymer, Propylene Glycol, Isopropyl Palmitate, Cyclomethicone, Dimethicone, Sodium PCA, Colloidal Oatmeal, Carbomer, Tocopheryl Acetate, Laminaria (Algae) Extract, Decolorized Aloe Barbadensis Leaf Juice, Mentha Piperita (Peppermint) Oil, Eucalyptus Globulus Leaf Extract, Hydrolyzed Opuntia Ficus Indica Flower Extract, Styrax Benzoin Resin Extract, Myristyl Myristate, Sodium Lactate, Menthol, Sodium Hydroxide, Methylchloroisothiazolinone, Methylisothiazolinone. The NAC dissolved readily into the cream without destabilizing the emulsion. It was then applied onto the skin of two subjects, one on a portion of wound from skin abrasion and also on healthy skin. In both cases there were no adverse effects and it appeared to have softening effect.

In another trial, an aqueous phase was prepared using 0.47 g NAC, 1.71 g propane diol, 0.60 g GLDA, and 1.28 g water. This was blended to dissolve the solids. Then 8.62 g of Eucerin® Advance Repair (a product of Beiersdorf, Hamburg, Germany) was put into a beaker and blended with 2.38 g of sodium methyl cocoyl taurate, and then 0.83 g of the aqueous phase was stirred in. The resulting mixture was less viscous than Eucerin® lotion alone but still appeared stable. It spread smoothly onto skin and had a pleasant but slightly greasy feel, perhaps because of the tactile properties of the taurate compound and the added propanediol. The ingredients of the Eucerin® Advanced Repair lotion are: water, glycerin, urea, cetearyl alcohol, glyceryl glucoside, cyclomethicone, sodium lactate, Butyrospermum Parkii (shea) butter, caprylic-capric-triglyceride, methylpropanediol, octyldodecanol, dicaprylyl ether, tapioca starch, glyceryl stearate SE, hydrogenated coco-glycerides, arginine HCl, sodium PCA, dimethiconol, lactic acid, Chondrus Crispus (carrageenan), carnitine ceramide NP, mannitol, serine, sucrose, citrulline, glycogen, histidine, alanine, threonine, glutamic acid, lysine, sodium chloride, sodium cetearyl sulfate, 1-2-hexanediol, phenoxyethanol.

Creams, pastes, and related agents can be made that combine NAC and related compounds with clays, such as any of the JARXOTIC® clays produced by Jarchem Industries, Newark, N.J. As one example, the formulation for a clay cleansing cream from Elementis (formulation F-027-02) at https://www.ulprospector.com/documents/1592071.pdf?bs=2561&b=1312796&st=20 &r=na&ind=personalcare was adapted for use with NAC. A thick, pleasant clay-based cream with an olive green color was made comprising NAC and related compounds, which had good stability, a smooth emollient-like feel, and good viscosity. When applied to facial skin, it appeared to have a firming effect and could remain for a prolonged time and still feel comfortable. Upon washing, there was no indication of any adverse effects.

The clay cleansing cream was made with three phases. Phase A had 18.23 g of glycerin combined with 7.2 g of Jarxotic® GC-NS, CAS# 12173-60-3. Phase B was the aqueous phase with 35 g distilled water, 1.613 g NAC (a relatively low-odor version from Bulk Supplements (Henderson, Nev.), 0.791 g L-cysteine HCL monohydrate from Bulk Supplements, 0.395 g N-acetyl glucosamine from Bulk Supplements, 0.090 g L-methionine from Bulk Supplements, and 0.684 g NaOH. This was stirred and heated to accelerate dissolution, showing a pH of 7.5. This was brought to a temperature of 70° C. and blended with Phase A, and the mixture was brought to a temperature of about 75° C. Meanwhile the oil phase, Phase B, was prepared and melted together to a temperature of about 65° C. It comprises 7.00 g caprylic capric triglycerides MCT, 2.01 g Ecomulse emulsifier, 0.776 g Olivem 1000® emulsifier, 0.995 g cetyl alcohol, 1.270 g stearyl alcohol, 0.987 g Shea butter, and 2.00 g sunflower wax. Phase C was then poured into a heated (about 90° C.) 32-ounce glass Mason jar and the mixture of Phases A and B was also poured in, and a KitchenAid® (St. Joseph, Mich.) immersion blender, Model KHB1231ER with an immersion head that was heated in 90° C. water was then used at high speed (setting #2) to fully blend the mixture as it cooled gradually from about 75° C. to 45° C. At about 43° C., it was transferred from the jar to a broad open glass container and instead of filling the container like a liquid, it acted like a typical thick hand cream and was able to form a mound over a portion of the flat glass bottom of the container, covering an area of about 3 inches by 2 inches with a height of about 1.5 inches.

Without wishing to be bound by theory, it is believed that by elevating the pH of the solution with NAC, initially at a pH of about 1.9, the emulsifiers were able to function effectively in spite of the NAC and related compounds being present. In alternate embodiments, it is believed that the pH could be kept as low as 1.9, 2.0, 2.5, 3, 3.5, or 4 and still maintain good rheological properties and stability if suitable emulsifiers were used, including, for example, AqDot's AqStar M1® emulsifier at a level of 0.2% to 2%.

The use of NAC and related compounds is also envisioned in many other related creams, lotions, pastes, ointments, gels, salves, balms, lipsticks, etc. For example, NAC and related compounds may be effective agents in treating onychomycosis (nail fungus), particularly when combined with keratolyic agents (agents that soften keratin and may help remove outer layers of the skin) that can increase penetration of active agents through the nail. Such agents include urea, salicylic acid, lactic acid, allantoin, glycolic acid, and trichloroacetic acid. As a demonstration of a NAC compound treating nail fungus, a foot soak was prepared in which about 6 g of NAC was combined with about 20 g of urea and combined with a mixture of about 2 liters of hot water and 300 ml of distilled vinegar (5% acidity), wherein two feet from a person with onychomycosis were soaked for about 1 hour, a process that repeated several times, followed by application of various topical ointments. Another water soak was made with 8.75 g NAC, 18.9 g urea, 18.3 g Epsom salt, 3.2 g zinc citrate, 0.6 g trisodiumphosphate, 2.88 g SHMP, 2 g of liquid soap, 1 quart of distilled vinegar (5% acidifty), and 1 gallon of hot water. This mix was then used to soak two feet for 1 hour.

The water soak appears to reduce symptoms and is believed to be synergistic with the topical treatments, but further testing is needed to confirm. It is believed that the urea assists in improving toenail permeability and that the NAC assists in weakening a fungal biofilm so that other agents may be more effective in fighting onychomycosis. It is believed that a further ointment or cream comprising 0.5% to 3% NAC, 1% to 20% urea, and a known antifungal active such as tineacide and/or undecylenic acid, for example, a pH of 2.5 to 9.5 or from 3 to 8 or from 3 to 6, could be helpful in further controlling onychomycosis when applied periodically and topically. Such actives include undecylic acid (typically 25%, but lower levels may also be used), Tolnaftate (typically 1%), Miconazole nitrate (typically 2%), ciclopirox, Tavaborole (Kerydin), Efinaconazole (Jublia), ME 1111, Auriclosene, Luliconazole, camphor oil, application of Vick's Vapo Rub (high in camphor), various essential oils such as rosemary oil, teal oil, grapefruit oil, and/or oregano oil, etc.

In an exemplary trial, 1.13 g of Tineacide® Antifungal Cream from Blaine Labs (Santa Fe Springs, Calif.) was combined with 0.141 g urea, 0.162 g NAC, and 0.04 g N-acetyl D-glucosamine. The mixture was blended with a finger in a small weighing cup for about 5 minutes to dissolve the particles. The viscosity of the cream remained relatively high, though perhaps slightly lower than originally. It is believed that the added urea assisted in controlling the pH and stability of the emulsion.

This was applied to toes both before and after a toe soak with NAC and related ingredients. A powder mix was prepared comprising 10.5 g NAC, 2.50 g N-acetyl D-glucosamine, and 21 g urea. This was dissolved in one quart of warm water and 400 ml of Heinz® distilled vinegar, 5% acidity, and then place in a flat about 25 by 40 cm by 15 cm high. The back of the container was propped up to be about 4 cm off the ground, putting the bottom of the container an angle that pooled the water to fully immerse the toes at the front end of the container. After a soak lasting about 45 minutes and patting the feet to be relatively dry with a cloth, the NAC-laden topical ointment was then applied to the toes, using about 50% of the available amount.

Various personal care and health care products are likewise envisioned in which NAC or related compounds, optionally (when suitable) with acidic ingredients such as mandelic acid, may provide benefits in wound care, treatment of skin ailments such as acne, eczema, psoriasis, dermatitis, allergic reactions, injury from insect bites, relief from itching, healing of burns (particularly in combination with olive oil or olive oil extracts and optionally aloe vera extract in a cream, lotion, or spray), treatment of many wounds, prevention and/or treatment of diabetic ulcers or bed sore, scaliness, excessive keratin growth, prevention of scar tissue (especially when combined with other extracts of onion or garlic known to assist in scar reduction), etc. In such compounds, NAC and related compounds may be present at a level of 0.3% to 12%, for example, and may be dissolved in an aqueous phase at a suitable pH which is combined with an oil phase to form an emulsion (e.g., an O/W or W/O emulsion) or a solid stick, thus giving a cosmetic, personal care, or health care product that can be conveniently applied, has good texture, and has good stability.

In a variety of tests of 1% to 4% NAC solution combined with proteins such as amylase, pectinase, papain, etc., we found that NAC has a potent effect in reducing microbial growth. Solutions that otherwise would show evidence of significant bacterial growth after days or weeks at room temperature would remain clear and apparently largely untouched by microbes when NAC was present, such that even after 6 months at room temperature such solutions could remain clear, even when the pH had been adjusted to be neutral (e.g., around 6.5 to 8). It is thus proposed that NAC may greatly reduce the need for preservatives in the creams, lotions, sticks, and related cosmetic products described herein. Thus, in one embodiment, NAC-laden cosmetics are proposed that are substantially free of preservatives or that have less than half or less than one-third the amount of preservative otherwise needed to meet common criteria for suppression of microbes such as bacteria and yeast. The PANNAC and PANNAC2 solutions remained clear and apparently free of bacteria for many months after being made, for example.

In another example, the role of NAC as an additive to protective gloves was considered. For example, some gloves have a powder coating on the inside to increase comfort or ease of use. One such powder coating is found in Medline's Restore® Nitrile Exam Gloves with Colloidal Oatmeal, comprising ground Avena sativa flour, paraffin, sodium benzoate, sodium dodecylbenzenesulfonate, sulphur, titanium dioxide, zinc di-nbutyldithiocarbamate, and zinc oxide. It is proposed that reduced antimicrobial agents could be used by taking advantage of NAC's antimicrobial properties, with further skin care benefits. Coupled with paraffin or other waxes and a small quantity of NAC-odor control agents such as polyphosphate ions, NAC may be an effective additive for exam gloves. To demonstrate, 1.65 g of oat flour from Bob's Red Mill Natural Products (Milwaukie, Oreg.) was combined with 0.17 g NAC, 0.124 g SHMP, 0.53 g zinc stearate, and 0.365 g sunflower wax and ground to a fine powder using a mortar and pestle. The powder was then filtered through a fine mesh screen, and 0.11 g of the powder was placed inside a powder-free nitrile exam glove from AMMEX Corp. (Kent, Wash.), “professional series,” and shaken, allowing excess powder to be removed. The glove went on and off more smoothly than an untreated glove and felt more comfortable. There was no noticeable NAC odor in the glove or on the hand after wearing the glove.

NAC added to hand sanitizer such as aqueous ethanol solutions or gels comprising ethanol or other antimicrobials can also be considered, especially in settings where biofilms on solid surfaces are a likely problem. NAC levels may be from, for example, 0.1% to 3% by weight or from 0.1% to 1%. Small amounts of NAC remaining on skin after use of such sanitizers may not only have a humectant and protective effect on the skin, but may assist in weakening biofilms that may be contacted. In such formulations, it may be desirable to add NAC-odor control materials such as SHMP, betaine, quaternary ammonium compounds particulary as antimicrobials, betaine compounds as surfactants or humectants, hydroxysultaine compounds as cleaning agents and moisturizers, etc., each often in the range of 0.3% to 5% or 0.3% to 3%. NAC can serve to protect skin, fight microbes, and undermine biofilm, while the NAC-odor control agent(s) can improve aroma while also providing secondary benefits in terms of skin health, cleaning efficacy, etc.

Lotion Q1: Phase A comprised 5.00 g water, 1.06 g NAC, 0.33 g panthenol, 0.095 g ectoin, 0.12 g allantoin, 0.94 g PuriShield CSA solution, and 0.08 g sodium carbonate. Phase B comprised 3.465 g aminosyl SCG, 0.76 g propanediol, 0.09 Olivem 1000, 0.895 g behenyl alcohol. The two phases were heated and blended, then homogenized with a rotary homogenizer at 13,000 rpm for 60 seconds to form a light lotion. The pH was 2.7.

Cream T5 as a toenail treatment: 0.719 g NAC, 0.285 g ethoxy diglycol, 0.50 g propanediol, 0.791 g PuriShield CSA solution, 0.18 g 25% undecylenic acid in isopropyl palmitate, 0.333 g behenyl alcohol, 0.126 Olivem 1000, 2.38 g Tineacide® antifungal cream (Blaine Labs, Santa Fe Springs, Calif.). The ingredients were blended to yield a relatively thick lotion for treatment of fungus infections in nails. The products was applied to toenails daily for one week with no apparent adverse effects. It is proposed that the antifungal properties of the CSA solution, the Tineacide® cream, and the undecylenic acid combined with the NAC may have the potential to provide synergy with an enhanced antifungal effect, although the permeability of nails can be a challenge. In a related embodiment, urea can be added to soften nails and potentially increase the permeation of active ingredients.

A shaving cream formulation was provided by combining 3.73 g of 2% NAC solution in water with 0.58 g propylene glycol and 3.1 g Barbasol® shaving cream.

An antimicrobial cream was prepared by combining 0.43 g of Nystatin® Cream (100,000 units per gram, from Taro Pharmaceuticals, Hawthorne, N.Y.) with 0.25 g of a 7% NAC solution and blended into a cream less viscous than the Nystatin Cream but still useful and apparently stable. Nystatin® Cream comprises aluminum hydroxide gel, ceteareth-15, glyceryl monostearate, polyethylene glycol 400 monostearate, propylene glycol, purified water, simethicone emulsion, sorbitol solution, TiO2, white petrolatum, methylparaben, propylparaben, and NaOH. This was tested by applying to toenails and skin with no adverse reaction.

### Hair Care

To reduce the effects of oxidation that can lead to the formation of compounds that induce inflammation on the scalp, NAC can be combined with several other ingredients to create hair care products for improved scalp health and reduced inflammation. In some aspects, polyglyceryl-10 laurate at a concentration of 0.1% to 20%, such as from 0.5% to 3%, can be combined with NAC solution and suitable ingredients such as surfactants, emollients, thickeners, etc., to create shampoos, dry shampoos, hair conditioners, and other hair aids, wherein the NAC in the hair product has a concentration of from 0.1% to 5% such as from 0.1% to 2% or from 0.2% to 1.4%, the pH ranges from 3 to 9 such as from 3.5 to 7.5 or from 4 to 7. NAC-odor control agents such as sodium phosphate compounds may be present. The resulting hair products can not only be effective in removing compounds that may contribute to inflammation when oxidized, but may also help prevent oxidation to reduce possible sources of inflammation.

An exemplary dry shampoo, for example, may comprise 0.3-2 parts of a phosphate salt, 0.5 to 1.5 parts NAC, 2 to 60 parts of a surfactant comprising at least 10%, 20%, 30%, 40%, or 50% polyglyceryl-10 laurate or other suitable surfactants, and 10 to 40 parts water. An exemplary serum or anti-dandruff shampoo for the scalp may adapt the formulations given in Pascal Yvon, “Scalp Care 101,” Cosmetics and Toiletries, vol. 136, no. 2 (Feb. 2021): 26, which provides a serum in Formula 1 and a shampoo in Formula 2. Adapting these formulas may be done by adding 0.5 to 1.5% NAC, such as in place of all or part of the citric acid, and adjusting to a suitable pH as needed, and optionally adding 0.1% to 1% panthenol and optionally adding 0.1% to 1% of a diol such as 1-3 propanediol. With the NAC, the serum and the anti-dandruff shampoo may be especially effective in reducing dandruff or itching of the scalp associated with microbial biofilms, and the panthenol in combination with the NAC may help enhance the anti-biofilm effect as well as the comfort provided by the serum and the overall efficacy of the serum. If odor control is desired, both products may incorporate 0.2% to 1% of SHMP or other phosphate salt, or other NAC odor control agents described herein, such as from 0.2% to 2% of the total mass.

### Leather Permeation Tests

Given that the NAC-containing Vit. C serums appeared to become dry on the skin faster than expected compared with water alone, further testing was conducted. Six solutions were prepared as follows: A) 42 g water and 6 g pure Vitamin C powder. B) 42 g water, 5.5 g pure Vitamin C powder, and 0.6 g NAC powder. C) 24.8 g of solution A plus 042 g NAC and 0.200 g panthenol. D) 10.3 g of solution C plus 0.49 g panthenol. E) 19.7 g of solution B plus 0.28 g allantoin, 7.00 g of added water, and 1.80 g of added pure Vitamin C powder. F) 21.0 g og water, 2.73 g of Vitamin C powder, 0.311 g NAC powder, 0.117 g panthenol, 0.115 g allantoin, 0.26 g propanediol, and 0.11 g ethoxydiglycol. Two subjects compared the time required for application of 0.09 to 0.1 g of solution A and B, respectively to become dry after application to the skin, and both concurred that solution B was faster, though they contain similar amounts of solids. A similar test with one subject comparing solution F to A indicated faster absorption by solution F. However, for more clarity and less risk of subjective evaluation, simulations with leather products were conducted. Two types of leather were purchased at The Tailored Hide in Neenah, Wish., a “naked leather” comprising “Vegtan” leather (leather tanned with vegetable matter) and a grained pigmented brown Nassa cowhide. Both had a smoother finished side and a coarser unfinished side and both had a nominal basis weight of 2 to 3 ounces, later measured at 808 g/m² (Nassa) and 813 g/m² (vegtan).

In testing, a pipette was used to apply droplets of the various solutions to give from 0.05 to 0.15 g drops on the unfinished side of the leather, and the time required to absorb into the leather was measured. The moment of full absorption was taken as them time when the reflection of overhead lights could no longer be seen on the moisture on the droplet surface, meaning there was no longer a smooth liquid surface to reflect the light (six distinct lights were distributed over the ceiling above the test area). This was done for at least 6 drops on various locations on each leather material. For a given material, the absorption time versus drop mass was plotted and fit to a linear curve, and the time for absorption for a droplet of 0.09 g was taken from the linear curve fit as the “effective absorption time.”

For rough side of the Vegtan material, the effective absorption times for fluids A, B, C, and D (due to limited space on the leather sample, E and F were not tested) were A: 29 s, B: 29 s, C: 27 s, and D: 22.5 s. For the Nassa leather sample, the results were A: 160 s, B: 148 s, C: 110 s, D: 97 s, E: 145 s, and F: 80 s. Some testing on the smooth side of the Vegtan leather was also conducted, but with different results, possibly due to an interaction from the chemical or other treatment on that side. This gave A: 76 s, B: 93 s, C: 83 s, and D: 92 s. Further testing with A and B gave consistent values. Why the finished side of the Vegtan exhibited such different behavior is unclear, but since the objective was to test the agents on the unfinished, porous side of the leather, those results suggest that while B was better that A in the Nassa leather and essentially the same in the Vegtan leather, there was a more significant decrease in absorption time with the panthenol present in sample C for both leathers. A small amount of propanediol also appeared to give a significant boost in the absorption rate. It may be that the combination of NAC with panthenol is particularly suited at enhancing skin or leather penetration of a Vitamin C serum, and pronanediol or ethoxydiglycol may also assist. Leather testing is, of course, not an ideal analog for skin absorption, but may still provide useful insight.

### Remarks

When introducing elements of aspects of the invention or aspects thereof, the articles “a,” “an,” “the,” and “said” are intended to mean that there are one or more of the elements. The terms “comprising,” “including,” and “having” are inclusive and mean that there may be additional elements other than the listed elements.

All patents and patent publications cited herein may be presumed to be incorporated by reference to the extent it is non-contradictory herewith. When a document is explicitly said to be “incorporated by reference,” it is also implied that it is incorporated by reference to the extent it is non-contradictory herewith.

Having described aspects of the invention in detail, it will be apparent that modifications and variations are possible without departing from the scope of aspects of the invention as defined in the appended claims. As various changes could be made in the above compositions, products, and methods without departing from the scope of aspects of the invention, it is intended that all matter contained in the above description shall be interpreted as illustrative and not in a limiting sense.

Portions of this work were conducted in the Minnesota Nano Center, which is supported by the National Science Foundation through the National Nano Coordinated Infrastructure Network (NNCIN) under Award Number ECCS-1542202.

We claim:

1. A method for treating a textile item to reduce persistent odor, comprising applying an enzymatic composition to the item and then washing the item, wherein the enzymatic composition comprises: (a) water, (b) from 5% to 60% of a surfactant, (c) from 1% to 20% of an enzyme mixture comprising at least one of lysozyme, proteinase, amylase, mannanase, lipase, pectinase, DNAse and cellulase; and (d) from 0.1% to 10% of N-acetyl cysteine.

2. The method of claim 1, wherein the enzymatic composition further comprises from 0.01% to 8% by weight of bacterial spores that become active in response to the presence of contaminants on textiles selected from at least one of proteins, carbohydrates, lipids, and carbohydrates, the spores then producing enzymes that attack a portion of said contaminants, wherein the concentration of the bacterial spores is between 1×10⁵ and 5×10¹⁰ CFU/ml.

3. The method of claim 1, wherein the enzymatic composition further comprises at least 0.05% of at least one of panthenol, a derivative of panthenol, and a catechin.

4. The method of claim 1, wherein the enzymatic composition is packaged with indicia instructing a user to wait at least 5 minutes between applying the enzymatic composition and washing the item.

5. The method of claim 1, wherein the enzymatic composition comprises at least two segregated portions, a first portion comprising an enzyme mixture and a second portion comprising N-acetyl cysteine, further associated with indicia instructing a user to apply both portions to the one or more regions of the textile item associated with persistent odor, such that N-acetyl cysteine and the enzyme mixture are both present on the item for a period of time.

6. The method of claim 5, wherein the first portion of the enzymatic composition is provided as a liquid and the second portion is provided as a liquid or as a powder to be combined with a liquid when applying it to the item.

7. The method of claim 5, wherein the second portion of the enzymatic composition comprises from 1% to 90% N-acetyl cysteine, from 1% to 10% panthenol, and sufficient alkaline agents such that when the second portion of the enzymatic composition is combined with enough water at pH 7.0 to bring the concentration of the N-acetyl cysteine to 1%, that the pH of the resulting aqueous mixture is at least 6.0

8. The method of claim 1, wherein the method is effective in reducing the amount of biofilm matter present or the surface area with biofilm matter present in the item, without the use of non-enzymatic bleaching agents.

9. The method of claim 1, further comprising visualizing the presence of suspected biofilm matter using UV light.

10. The method of claim 9, wherein the item has malodor and wherein a suitable dye that fluoresces in UV light has been applied to the item to identify one or more regions that show relatively high fluorescence in UV light, wherein the enzymatic composition is applied to at least one of the one or more regions that show relatively high fluorescence.

11. The method of claim 1 wherein the enzymatic composition further comprises at least 0.1% sophorolipids.

12. The method of claim 1, further comprising treating the item with at least 0.01 g of N-acetyl cysteine.

13. A method for reducing a biofilm in a target region of a textile item, the method comprising: 1) applying an effective amount of a biofilm attack agent to the item, the biofilm attack agent being selected from one or more of N-acetyl cysteine, panthenol or derivatives thereof, and a catechin, 2) applying a bioenzymatic mixture comprising bacterial spores, one or more surfactants, and an enzyme mixture from two of more categories of enzymes selected from proteases, cellulases, amylases, mannanes, lipases, pectinases, and DNases;

3. providing conditions to activate the spores; and 4) washing the item.

14. The method of claim 13, wherein step 1 comprises applying a dose of at least 0.01 g of N-acetyl cysteine per 50 cm² to the target region.

15. The method of claim 13, further comprising using UV light having a wavelength from 330 nm to 420 nm to identify a target region having biofilm matter, wherein the item has been previously washed with a laundry detergent comprising an optical brightener that preferentially absorbs onto the biofilm.

16. The method of claim 15, wherein after step 4, UV light is again used to examine the target region and reveals decreased fluorescence relative to the fluorescence observed when identifying the target region.

17. A composition for reducing persistent odor in a textile item, comprising 0.1% to 30% N-acetyl cysteine, from 5% to 50% of at least one surfactant, at least 1% of at least one enzyme selected from proteases, pectinases, cellulases, amylases, lipases, mannanases, and lysozymes; and at least 20% water, the composition being associated with indicia instructing a user to apply the composition to the textile item prior to washing to reduce odor.

18. The composition of claim 17, wherein the composition is aqueous solution comprising from 0.2% to 5% N-acetyl cysteine and from 0.1% to 5% protease.

19. The composition of claim 17 provided as a two-part composition, comprising a first part comprising N-acetyl-cysteine or salt thereof and a second part comprising a cleaning compound comprising the at least one enzyme, the two parts of the composition being segregated prior to use.

20. The composition of claim 19 further comprising at least 0.01% of bacterial spores capable of producing at least one of proteinases, cellulases, amylsases, lipases, mannanases, and lysozymes in the presence of suitable nutrients.
